(19) United States
(12) Patent Application Publication
(10) Pub. No.: US 2026/0014484 A1
(43) Pub. Date: Jan. 15, 2026

(54) INFORMATION PROCESSING SYSTEM, STORAGE MEDIUM, AND INFORMATION PROCESSING METHOD

(71) Applicant: Nintendo Co., Ltd., Kyoto (JP)

(72) Inventors: Ryota OIWA, Kyoto (JP); Minori KOIKE, Kyoto (JP)

(21) Appl. No.: 19/265,802

(22) Filed: Jul. 10, 2025

(30) Foreign Application Priority Data
Jul. 12, 2024 (JP) 2024-112756
Mar. 28, 2025 (JP) 2025-055466

(51) Int. Cl. A63F 13/87; A63F 13/73; A63F 13/79; A63F 13/847; A63F 13/86

(52) U.S. Cl. CPC A63F 13/87; A63F 13/73; A63F 13/79; A63F 13/847; A63F 13/86

(57) ABSTRACT

Executed are: executing a communication process between a plurality of communication members; executing a multiplayer game between a plurality of game members while generating game image data for each game member; displaying the game image based on the generated game image on displays of other communication members of the communication group, to share the game image with other communication members; and forbidding at least one game image from being displayed on a display for at least one of game members of the game group.

### CROSS REFERENCE TO RELATED APPLICATIONS

This application claims priority to Japanese Patent Application No. 2024-112756, filed on Jul. 12, 2024, and Japanese Patent Application No. 2025-055466, filed on Mar. 28, 2025, the entire contents of which are incorporated herein by reference.

### FIELD

The technology disclosed herein relates to information processing systems, storage media, and information processing methods.

### BACKGROUND AND SUMMARY

There has conventionally been a system in which an application image is shared with other users.

There has been room for improvement of a method for sharing an application image with other users.

The present example may have the following features (1) to (19), for example.

(1) An example configuration of an information processing system according to the present example is an information processing system comprising one or more memories storing instructions and one or more processors executing the instructions, the information processing system being configured to perform operations comprising: forming a communication group in which communication is performed, and executing a communication process between a plurality of communication members using network communications; forming a game group in which a multiplayer game is performed, and executing the multiplayer game between a plurality of game members using the network communications or another network communications to generate game image data for each game member; displaying the game image based on the generated game image on displays of other communication members of the communication group, to share the game image with other users; and forbidding at least one game image from being displayed on a display for at least one of game members of the game group.

With the configuration of (1), a game image can be appropriately shared in the communication group.

(2) In the configuration of (1), the operations may further comprise: designating at least one of the game members according to a condition specified in the multiplayer game. The forbidding may comprise forbidding the game image from being displayed on at least one of displays for the at least one of the designated game members.

With the configuration of (2), a game image can be shared according to the contents of a game.

(3) In the configuration of (1) or (2), the operations may further comprise: storing identification information of the game members of the game group; and designating at least one of the game members satisfying a condition based on the identification information. The forbidding may comprise forbidding the game image from being displayed on at least one of displays for the at least one of the designated game members.

With the configuration of (3), sharing of a game image can be appropriately forbidden based on the identification information of the game members.

(4) In the configuration of any one of (1) to (3), the multiplayer game may be a team competition game. In that case, the operations may further comprise: storing team configuration data including identification data of game member of each team of the team competition game; and designating game members of an opponent team in the team competition game, based on the team configuration data. The forbidding may comprise forbidding the game image from being displayed on at least one of displays for the at least one of the designated game members.

With the configuration of (4), sharing of a game image can be appropriately forbidden for game members of an opponent team.

(5) In the configuration of any one of (1) to (4), the multiplayer game may be a game in which a user participates as a player and a user participates as a spectator. In that case, the operations may further comprise: storing member configuration data including identification data of game members for identifying the user participating as a player and the user participating as a spectator; and designating at least one of the users participating as a player without designating the user participating as a spectator, based on the member configuration data. The forbidding may comprise forbidding the game image from being displayed on at least one of displays for the at least one of the designated game members.

With the configuration of (5), a user participating in a multiplayer game as a player can be appropriately forbidden from sharing of a game image.

(6) In the configuration of any one of (1) to (5), the operations may further comprise: executing a game program. A first game program for executing the multiplayer game may be stored as the game program to be executed, in a memory. In that case, the first game program may include a first instruction to designate the game member satisfying a condition, based on identification information of the game members of the game group. The forbidding may comprise forbidding the game image from being displayed on at least one of displays for the at least one of the designated game members.

With the configuration of (6), sharing of a game image is forbidden by a game program. Therefore, the forbidding of the sharing can be appropriately performed according to the contents of a game.

(7) In the configuration of (6), a second game program for executing the multiplayer game may be stored as the game program to be executed, in a memory. In that case, the second game program may include a second instruction to designate all game members of the game group. The forbidding may comprise forbidding the game image from being displayed on at least one of displays for the at least one of the designated game members.

With the configuration of (7), sharing of a game image can be forbidden by the developer of a game program incorporating the second instruction into the game program, leading to an improvement in development efficiency.

(8) In the configuration of (6) or (7), a third game program for executing the multiplayer game may be stored as the game program to be executed, in a memory. In that case, the third game program may include a third instruction to designate all communication members of the communication group.

With the configuration of (8), sharing of a game image can be forbidden by the developer of a game program incorporating the third instruction into the game program, leading to an improvement in development efficiency.

(9) In the configuration of (6), a second and a third game program for executing the multiplayer game may be stored as the game program to be executed, in the memory. In that case, the second game program may include a second instruction to designate all game members of the game group, and the third game program may include a third instruction to designate all communication members of the communication group.

With the configuration of (9), sharing of a game image can be forbidden by the developer of a game program incorporating the second and third instructions into the game program, leading to an improvement in development efficiency.

(10) In the configuration of any one of (1) to (9), the operations may further comprise: designating all communication members of the communication group according to a user's instruction. The forbidding may comprise forbidding the game image from being displayed on at least one of displays for the at least one of the designated game members.

With the configuration of (10), sharing of a game image can be forbidden according to a user's operation.

(11) In the configuration of any one of (1) to (10), the information processing system may comprise a plurality of game apparatuses. In the multiplayer game, one of the plurality of game apparatuses serving as a host apparatus may be configured to obtain operation data of one of the plurality of game apparatuses serving as a guest apparatus, and execute a game program using operation data of the host apparatus and the operation data of the guest apparatus to generate game image data for the host apparatus and game image data for the guest apparatus.

With the configuration of (11), by a host apparatus executing a game program, a multiplayer game can also be performed in a guest apparatus.

(12) A first configuration example of a system program according to the present example is one or more non-transitory computer-readable storage media storing instructions that cause one or more computers to perform operations comprising: displaying a game image on a display of another communication member of a communication group; receiving a first instruction to designate all game members of a game group, the first instruction being issued by execution of a game program of a multiplayer game; and forbidding a game image corresponding to the designated game member from being displayed on a display by the displaying.

With the configuration of (12), the function of forbidding sharing of a game image is prepared in a system program, leading to facilitation of development of a game program.

(13) In the configuration of (12), the operations may further comprise: receiving a second instruction to designate all communication members, the second instruction being issued by execution of a game program of a multiplayer game; and forbidding a game image corresponding to the designated members from being displayed on a display by the displaying.

With the configuration of (13), the function of forbidding sharing of a game image is prepared in a system program, leading to facilitation of development of a game program.

(14) A second configuration example of the system program of the present example is one or more non-transitory computer-readable storage media storing instructions that cause one or more computers to perform operations comprising: displaying a game image on a display of another communication member of a communication group; receiving a third instruction to designate user identification data, the third instruction being issued by execution of a game program of a multiplayer game; and forbidding a game image corresponding to the designated user identification data from being displayed on a display by the displaying.

With the configuration of (14), the function of forbidding sharing of a game image is prepared in a system program, leading to facilitation of development of a game program.

(15) In the configuration of (14), the operations may further comprise: receiving a fourth instruction to designate all communication members of a communication group, the fourth instruction being issued by execution of a game program of a multiplayer game; and forbidding a game image corresponding to the designated members from being displayed by the displaying.

With the configuration of (15), the function of forbidding sharing of a game image is prepared in a system program, leading to facilitation of development of a game program.

(16) In the configuration of (12), the operations may further comprise: receiving a third instruction to designate user identification data, the third instruction being issued by execution of a game program of a multiplayer game; and forbidding a game image corresponding to the designated user identification data from being displayed on a display by the displaying.

With the configuration of (16), the function of forbidding sharing of a game image is prepared in a system program, leading to facilitation of development of a game program.

(17) A first configuration example of a game program according to the present example is one or more non-transitory computer-readable storage media storing instructions that cause one or more computers to perform operations comprising: executing a multiplayer game; and instructing a system program to designate all game members of a game group of the multiplayer game as subject to forbidding of sharing of a game image.

With the configuration of (17), sharing of a game image is forbidden by a game program. Therefore, the forbidding of the sharing can be appropriately performed according to the contents of a game.

(18) A second configuration example of the game program of the present example is one or more non-transitory computer-readable storage media storing instructions that cause one or more computers to perform operations comprising: executing a multiplayer game; and instructing a system program to designate a game member of a game group of the multiplayer game as subject to forbidding of sharing of a game image.

With the configuration of (19), sharing of a game image is forbidden by a game program. Therefore, the forbidding of the sharing can be appropriately performed according to the contents of a game.

(19) In the configuration of (18), in the designation, a game member of an opponent team in a team competition game as the multiplayer game may be configured to be designated as subject to forbidding of sharing of a game image.

With the configuration of (19), sharing of a game image is forbidden by a game program. Therefore, the forbidding of the sharing can be appropriately performed according to the contents of a game.

The present example may also be carried out in the form of an information processing method.

According to the present example, a game image can be appropriately shared in a communication group.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a diagram showing a non-limiting example information processing system in the present example,

FIG. 2 is a block diagram showing a non-limiting example hardware configuration of an information processing apparatus 1,

FIG. 3 is a block diagram showing a non-limiting example configuration of servers 101a and 101b,

FIG. 4 is a functional block diagram showing non-limiting example functions of a host apparatus and a guest apparatus during a sharing game,

FIG. 5 is a diagram showing a non-limiting example in which eight information processing apparatuses 1a to 1h that belong to a communication group and an information processing apparatus 1z that does not belong to the communication group operate in respective game modes,

FIG. 6 is a diagram showing a non-limiting example image displayed on a display 15a of an information processing apparatus 1a serving as a first host apparatus,

FIG. 7 is a diagram showing a non-limiting example image displayed on a display 15b of an information processing apparatus 1b serving as a first guest apparatus,

FIG. 8 is a diagram showing a non-limiting example image displayed on a display 15c of an information processing apparatus 1c serving as a second host apparatus,

FIG. 9 is a diagram showing a non-limiting example image displayed on a display 15d of an information processing apparatus 1d serving as a second guest apparatus,

FIG. 10 is a diagram showing a non-limiting example image that is displayed on a display 15a when an information processing apparatus 1a that serves as a host apparatus invites another information processing apparatus 1 to participate in a sharing game,

FIG. 11 is a diagram showing a non-limiting example image that is displayed on a display 15b when an information processing apparatus 1b receives an invitation to a sharing game from another information processing apparatus 1a and participates in the sharing game, in accordance with operation of a dedicated button 3,

FIG. 12 is a diagram showing a non-limiting example second dedicated button menu image BMb that is displayed when a dedicated button 3 of an information processing apparatus 1b is operated,

FIG. 13 is a diagram showing a non-limiting example third dedicated button menu image BMc that is displayed when a dedicated button 3 of an information processing apparatus 1b is operated,

FIG. 14 is a diagram showing a non-limiting example system that performs game sharing using Internet communications,

FIG. 15 is a diagram showing a non-limiting example system that performs game sharing using local wireless communications,

FIG. 16 is a diagram showing a non-limiting example data area set in a DRAM 13,

FIG. 17 is a flowchart showing a non-limiting example of the first half of a main-body function process that is executed in an information processing apparatus 1,

FIG. 18 is a flowchart showing a non-limiting example of the second half of a main-body function process that is executed in an information processing apparatus 1,

FIG. 19 is a flowchart showing a non-limiting example dedicated button menu process that is executed in an information processing apparatus 1,

FIG. 20 is a flowchart showing a non-limiting example of the first half of a communication function process executed in an information processing apparatus 1,

FIG. 21 is a flowchart showing a non-limiting example of the second half of a communication function process executed in an information processing apparatus 1,

FIG. 22 is a flowchart showing a non-limiting example game program process that is executed in an information processing apparatus 1,

FIG. 23 is a subroutine indicating a non-limiting example detailed game sharing mode process that is executed in step S144 of FIG. 22,

FIG. 24 is a subroutine indicating a non-limiting example detailed image sharing setting process that is executed in step S146 of FIG. 22 and step S151 of FIG. 23,

FIG. 25 is a flowchart showing a non-limiting example game sharing function process for a host that is executed in an information processing apparatus 1,

FIG. 26 is a flowchart showing a non-limiting example game sharing function process for a guest that is executed in an information processing apparatus 1,

FIG. 27 is a diagram showing non-limiting example data and programs stored in a storage 104a of a server 101a,

FIG. 28 is a flowchart showing a non-limiting example process that is executed by a server 101a,

FIG. 29 is a diagram showing non-limiting example data and programs stored in a storage 104b of a server 101b, and

FIG. 30 is a flowchart showing a non-limiting example process that is executed by a server 101b.

### DETAILED DESCRIPTION OF NON-LIMITING EXAMPLE EMBODIMENTS

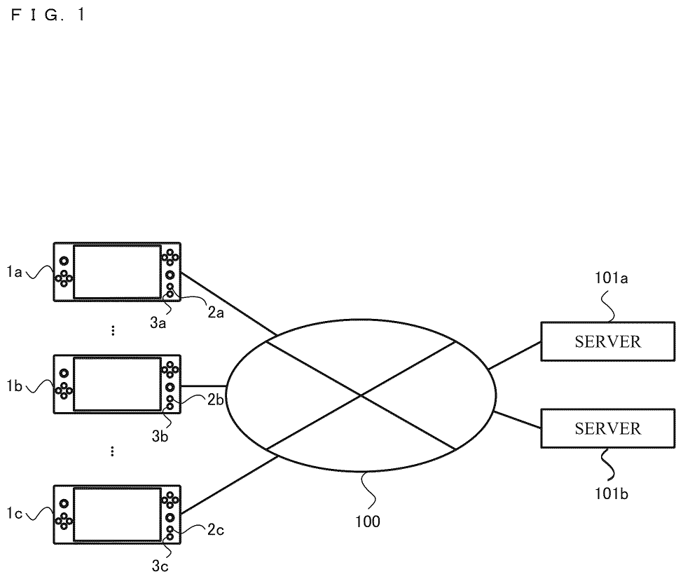

An information processing system that is used in the present example will be described below. The information processing system is configured by a plurality of information processing apparatuses 1 communicating with each other. FIG. 1 is a diagram showing an example of the information processing system, illustrating an overview of a configuration of the information processing system in which the plurality of information processing apparatuses 1 perform Internet communications through a network 100.

As shown in FIG. 1, the information processing system includes a plurality of information processing apparatuses 1 and a plurality of servers. For example, in the information processing system, information processing apparatuses 1a to 1c are communicably connected to servers 101a and 101b through the network 100. The information processing apparatuses 1a to 1c can be connected to the network 100 through Internet communications using wireless or wired communications. The information processing apparatuses 1a to 1c and the servers 101a and/or 101b form a client-server system. It should be noted that the information processing apparatuses 1a to 1c may communicate with each other without through the Internet or without through a server. For example, peer-to-peer communications through local wireless communications may be employed. For example, the information processing apparatuses 1a to 1c are each capable of executing a predetermined application (e.g., a game application or system application). The information processing apparatuses 1a to 1c are also each capable of establishing connection to the servers 101a and/or 101b through the network 100 by executing the above predetermined application, so as to communicate with the servers 101a and/or 101b. It should be noted that the number of information processing apparatuses 1 included in the information processing system is not particularly limited. The information processing apparatuses 1 may each be any type of information processing apparatus, such as a game machine, smartphone, tablet terminal, or personal computer, irrespective of whether it is of the stationary or handheld type. The information processing apparatuses 1 may also be of different types or of the same type.

The information processing apparatus 1 may be identified using its own unique ID, or through a user account such as a network account. In the latter case, for example, the “information processing apparatus of a user A” is the information processing apparatus 1 in which the user A has currently logged using their user account. For example, when communication is performed with the “information processing apparatus of a user A”, a communication destination is specified using the unique ID of the “information processing apparatus in which the user A has currently logged using their user account.

In the present example, the information processing system has a communication function, and a plurality of information processing apparatuses 1 can form a communication group. In the present example, the information processing apparatuses 1 in the communication group can share audio by communicating audio data to each other, or share images by communicating game images or camera images to each other, so that communication is allowed between the information processing apparatuses 1 using audio and/or images.

In the present example, the information processing system has a game sharing function. The “sharing game” (a game by the game sharing function) refers to a game that is played between a plurality of information processing apparatuses 1, and in which an information processing apparatus 1 that does not have a game program is allowed to participate. At least one of the plurality of information processing apparatuses 1 that has a game program operates as a host apparatus, while another information processing apparatus(es) 1 operates as a guest apparatus. The host apparatus executes a game process in the sharing game, and generates a game image indicating a result of the game process. The generated game image is transmitted from the host apparatus to the guest apparatuses. The guest apparatus receives the game image from the host apparatus, and displays a game image on a display thereof. The guest apparatus transmits operation data indicating an operation performed on itself (self-apparatus) by the user thereof to the host apparatus. The host apparatus executes the game process based on operation data thereof and the operation data transmitted from the guest apparatus. Thus, in the present example, a game process can be executed by execution of game sharing between a plurality of information processing apparatuses 1. It should be noted that game sharing is the function of allowing an information processing apparatus 1 that has not a game program to share a game (e.g., temporarily playing together). Sharing of a game image or the like using the above communication function is the function of displaying a game image or the like displayed on the display of a self-apparatus, on the display of another information processing apparatus 1. In the present example, the same term “share” is used, but has different specific meanings.

It should be noted that in the present example, communication between information processing apparatuses 1 can be performed through Internet communications or local wireless communications. In the former case, Internet communications may be performed between information processing apparatuses 1 through the above other apparatuses (e.g., the servers 101a and 101b), or direct Internet communications may be performed between information processing apparatuses 1 using a predetermined communications scheme (e.g., a peer-to-peer (P2P) scheme). In the present example, the communication function between information processing apparatuses 1 performed in the above communication group is performed using Internet communications. Sharing games can be executed by selectively using Internet communications (server-mediated communication or peer-to-peer communications) or local wireless communications. Sharing games that are executed using Internet communications can be executed between members of the above communication group. Meanwhile, in sharing games that are executed using local wireless communications, direct wireless communication is performed between a plurality of information processing apparatuses 1 existing in the communication range of the information processing apparatuses 1 using a predetermined communications scheme (e.g., a scheme compliant with a Wi-Fi (registered trademark) standard such as IEEE802.11, a wireless communications scheme employing a particular protocol, or infrared communication). In this case, recruitment for the above sharing game is performed by a host apparatus in a broadcast manner, and a game process in the sharing game is executed between a plurality of information processing apparatuses 1 that perform local wireless communications. Therefore, for one player of game sharing in which local wireless communications is used, coplayers of the game sharing are not limited to members of the communication group to which the one player belongs. In this case, the above host apparatus directly receives operation data from each guest apparatus using a local wireless communications technique, and directly transmits a game image to each guest apparatus, whereby game sharing is performed between a plurality of information processing apparatuses 1 through local wireless communications. Here, the “local wireless communications” that can be performed with respect to other information processing apparatuses 1 may be ad-hoc communications in which information processing apparatuses 1 are directly and wirelessly connected to each other without through the Internet.

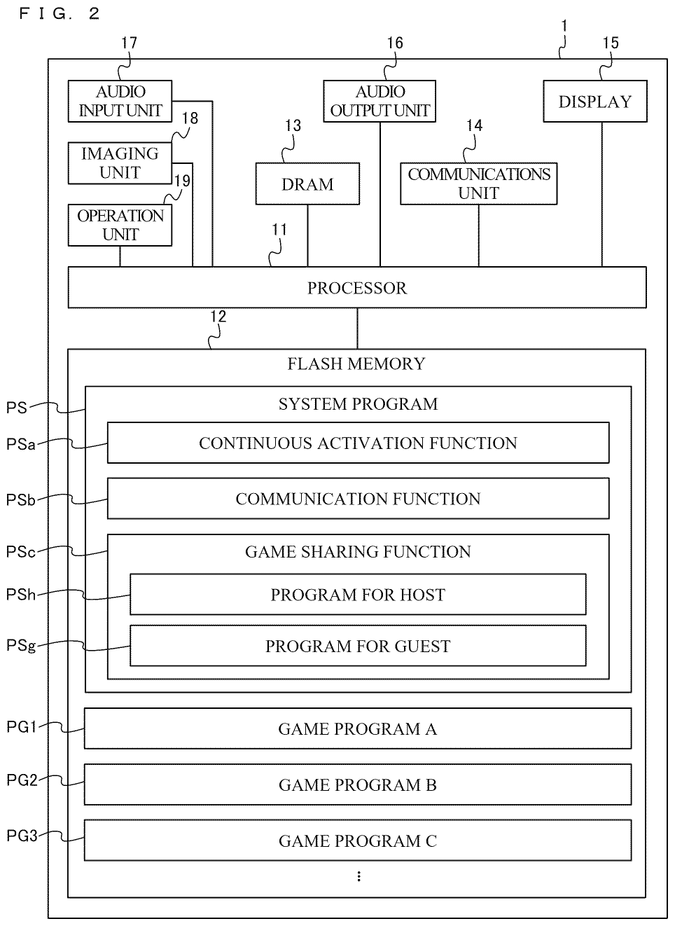

FIG. 2 is a block diagram showing an example hardware configuration of the information processing apparatus 1. It should be noted that in the present example, each information processing apparatus 1 has both a function for operating as a host apparatus and a function for operating as a guest apparatus. It should be noted that in another example, the information processing apparatus 1 included in the information processing system may be configured to have only either of a function for operating as a host apparatus or a function for operating as a guest apparatus. In addition, as in the present example, functioning as a host apparatus may require execution of a game program.

As shown in FIG. 2, the information processing apparatus 1 includes a processor 11, a flash memory 12, a DRAM 13, a communications unit 14, a display 15, an audio output unit 16, an audio input unit 17, an imaging unit 18, and an operation unit 19.

The processor 11, which is an information processing unit that executes various information processes in the information processing apparatus 1, is connected to the units 12 to 19. For example, the processor 11 may be composed of one or more central processing units (CPUs), or may be composed of a system-on-a-chip (SoC) including one or more CPUs, one or more graphics processing units (GPUs), and the like. The processor 11 executes a program (e.g., a system program or game program) stored in a storage (specifically, an internal storage medium such as the flash memory 12, an external storage medium attached to the information processing apparatus 1, or the like), thereby executing various information processes.

The flash memory 12 stores various programs for causing the processor 11 to execute information processes for carrying out the communication function and executing a game. For example, the flash memory 12 stores a game program PG, and a system program PS, which is different from the game program PG. It should be noted that the game program PG may be stored in a storage medium (e.g., a memory card) that is removably attached to the information processing apparatus 1. In the present example, the flash memory 12 stores a plurality of different game programs (in FIG. 2, three game programs PG1 to PG3), and different games can be played by the processor 11 executing the respective game programs PG. The system program PS is previously installed in the information processing apparatus 1. Thus, in the present example, a program for carrying out the communication function and a program for carrying out the game sharing function are previously installed in the information processing apparatus 1. The system program PS includes a program PSa that carries out a continuous activation function that is continuously active when the power supply of the information processing apparatus is on, a program PSb that carries out the communication function between a plurality of information processing apparatuses 1, a program PSc that carries out the sharing game function of causing a plurality of information processing apparatuses 1 to share and play a game, and the like. The program PSc that carries out the sharing game function includes a host program PSh that is executed when the information processing apparatus 1 operates as a host apparatus, and a guest program PSg that is executed when the information processing apparatus 1 operates as a guest apparatus. The host program PSh and the guest program PSg are provided for the game sharing function that is used by each game program PG through an application programmable interface (API).

The DRAM 13 is a memory that is an example storage in the information processing apparatus 1 and is used to temporarily store various kinds of data that are used in information processes. The DRAM 13 stores various kinds of data that are used or generated in information processes for executing the communication function and a game (e.g., a process for carrying out the communication function for executing voice chat or image sharing, a game process for causing a game to proceed, and a process for exchanging data with other information processing apparatuses 1 or the server 101a or 101b in order to carry out the communication function or a game). It should be noted that in the present example, voice chat can be performed while video information is shared (so-called video chat), and thus, encompasses such a form. In addition, the communication function may be the function of sharing a game image during play of the user of the communication function with another user, in addition to voice chat, video chat, and text chat, in which text data is exchanged, and may be one of these functions or include all or some of these functions.

The communications unit 14 takes a first communications form in which the communications unit 14 can perform Internet communications, and a second communications form in which the communications unit 14 can perform local wireless communications. The game sharing function can employ any of these communications schemes. Any of these communications schemes can be arbitrarily selected by the user for the same game.

The display 15 displays an image based on a display control process executed by the processor 11. It should be noted that in another example, the information processing apparatus 1 may not be equipped with the display 15, and may be configured to cause a display apparatus that can communicate with the information processing apparatus 1 to display an image.

The audio output unit 16 generates audio (e.g., game sounds or a user's voice in voice chat) based on audio data output from the processor 11. For example, the audio output unit 16 includes a codec circuit and a loudspeaker. It should be noted that in another example, the information processing apparatus 1 may not be equipped with at least a portion of the audio output unit 16, and may be configured to output audio from a loudspeaker connected to the information processing apparatus 1.

The audio input unit 17 collects sounds around the information processing apparatus 1 and outputs audio data of the sounds to the processor 11. For example, the audio input unit 17 includes a codec circuit and a microphone, and outputs, to the processor 11, audio data based on voices of the user of the information processing apparatus 1 collected by the microphone. It should be noted that in another example, the information processing apparatus 1 may not be equipped with at least a portion of the audio input unit 17, and may be configured to collect audio using a microphone connected to the information processing apparatus 1.

The imaging unit 18 includes a camera that captures an image of the real world around the information processing apparatus 1, and outputs the captured image data to the processor 11. It should be noted that in another example, the information processing apparatus 1 may not be equipped with the imaging unit 18, and may be configured to capture an image using a camera connected to the information processing apparatus 1.

The operation unit 19 detects an operation performed on the information processing apparatus 1 by the user, and outputs operation data indicating the detected operation. The operation unit 19 may, for example, include operation parts such as an analog stick and buttons, and sensors such as a gyroscopic sensor and an acceleration sensor. In addition, the operation unit 19 may include a home button 2 and a dedicated button 3 (see FIG. 1), which is different from the home button 2. The home button 2 is an operation part used for displaying a menu screen. The dedicated button 3 is an operation button for the communication function. When the dedicated button 3 is operated, a user interface for the communication function is displayed, and in the present example, only a user interface for the communication function is displayed, as described below. It should be noted that the game sharing function that employs Internet communications is executed between members of a communication group, and therefore, the user interface for the game sharing function that employs Internet communications may be a kind of user interface for the communication function. In the present example, when the dedicated button 3 is operated, the user interface for the game sharing function is also displayed, depending on the situation. It should be noted that the operation unit 19 may be integrated with the information processing apparatus 1, may be removably attached to the information processing apparatus 1, or may be a separate operation unit.

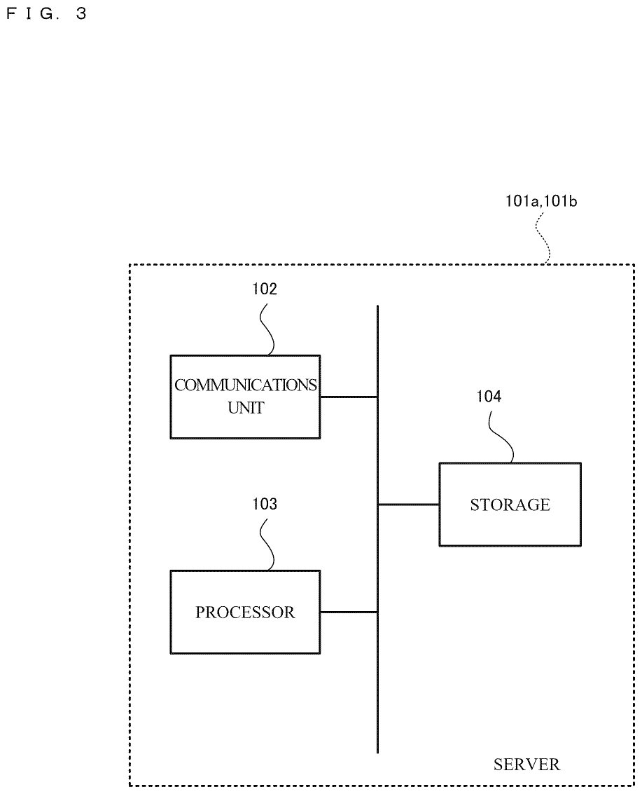

As shown in FIG. 3, the servers 101a and 101b each have a communications unit 102, a processor 103, and a storage 104. The communications unit 102 communicates with the information processing apparatus 1 and the like by exchanging communications packets through the network 100. As an example, the processor 103 of the server 101a executes the process of managing the communication function performed between the server 101a and the information processing apparatus 1, and the like, and in addition, establishes a communication link to the information processing apparatus 1 and the like through the communications unit 102, and performs data transmission control and routing on the network 100. The processor 103 of the server 101b executes the process of managing the game sharing function performed between the server 101b and the information processing apparatus 1, and the like, and in addition, establishes a communication link to the information processing apparatus 1 and the like through the communications unit 102, and performs data transmission control and routing on the network 100. The storage 104 stores a program executed in the processor 103, various kinds of data required for the above process, various kinds of data required for communication with the information processing apparatus 1, and the like. It should be noted that in the case of a system in which a predetermined log-in process is required for data exchange performed through the network 100 or participation in a game, the servers 101a and/or 101b may execute an authentication process to determine whether or not a user that is trying to log in is an authorized user. In addition, the servers 101a and 101b may each be a single server machine or may include a plurality of server machines.

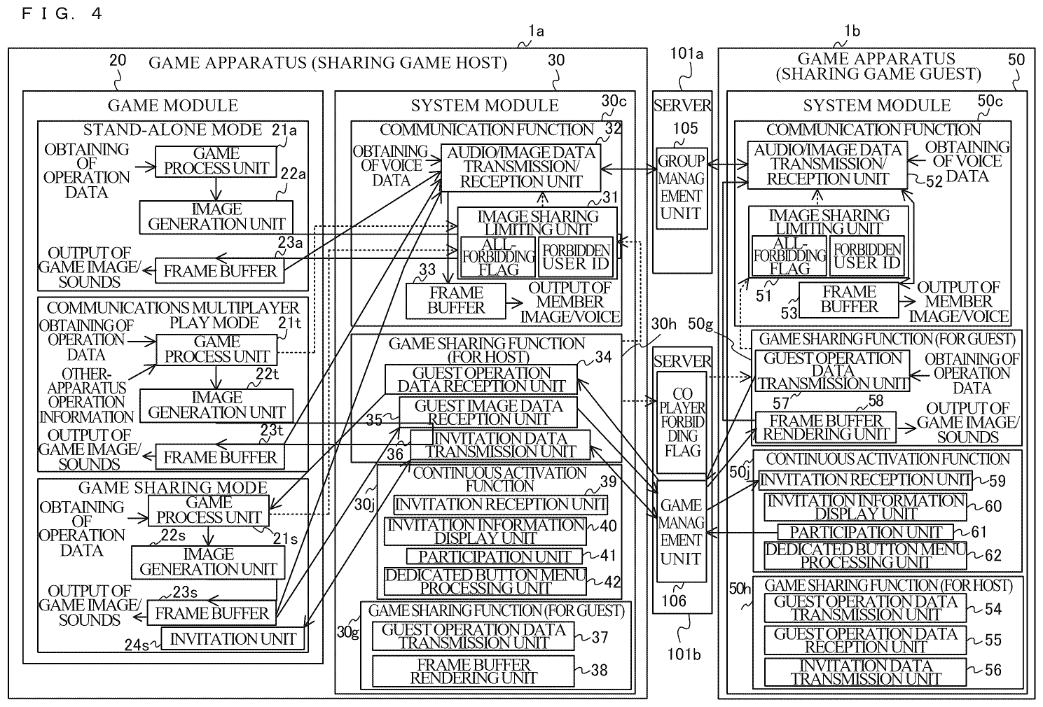

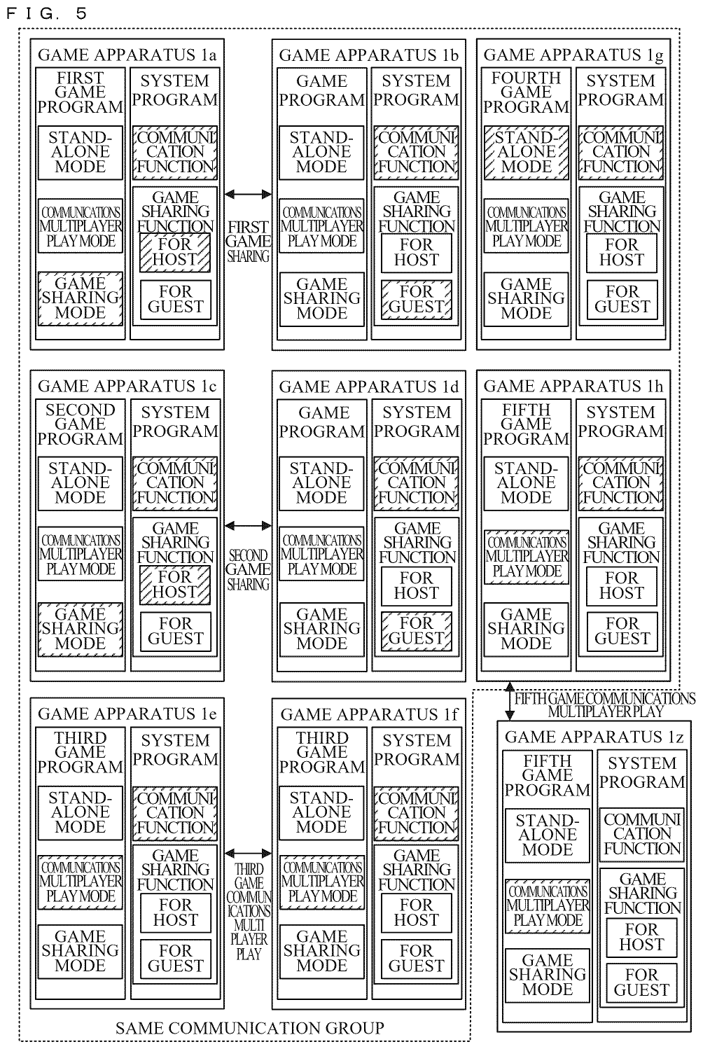

An operation that is performed by each information processing apparatus 1 when a game is played in the information processing system will be outlined below with reference to FIGS. 4 and 5. In the description using FIG. 4, an information processing apparatus 1a operates as a host apparatus during a sharing game, and an information processing apparatus 1b operates as a guest apparatus during the sharing game, for example.

FIG. 4 is a functional block diagram showing example functions of a host apparatus and a guest apparatus during a sharing game.

The information processing apparatus 1a that serves as a host apparatus includes a game module 20 that is carried out based on execution of the game program PG, and a system module 30 that is carried out based on execution of the system program PS. The game module 20 carries out different functions in different game modes executed by the information processing apparatus 1a. For example, the information processing apparatus 1a has a function corresponding to each of a stand-alone mode in which the information processing apparatus 1a executes a game process alone, a communications multiplayer play mode in which a plurality of information processing apparatuses 1 execute the same game program to execute a game process while communicating with each other, and a game sharing mode in which while a host apparatus and a guest apparatus communicate with each other, the host apparatus executes a game program to execute a game process so as to display a game image on itself and transmits the game image to the guest apparatus. Specifically, the information processing apparatus 1a includes units 21a to 23a as a function corresponding to the stand-alone mode, units 21t to 23t as a function corresponding to the communications multiplayer play mode, and units 21s to 24s as a function corresponding to the game sharing mode.

The game process unit 21a executes a game process for causing a game to proceed in the stand-alone mode (e.g., the process of controlling each object in a game space, or the process of updating a parameter indicating a game situation). The game process unit 21a obtains operation data of the self-apparatus, and outputs, to the image generation unit 22a, a game parameter indicating a result of a game process based on the operation data (e.g., a parameter indicating the position, state, or the like of each object in a game space, or a parameter indicating a game situation).

The image generation unit 22a outputs and generates a game image in a frame buffer 23a based on a game parameter output from the game process unit 21a. The data of the game image thus generated is output to an audio/image data transmission/reception unit 32 included in the system module 30 so that an image to be displayed on the self-apparatus is shared with another information processing apparatus 1. A game image rendered in the frame buffer 23a by the image generation unit 22a is output to the display 15 of the self-apparatus. It should be noted that the game module 20 (e.g., an audio generation unit) generates game sounds accompanying the game image, and outputs the generated game sound data to the audio output unit 16 of the self-apparatus.

The game process unit 21t executes a game process for causing a game to proceed in the communications multiplayer play mode. The game process unit 21t obtains operation data of the self-apparatus and operation data of another information processing apparatus 1 that performs communication in communications multiplayer play, and outputs, to the image generation unit 22t, a game parameter indicating a result of a game process based on the operation data.

The image generation unit 22t outputs and generates a game image in a frame buffer 23t based on a game parameter output from the game process unit 21t. The data of the game image thus generated is output to the audio/image data transmission/reception unit 32 included in the system module 30 so that an image to be displayed on the self-apparatus is shared with another information processing apparatus 1. The game image rendered in the frame buffer 23t by the image generation unit 22t is output to the display 15 of the self-apparatus. It should be noted that the game module 20 (e.g., an audio generation unit) generates game sounds accompanying the game image, and outputs the generated game sound data to the audio output unit 16 of the self-apparatus.

The game process unit 21s executes a game process for causing a game to proceed in the game sharing mode. The game process unit 21s obtains operation data of the self-apparatus (host apparatus) and operation data of a guest apparatus output from a guest operation data reception unit 34 included in a game sharing function (for a host) 30h of the system module 30, and outputs, to the image generation unit 22s, a game parameter indicating a result of a game process based on the operation data.

The image generation unit 22s outputs and generates a game image in a frame buffer 23s based on a game parameter output from the game process unit 21s. A game image for a host apparatus may be the same as or different from a game image for a guest apparatus. When these game images are different from each other, the image generation unit 22s generates the game images and renders the game images in different memory areas. When these game images are the same as each other, the image generation unit 22s generates only one game image. In the case in which there are a plurality of guest apparatuses, the image generation unit 22s may generate the same game image for all guest apparatuses or different game images for different guest apparatuses.

The image generation unit 22s generates a game image for a host apparatus and outputs the game image to the frame buffer 23s. The game image written in the frame buffer 23s is displayed on the display 15 of the information processing apparatus 1a. A guest image data transmission unit 35 included in the game sharing function (for a host) 30h of the system module 30 obtains data of a game image for a guest apparatus, of the generated game images (a game image written in the frame buffer 23s in the case in which a game image for a host apparatus is the same as a game image for a guest apparatus), and transmits the data to the guest apparatus. The audio/image data transmission/reception unit 32 included in the system module 30 obtains the data of the generated game image for a host apparatus (the self-apparatus) in order to share an image to be displayed on the self-apparatus with another information processing apparatus 1 (image sharing), and transmits the data to members of a communication group. It should be noted that these processes executed by the guest image data transmission unit 35 and the audio/image data transmission/reception unit 32 may be repeated for each predetermined cycle in accordance with an instruction from the game module 20, or each time a new game image is rendered in the frame buffer, or in accordance with an instruction from the game module 20. It should be noted that the game module 20 (e.g., an audio generation unit) generates game sound accompanying the game image, and outputs the generated game sound data to the guest image data transmission unit 35. The game module 20 (e.g., an audio generation unit) also generates game sounds accompanying the game image, and outputs the generated game sound data to the audio output unit 16 of the self-apparatus.

The invitation unit 24s, which is for giving an invitation to a sharing game, selects another information processing apparatus 1 that is to be invited to a sharing game performed with the self-apparatus serving as a host apparatus, from the members of the communication group to which the self-apparatus belongs. Thereafter, the invitation unit 24s outputs a request for inviting the selected information processing apparatus 1 to play the sharing game, to an invitation data transmission unit 36 included in the game sharing function (for a host) 30h. The invitation unit 24s also sets a guest apparatus registered based on a reply from an invited information processing apparatus as a coplayer in the sharing game.

The system module 30 includes a communication function 30c, a game sharing function (for a host) 30h, a game sharing function (for a guest) 30g, and a continuous activation function 30j. The communication function 30c includes units 31 to 33 as the function of, together with another information processing apparatus 1, forming a communication group, and performing voice chat or video chat and game image sharing in the communication group. The game sharing function (for a host) 30h includes units 34 to 36 for functioning as a host apparatus when a sharing game is performed between a plurality of information processing apparatuses 1. The game sharing function (for a guest) 30g includes units 37 and 38 for functioning as a guest apparatus when a sharing game is performed between a plurality of information processing apparatuses 1. The continuous activation function 30j includes units 39 to 41 as the function of executing a main-body function process.

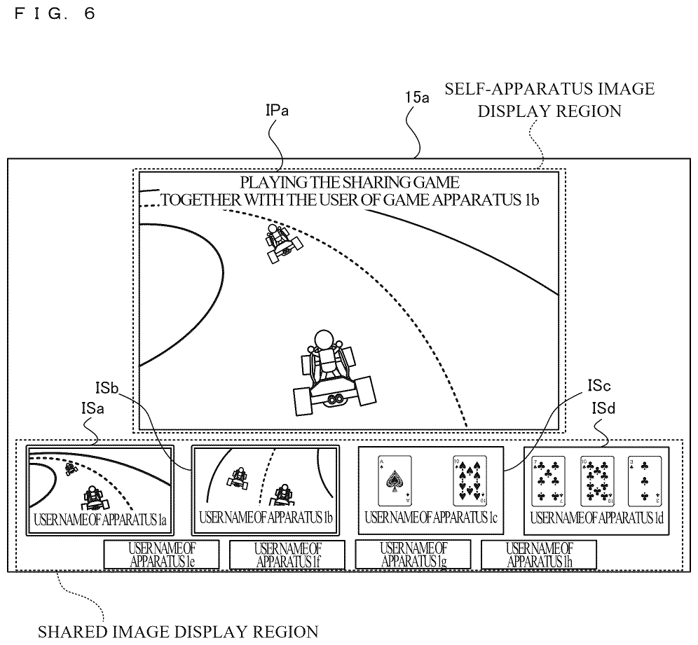

The audio/image data transmission/reception unit 32, which is a module for the communication function, receives a game image for image sharing from another information processing apparatus 1 through the server 101a, and transmits game image data obtained from the frame buffer of the game module 20 of the self-apparatus to another information processing apparatus 1 through the server 101a. Specifically, the audio/image data transmission/reception unit 32 receives a game image of another information processing apparatus 1 that is a member of the communication group to which the self-apparatus belongs, and outputs the game image to the frame buffer 33, thereby displaying the game image on the display 15 (in FIG. 6, ISb, ISc, ISd). The audio/image data transmission/reception unit 32 also executes the process of reducing the resolution of image data of the self-apparatus generated by the image generation unit 22a, and thereafter, outputs the image data to the frame buffer 33 (in FIG. 6, ISa) and transmits the image data to the server 101a. The image data thus transmitted is transmitted to another information processing apparatus 1 that belongs to the above communication group, by the server 101a. The members of the communication group are identified by the group management unit 105. It should be noted that the audio/image data transmission/reception unit 32 transmits image data for image sharing of the self-apparatus to the server 101a in association with a communication group ID indicating the communication group to which the self-apparatus belongs and an ID indicating the self-apparatus. The audio/image data transmission/reception unit 32 also receives, from the server 101a, game image data for image sharing transmitted from another information processing apparatus 1 belonging to the above communication group together with an ID indicating the transmission source device, and outputs the image data to the frame buffer 33, thereby displaying an image on the display 15.

The audio/image data transmission/reception unit 32 obtains the user's voice data collected by the audio input unit 17 of the self-apparatus. Thereafter, the audio/image data transmission/reception unit 32 transmits the obtained voice data to another information processing apparatus 1 belonging to the above communication group through the group management unit 105 included in the server 101a. It should be noted that the audio/image data transmission/reception unit 32 transmits, to the server 101a, the voice data of the self-apparatus in association with a communication group ID indicating the communication group to which the self-apparatus belongs and an ID indicating the self-apparatus. The audio/image data transmission/reception unit 32 also receives, through the group management unit 105 included in the server 101a, voice data transmitted from another information processing apparatus 1 belonging to the above communication group together with an ID indicating the transmission source device. It should be noted that the system module 30 (e.g., an audio generation unit) generates audio (a user's voice) based on voice data obtained by the audio/image data transmission/reception unit 32, and outputs the generated audio to the audio output unit 16 of the self-apparatus.

The frame buffer 33 renders an image for image sharing output from the audio/image data transmission/reception unit 32, e.g., images for image sharing of the self-apparatus and another information processing apparatus 1 belonging to the above communication group. The rendered image is displayed on the display 15 of the self-apparatus.

In order to execute a sharing game in which the self-apparatus serves as a host apparatus, the guest operation data reception unit 34 receives operation data transmitted from an information processing apparatus 1 that serves as a guest apparatus in the sharing game, through a game management unit 106 of the server 101b, or peer-to-peer communications from the guest apparatus. Thereafter, the guest operation data reception unit 34 outputs the operation data to the game process unit 21s of the game module 20 of the self-apparatus together with the ID of the information processing apparatus on which the operation has been performed, the ID having been transmitted in association with the received operation data of the guest apparatus.

The guest image data transmission unit 35 transmits game image data in which a game image (for a guest apparatus) rendered in the frame buffer 23s (a memory area for a guest image) by the image generation unit 22s of the game module 20 of the self-apparatus is associated with a game session ID, to a guest apparatus through the game management unit 106 of the server 101b or peer-to-peer communication. The guest image data transmission unit 35, when transmitting the game image data to the server 101b, also transmits game sound data related to the transmitted game image, in association with the game session ID.

The invitation data transmission unit 36, when receiving an instruction to transmit invitation data for a sharing game from the game module 20, transmits the invitation data together with information indicating the sharing game to the game management unit 106 of the server 101b.

When the information processing apparatus 1a is operating as a host apparatus, the game sharing function (for a guest) 30g in the system module 30 of the information processing apparatus 1a is not operating. The game sharing function (for a guest) 30g in the system module 30 of the information processing apparatus 1a is activated when a sharing game is performed with the information processing apparatus 1a serving as a guest apparatus. When activated, the game sharing function (for a guest) 30g in the information processing apparatus 1a carries out a function similar to a game sharing function (for a guest) 50g in a system module 50 described below of the information processing apparatus 1b that operates as a guest apparatus. It should be noted that in the case in which the information processing apparatus 1a is configured to have only functions for operating as a host apparatus, the information processing apparatus 1a may not include the game sharing function (for a guest) 30g.

The dedicated button menu processing unit 42 is activated when the dedicated button 3 is operated (more specifically, immediately after the dedicated button 3 is operated). Specifically, when the communication function 30c is not active, the dedicated button menu processing unit 42 starts the sequence of activating the communication function 30c. For example, the dedicated button menu processing unit 42 provides a user interface for the communication function. This user interface is referred to as a dedicated button menu. The dedicated button menu processing unit 42 displays various states of the communication function, depending on the user's operation, and in addition, performs various settings and the like. Specifically, the dedicated button menu processing unit 42 provides a user interface for forming the above communication group, a user interface for displaying various states of the communication function, and a user interface for setting various functions. It should be noted that the dedicated button menu may include a user interface for receiving an invitation from a host apparatus for the game sharing function employing Internet communications. This user interface may be used to select displaying and accepting the above invitation, or may be used to transition to a screen for such selection.

In addition, the other functions in the continuous activation function 30j in the system module 30 are basically similar to those in a continuous activation function 50j in a system module 50 described below, and will not be herein described in detail.

The information processing apparatus 1b that serves as a guest apparatus includes a system module 50 that is carried out by execution of the system program PS. The system module 50 includes a communication function 50c, a game sharing function (for a host) 50h, a game sharing function (for a guest) 50g, and a continuous activation function 50j. The communication function 50c includes units 51 to 53 as the function of, together with another information processing apparatus 1, forming a communication group, and performing voice chat and game image sharing in the communication group. The game sharing function (for a guest) 50g includes units 57 and 58 for functioning as a guest apparatus when a sharing game is played between a plurality of information processing apparatuses 1. The game sharing function (for a host) 50h includes units 54 to 56 for functioning as a host apparatus when a sharing game is played between a plurality of information processing apparatuses 1. The continuous activation function 50j includes units 59 to 62 as the function of executing a main-body function process.

The function of the communication function 50c in the system module 50 is basically similar to the function of the communication function 30c in the system module 30. It should be noted that a game image for image sharing that is transmitted by the audio/image data transmission/reception unit 52 to another information processing apparatus that is another member in the same communication group is not a game image generated by the image generation unit of the self-apparatus, and is a game image generated by a host apparatus and received through the server 101b.

The guest operation data transmission unit 57 obtains operation data of the self-apparatus. Thereafter, the guest operation data transmission unit 57 transmits the obtained operation data of the self-apparatus in association with the game session ID of a sharing game that is being played, to a host apparatus, through the game management unit 106 of the server 101b or peer-to-peer communications.

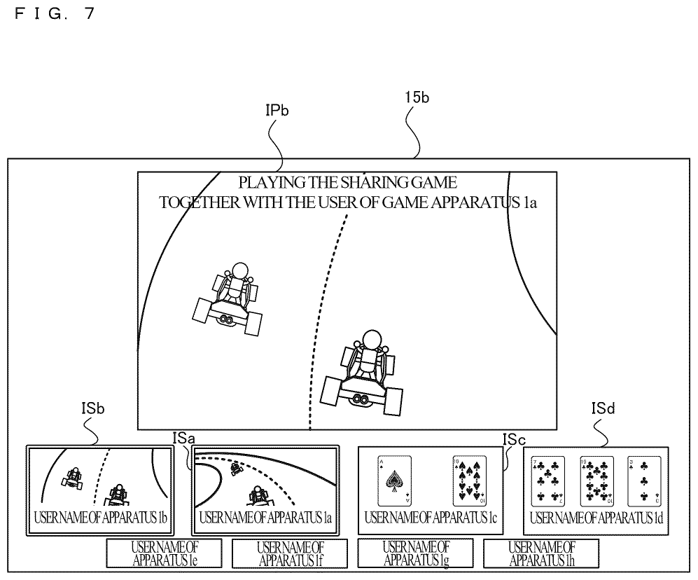

The frame buffer rendering unit 58 renders, in the frame buffer, a game image for a guest apparatus transmitted from the guest image data transmission unit 35 in the system module 30 of a host apparatus. The rendered game image is output to the display 15 of the self-apparatus (in FIG. 7 described below, IPb). The game image is also subjected to a resolution reduction process before being rendered in the frame buffer 53 (in FIG. 7 described below, ISb). It should be noted that the system module 50 (e.g., an audio generation unit) generates game sounds based on game sound data transmitted in association with the game image, and outputs the generated game sounds from the audio output unit 16 of the self-apparatus.

The invitation reception unit 59 receives invitation data to a sharing game transmitted from a host apparatus through the server 101b or peer-to-peer communications.

The invitation information display unit 60 outputs and renders, in the frame buffer of the self-apparatus, invitation information indicating details of an invitation from a host apparatus based on the received invitation data, thereby prompting the user of the self-apparatus to participate in a sharing game to which the user is invited with the invitation data.

When there is an invitation from a host apparatus, the participation unit 61 transmits participation data indicating participation to the host apparatus through the server 101b or peer-to-peer communications, in accordance with the user's operation for accepting participation in a sharing game. The participation unit 61, when receiving information indicating that the self-apparatus has been registered as a guest apparatus, sets the game session ID indicating a host apparatus registered as a coplayer of a sharing game and the sharing game.

The dedicated button menu processing unit 62 displays a dedicated button menu including a user interface for the communication function and a user interface for the game sharing function when the dedicated button 3 is operated.

When the information processing apparatus 1b is operating as a guest apparatus, the game sharing function (for a host) 50h in the system module 50 of the information processing apparatus 1b is not operating. When a sharing game is played with the information processing apparatus 1b serving as a host apparatus, the game sharing function (for a host) 50h is activated. When the game sharing function (for a host) 50h in the information processing apparatus 1b is activated, the game sharing function (for a host) 50h carries out a function similar to the game sharing function (for a host) 30h in the system module 30 of the information processing apparatus 1a that operates as a host apparatus. It should be noted that in the case in which the information processing apparatus 1b is configured to have only functions for operating as a guest apparatus, the information processing apparatus 1b may not include the game sharing function (for a host) 50h.

The server 101a includes the group management unit 105 that manages a communication group, and exchanges data with each information processing apparatus 1. The group management unit 105 assigns different group IDs to different communication groups, and manages members (the IDs of information processing apparatuses 1) belonging to a communication group based on member registration related information such as information indicating request for joining a communication group and information indicating acceptance transmitted from each information processing apparatus 1. The group management unit 105, when receiving data from a member belonging to a communication group, executes a process corresponding to the received data, based on member information of the communication group. The group management unit 105, when receiving image data for image sharing, transfers the image data to another member based on a communication group ID associated with the image data. In addition, the group management unit 105, when receiving voice data, transfers the voice data to another member based on a communication group ID associated with the voice data.

The server 101b, which includes the game management unit 106 that manages a host apparatus and a guest apparatus (e.g., the IDs of the host apparatus and the guest apparatus) that play a sharing game, exchanges data (specifically, game image data and operation data) with each information processing apparatus 1. The game management unit 106, when receiving, from an information processing apparatus 1, an instruction to transmit an invitation to another information processing apparatus 1, transmits invitation data to an invited member in association with information indicating a sharing game to which the another information processing apparatus 1 is invited and an ID indicating the invitation source. The game management unit 106 manages a set of a host apparatus and a guest apparatus together with the game session ID based on participation data received from the invited member. In addition, the game management unit 106, when receiving operation data from a guest apparatus, transfers the received operation data to a corresponding host apparatus. In addition, the game management unit 106, when receiving game image data from a host apparatus, transfers the received game image data to a corresponding guest apparatus. In addition, the server 101b manages an image sharing forbidding flag for a game coplayer (referred to as a “coplayer forbidding flag”). It should be noted that a sharing game can also be executed by exchanging of a game image and operation data between information processing apparatuses 1 through peer-to-peer communications without using the server 101b. The peer-to-peer communications may be based on Internet communications or local wireless communications.

It should be noted that a communications channel or communications network that is used for exchanging of data for the communication function between the server 101a and each information processing apparatus 1 may be the same as or different from a communications channel or communications network for exchanging of data for game sharing function between the server 101b and each information processing apparatus 1.

Thus, the function of the guest apparatus is carried out by a processor executing a system program without executing a game program. Therefore, the information processing apparatus 1 that serves as a guest apparatus can have the game sharing function for a guest and the communication function without installation of a specific game program. In addition, the information processing apparatus 1 that serves as a host apparatus can have basic portions of the game sharing function for a host and the communication function without implementation of a particular game program. As a result, it is no longer necessary to generate these functions for each game program, and therefore, the efficiency of development of a game program can be improved. In addition, since the information processing apparatus 1 can operate as a guest apparatus without installation of a specific game program, a sharing game can be played using a host apparatus and a guest apparatus if a game program is installed in the host apparatus. Thus, it is not necessary to install a game program in a guest apparatus, resulting in an improvement in convenience for the user.

In addition, in the present example, a single information processing apparatus 1 has a basic portion of the game sharing function for a host, and the game sharing function for a guest, due to a system program. Therefore, if a system program is installed in an information processing apparatus 1, the information processing apparatus 1 can operate either as a host apparatus or as a guest apparatus. Therefore, in the case in which a game is played using a game program stored in an information processing apparatus 1, the game can be easily played by multiple persons with the information processing apparatus 1 operated by the user serving as a host apparatus and information processing apparatuses 1 operated by other users serving as a guest apparatus. Alternatively, in the case in which a game is played using a game program stored in the information processing apparatus 1 of another user, the game can be easily played by multiple persons with the information processing apparatus 1 operated by the another user serving as a host apparatus and an information processing apparatus 1 operated by the user serving as a guest apparatus. This can further improve the user's convenience.

In addition, every function of the information processing apparatus 1 may be carried out either by execution of a game program or by execution of a system program. For example, in another example, the guest operation data reception unit of a host apparatus may be carried out by a game module by execution of a game program, and all portions of the game sharing function for a host may be carried out by execution of a game program.

In addition, information about a member of a communication group and information about a combination of a host apparatus and a guest apparatus with which a sharing game is played may be managed by an information processing apparatus 1. Specifically, at least one of the functions of the group management unit 105 in the server 101a and the function of the game management unit 106 in the server 101b may be provided as a function of at least one of a plurality of information processing apparatuses 1. In addition, information managed by the server 101a or 101b may be stored in an information processing apparatus 1.

In addition, one or at least three servers may control data communications between a plurality of information processing apparatuses 1. In the case in which a single server controls data communications between a plurality of information processing apparatuses 1, the server may have both the function of the group management unit 105 and the function of the game management unit 106. In that case, as to a communications channel(s) for data communications with the single server, a communications channel for use of the function of the group management unit 105 may be different from or the same as a communications channel for the use of the function of the game management unit 106.

As described above, a game image is shared in a communication group. In the present example, a limitation may be imposed on displaying of a game image for other members of a communication group. For example, in the present example, for at least one game member belonging to a game group in which a multiplayer game is played in the above game sharing mode or communications multiplayer play mode, displaying of a game image on the display of the game member is forbidden. Specifically, a game image is displayed on the displays of communication members belonging to a communication group excluding the forbidden game member.

As described above, a game image displayed on the display of a self-apparatus is shared by the apparatus of another user and displayed on the display of the another user, so that communication is performed by image sharing in a communication group. For example, in the case in which a multiplayer game is played in the communications multiplayer play mode, the above shared game image is generated and displayed by each information processing apparatus 1 that executes the game, and is used to play the multiplayer game in each information processing apparatus 1. In addition, in the case in which a multiplayer game is played in the game sharing mode, the above shared game image is an image generated and displayed by a host apparatus and an image for a guest apparatus that is generated by the host apparatus and is obtained and displayed by the guest apparatus, and is used to play the multiplayer game in each of the host apparatus and the guest apparatus.

In the present example, a user that is forbidden from the above image sharing is registered, and a game image of the registered user is not displayed even when received. For example, a user that is forbidden from the above image sharing is set as follows.

As a first example, of the communication members of a communication group, a user that is a coplayer in a multiplayer game that is being played by a self-apparatus is registered as one that is forbidden from image sharing (coplayer forbidding). As an example, in the case in which a trump game or mahjong game is being played as a multiplayer game by a plurality of members, a game image showing hand cards or hand tiles in the game is registered as one that is forbidden from image sharing for other members (members of the same communication group that are playing the same multiplayer game). As a result, a game image of a coplayer that is playing the game is registered as one that is forbidden from image sharing and therefore is not displayed, so that a game image showing hand cards or hand tiles is not seen by a game coplayer. It should be noted that the above game image is shared by a communication member that is not playing the multiplayer game together and is displayed. In the case in which there is a user that participates in the above multiplayer game as a spectator rather than a player, the above game image may be shared by the user and displayed.

As a second example, users that are forbidden from image sharing may be individually designated and registered as one that is forbidden from image sharing (individually forbidding). As an example, in the case in which a team competition game is played as a multiplayer game, members belonging to an opponent team are registered as one that is forbidden from image sharing. As a result, although a game image of each member belonging to a friendly team is shared by the members and displayed, a game image of each member belonging to an opponent team is registered as one that is forbidden from image sharing and is not displayed. Therefore, a game situation can be shared in one team and is not seen by another team.

As a third example, all users are registered as one that is forbidden from image sharing (all forbidding). As an example, in the case in which a puzzle-solving game is played, all other users are registered as one that is forbidden from image sharing. As a result, image sharing is not performed for other members of a communication group to which a player of the above puzzle-solving game belongs, and therefore, the answer to the puzzle is prevented from being known to other users before other users solve the puzzle, for example.

As a fourth example, a game image is shared by all other users including other members that are playing a multiplayer game (all permission). In this case, for other members of a communication group to which one member that is playing a multiplayer game belongs, a game image for which the one member is playing is shared and displayed by the function described above using the functional block diagram.

As shown in FIG. 4, in order to impose the above limitation on image sharing, the communication function 30c of the information processing apparatus 1a serving as a host apparatus in a sharing game has an image sharing limiting unit 31. The image sharing limiting unit 31 manages an all-forbidding flag and a forbidden user ID set in a host apparatus. In addition, the communication function 50c of the information processing apparatus 1b serving as a guest apparatus in a sharing game has an image sharing limiting unit 51. The image sharing limiting unit 51 manages an all-forbidding flag and a forbidden user ID set in a guest apparatus. In addition, the server 101b manages the coplayer forbidding flag in association with the user ID of a host apparatus that is executing the game sharing function.

In the present example, a game program specifies a form in which image sharing is forbidden (e.g., the form in one of the above first to fourth examples). For example, when a game program A that forbids image sharing in the form of the above first example is being executed in the game sharing mode by the game process unit 21s, the game process unit 21s instructs the game sharing function (for a host) 30h, through an API, to forbid all game sharing coplayer users based on identification information of users that are playing the game program A together in the game sharing mode (game members of the membership game group) (a first instruction to forbid a game sharing coplayer from image sharing). In this case, it is not necessary for the game program to specify individual user IDs that are to be forbidden. The game sharing function (for a host) 30h, when receiving the above first instruction from the game module 20, requests the server 101b to set the coplayer forbidding flag to on. When the above coplayer forbidding flag functions as an “image sharing forbidding flag for a game coplayer” and is on, all members that are currently playing together in a multiplayer game are forbidden from image sharing. The coplayer forbidding flag managed by the server 101b (the image sharing forbidding flag of a game coplayer) is set to on in association with the user ID of a host apparatus that has requested to set the coplayer forbidding flag to on, and can be referenced by the information processing apparatuses 1 of all game members in the above sharing game (e.g., a host apparatus and a guest apparatus in the sharing game). It should be noted that the coplayer forbidding flag may be managed by each of the information processing apparatuses 1 of all game members in the above sharing game (all client apparatuses that are executing a game process using the game sharing function).

A host apparatus in the above sharing game writes the user ID of a game sharing coplayer in the sharing game that is currently being executed into the forbidden user ID that is managed by the image sharing limiting unit 31 of the communication function 30c if one of the coplayer forbidding flags managed by the server 101b that corresponds to the user ID of the host apparatus is on. The audio/image data transmission/reception unit 32 of the communication function 30c, when receiving a game image for image sharing from another information processing apparatus 1 through the server 101a, does not output a game image associated with a forbidden user ID managed by the image sharing limiting unit 31 to the frame buffer 33. Therefore, a game image for image sharing corresponding to a forbidden user ID managed by the image sharing limiting unit 31 is not displayed on the display 15 of a host apparatus. Thus, a game image for image sharing for which image sharing is forbidden is designated as one that is not displayed on a host apparatus that has received the game image, and is not displayed on the display 15 of the host apparatus. Specifically, an apparatus that transmits the above game image for image sharing transmits the game image through the server 101a irrespective of image sharing being forbidden. However, a host apparatus that has received the game image displays the game image on the display 15 unless image sharing is forbidden for the received game image for image sharing.

In addition, a guest apparatus in the above sharing game writes the user ID of a game sharing coplayer in the sharing game into the forbidden user ID that is managed by the image sharing limiting unit 51 of the communication function 50c if one of the coplayer forbidding flags managed by the server 101b that corresponds to the user ID of the host apparatus of the sharing game group to which the guest apparatus belongs is on. The audio/image data transmission/reception unit 52 of the communication function 50c, when receiving a game image for image sharing from another information processing apparatus 1 through the server 101a, does not output the game image into the frame buffer 53 if the game image is associated with a forbidden user ID that is managed by the image sharing limiting unit 51. Therefore, a game image for image sharing corresponding to a forbidden user ID managed by the image sharing limiting unit 51 is not displayed on the display 15 of the guest apparatus. Thus, a game image for image sharing for which image sharing is forbidden is designated as one that is not displayed on a guest apparatus that has received the game image and is not displayed on the display 15 of the guest apparatus. Specifically, an apparatus that transmits the above game image for image sharing transmits the game image through the server 101a irrespective of image sharing being forbidden. However, a guest apparatus that receives the game image displays the game image on the display 15 unless image sharing is forbidden for the received game image for image sharing.

Although in the foregoing description in which image sharing is forbidden in the above first example form, an example has been described in which the game program A is played in the game sharing mode, the process of forbidding image sharing may also be similarly executed when the game program A is executed in the communications multiplayer play mode in the game process unit 21t. Specifically, the user ID of a multiplayer game coplayer is registered as a forbidden user ID, and when a game image (for image sharing) associated with the user ID is received, the game image is not displayed. The coplayer forbidding flag may be managed by each of the information processing apparatuses 1 of all game members that are playing a game in the communications multiplayer play mode, and may be set during game matching-up. Also in the case in which image sharing is forbidden in the form of the above first example in the communications multiplayer play mode, an information processing apparatus 1 that transmits the above game image for image sharing transmits the game image irrespective of image sharing being forbidden. However, an information processing apparatus 1 that receives the game image displays the game image on the display 15 unless image sharing is forbidden for the received game image for image sharing.

For example, when the game program B in which image sharing is forbidden in the form of the above second example is being executed by the game process unit 21s in the game sharing mode, the game process unit 21s designates a user to be forbidden from image sharing, based on identification information of a user that is performing game sharing play on the game program B (a game member of the membership game group), and instructs the game sharing function (for a host) 30h (a second instruction to individually forbid users from image sharing) through an API. As an example, when a team competition game is performed in the game sharing mode by the game program B, the users ID of users belonging to a coplayer team (e.g., an opponent team) are designated as one that is forbidden from image sharing. As another example, in the case in which there is a user that participates in a game executed by the game program B as a spectator rather than a player, the user IDs of users (specifically, users that participate as a player) excluding the user that participates as a spectator are designated as one for which image sharing is forbidden (as a result, players excluding a spectator are forbidden from image sharing).

The game sharing function (for a host) 30h, when receiving the above second instruction from the game module 20, writes the user ID designated as one for which image sharing is forbidden into the forbidden user ID managed by the image sharing limiting unit 31 of the communication function 30c. The audio/image data transmission/reception unit 32 of the communication function 30c, when receiving a game image for image sharing from another information processing apparatus 1 through the server 101a, does not output the game image to the frame buffer 33 if the game image is associated with a forbidden user ID that is managed by the image sharing limiting unit 31. Also in the case in which image sharing is forbidden in the form of the above second example, an apparatus that transmits the above game image for image sharing transmits the game image through the server 101a irrespective of image sharing being forbidden. However, a host apparatus that receives the game image displays the game image on the display 15 unless image sharing is forbidden for the received game image for image sharing.

In addition, when the game program B is being executed in the game sharing mode, the game sharing function (for a host) 30h transmits the user ID of a user that is to be forbidden from image sharing (e.g., the ID of a user in an opponent team against each guest) to each guest apparatus through the server 101b. A guest apparatus that has received the user ID of a user that is to be forbidden from the above image sharing, writes the user ID into the forbidden user ID that is managed by the image sharing limiting unit 51 of the communication function 50c. The audio/image data transmission/reception unit 52 of the communication function 50c, when receiving a game image for image sharing from another information processing apparatus 1 through the server 101a, does not output the game image to the frame buffer 53 if the forbidden user IDs managed by the image sharing limiting unit 51 include the user ID that indicates the transmission source apparatus associated with the game image. Also in the case in which image sharing is forbidden in the form of the above second example, an apparatus that transmits the above game image for image sharing transmits the game image through the server 101a irrespective of image sharing being forbidden. However, a guest apparatus that has receives the game image displays the game image on the display 15 unless image sharing is forbidden for the received game image for image sharing.

Although in the foregoing description in which image sharing is forbidden in the form of the above second example, an example has been described in which the game program B is played in the game sharing mode, the process of forbidding image sharing may also be similarly executed when the game program B is executed in the communications multiplayer play mode in the game process unit 21t. Specifically, in each information processing apparatus, the user IDs of members in an opponent team against the information processing apparatus are registered as a forbidden user ID.

For example, when a game program C in which image sharing is forbidden in the form of the above third example is being executed by the game process unit 21s, the game process unit 21s instructs the game sharing function (for a host) 30h, through an API, to forbid all users from image sharing (third instruction to forbid all). The game sharing function (for a host) 30h, when receiving the above third instruction from the game module 20, sets the all-forbidding flag managed by the image sharing limiting unit 31 of the communication function 30c to on. If the all-forbidding flag managed by the image sharing limiting unit 31 is on, the audio/image data transmission/reception unit 32 of the communication function 30c does not transmit image data for image sharing of the self-apparatus to any other apparatuses. Thus, in the case in which image sharing is forbidden in the form of the above third example, a host apparatus that transmits the above game image for image sharing does not transmit the game image to any other apparatuses. Therefore, since the above transmitter host apparatus does not transmit the game image itself, an apparatus that receives the above game image for image sharing is not allowed to display the game image on the display 15.

In addition, when the game program C is being executed in the game sharing mode, the game sharing function (for a host) 30h transmits, to each guest apparatus, a notification indicating all forbidding. A guest apparatus that receives the above all-forbidding notification sets the all-forbidding flag managed by the image sharing limiting unit 51 of the communication function 50c to on. The audio/image data transmission/reception unit 52 of the communication function 50c, when the all-forbidding flag managed by the image sharing limiting unit 51 is on, does not transmit the image data for image sharing of the self-apparatus to any other apparatuses. Thus, in the case in which image sharing is forbidden in the form of the above third example, a guest apparatus that transmits the above game image for image sharing does not transmit the game image to any other apparatuses. Therefore, since the above transmitter guest apparatus does not transmit the game image itself, an apparatus that receives the above game image for image sharing is not allowed to display the game image on the display 15.

Although in the foregoing description in which image sharing is forbidden in the form of the above third example, an example has been described in which the game program C is played in the game sharing mode, the process of forbidding image sharing may also be similarly executed by setting the all-forbidding flag to on when the game program C is executed by the game process unit 21t in the stand-alone mode or the communications multiplayer play mode.

In addition, various kinds of setting may be performed by execution of the above instructions by the game process unit through an API, or may be performed by another program after an instruction to perform each kind of settings is issued. In addition, although in the above examples, the process of forbidding image sharing itself is executed by execution of a system program, game the process of forbidding image sharing itself may be executed by execution of a game program.

In addition, in the present example, shared game images include not only a game image in a multiplayer game in which game sharing is performed between a plurality of information processing apparatuses 1, but also a game image in a multiplayer game in which a game program is executed in each information processing apparatus 1, a game image that is streamed and displayed in each information processing apparatus 1 by execution of a game program in a cloud server, and a game image displayed in an information processing apparatus 1 that executes a game program in the stand-alone mode. In addition, in another example, shared images in the present example may not be particularly limited. For example, shared images in the present example may be an image obtained by execution of any application program executed in an information processing apparatus 1, or an image (including a captured image) generated or set in an information processing apparatus 1 (e.g., a captured image, avatar image, icon image, letter image, and design image).

Next, an example operation of a plurality of information processing apparatuses belonging to a communication group will be described with reference to FIG. 5. FIG. 5 shows an example in which eight information processing apparatuses 1a to 1h that belong to the same communication group and an information processing apparatus 1z that does not belong to the communication group are operating in the respective game modes.

FIG. 5 shows that the information processing apparatuses 1a to 1h, which are within a dashed-line box, belong to the same communication group, and the information processing apparatus 1z, which is out of the dashed-line box, does not belong to the communication group. In addition, in FIG. 5, main functions that are being operated in each information processing apparatus 1 are indicated by a hatched regional block. The above communication group is constructed by each information processing apparatus executing a system program to operate the communication function, and therefore, the communication function is being operated in each of the information processing apparatuses 1a to 1h, which belong to the same communication group. Meanwhile, in the information processing apparatus 1z, which does not belong to the communication group, the communication function is not active.

In the present example, for the information processing apparatuses of a plurality of members belonging to the same communication group, a plurality of sets of a host apparatus and a guest apparatus(es) can be formed, and in each set, game sharing play in which a different game program is shared can be performed. It should be noted that the number of members that can belong to the same communication group may be limited (e.g., a maximum of 12) or may not be limited. In addition, the number of sets of a host apparatus and a guest apparatus(es) that can be formed in the same communication group and that play in the game sharing mode, e.g., a sharing play number, may be limited to a number of at least two in that communication group or may not be limited.

For example, two information processing apparatuses 1a and 1b belonging to the same communication group play a sharing game using a first game program in the game sharing mode with the information processing apparatus 1a serving as a first host apparatus and the information processing apparatus 1b serving as a first guest apparatus. At this time, in the information processing apparatus 1a serving as a first host apparatus, a game module carried out by execution of the first game program operates in the game sharing mode to execute a game process, and the game sharing function for a host that is carried out by execution of a system program operates. Meanwhile, in the information processing apparatus 1b serving as a first guest apparatus, a game module is not active, and the game sharing function for a guest that is carried out by execution of a system program operates.

In addition, two information processing apparatuses 1c and 1d belonging to the same communication group to which the information processing apparatuses 1a and 1b belong play a sharing game (a game different from the first game program; the game may be the same as the first game program) using a second game program in the game sharing mode with the information processing apparatus 1c serving as a second host apparatus and the information processing apparatus 1d serving as a second guest apparatus. At this time, in the information processing apparatus 1c serving as a second host apparatus, a game module that is carried out by execution of a second game program operates in the game sharing mode to execute a game process, and the game sharing function for a host that is carried out by execution of a system program operates. Meanwhile, in the information processing apparatus 1d serving as a second guest apparatus, a game module is not active, and the game sharing function for a guest that is carried out by execution of a system program operates.

Thus, in the present example, in a single communication group, a game sharing play that is performed by a first host apparatus and a first guest apparatus and another game sharing play that is performed by a second host apparatus and a second guest apparatus can be performed in parallel. In other words, a plurality of sets of game sharing functions can be activated in a communication group. In addition, voice chat and images can be shared between information processing apparatuses 1 belonging to the above communication group, and participants in a sharing game can be recruited, and therefore, a session for playing a sharing game can be easily formed. In addition, since a plurality of sharing games can be started in a communication group, even if there are few members possessing a game program in a communication group, a variety of game plays can be performed while communication is performed in the communication group. Therefore, communication using a game can be expected to be promoted.

Two information processing apparatuses 1e and 1f belonging to the same communication group each execute a third game program to play a multiplayer game in the communications multiplayer play mode. At this time, in each of the information processing apparatuses 1e and 1f, a game module that is carried out by execution of the third game program operates in the communications multiplayer play mode to execute a game process.

A single information processing apparatus 1g belonging to the same communication group plays a game in the stand-alone mode by execution of a fourth game program. At this time, in the information processing apparatus 1g, a game module that is carried out by execution of the fourth game program operates in the stand-alone mode to execute a game process.

In addition, an information processing apparatus 1h belonging to the same communication group plays a multiplayer game together with an information processing apparatus 1z that does not belong to that communication group, in the communications multiplayer play mode, by execution of a fifth game program. At this time, in each of the information processing apparatuses 1h and 1z, a game module that is carried out by execution of the fifth game program operates in the communications multiplayer play mode to execute a game process. Thus, in the present example, a multiplayer game can be played in the communications multiplayer play mode together with the information processing apparatus 1z that does not belong to the same communication group.

It should be noted that in another example, a sharing game may be able to be played in the game sharing mode between information processing apparatuses 1 that do not belong to the same communication group. In that case, a guest apparatus may be an information processing apparatus 1 that belongs to the same communication group or an information processing apparatus 1 that does not belong to the same communication group.

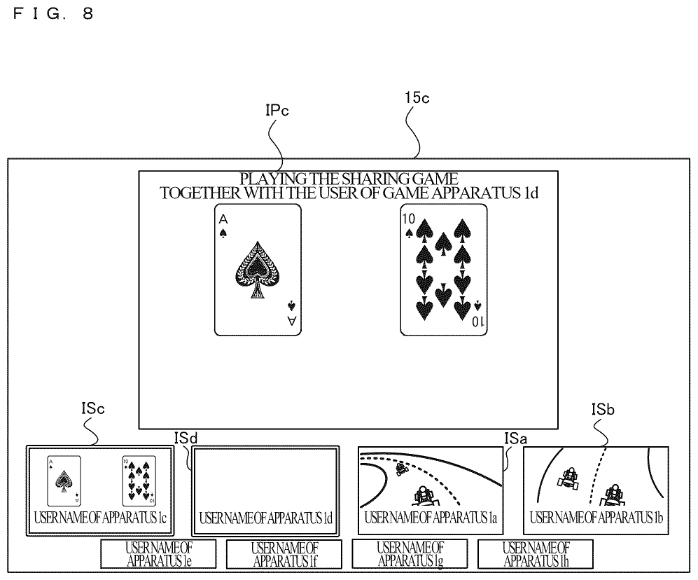

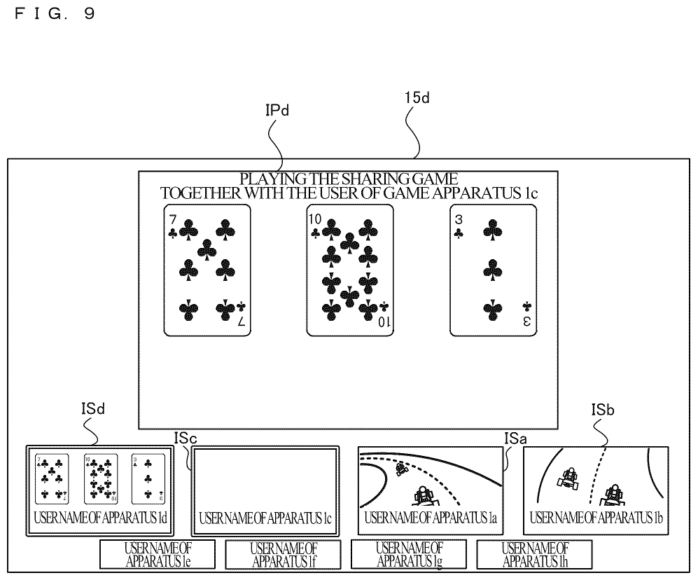

Next, an example image displayed on the display 15 of each information processing apparatus 1 in sharing game play will be described with reference to FIGS. 6 to 9. It should be noted that FIG. 6 is a diagram showing an example image displayed on a display 15a of an information processing apparatus 1a serving as a first host apparatus. FIG. 7 is a diagram showing an example image displayed on a display 15b of an information processing apparatus 1b serving as a first guest apparatus. FIG. 8 is a diagram showing an example image displayed on a display 15c of an information processing apparatus 1c serving as a second host apparatus. FIG. 9 is a diagram showing an example image displayed on a display 15d of an information processing apparatus 1d serving as a second guest apparatus.

In the examples described with reference to FIGS. 6 to 9, information processing apparatuses 1a to 1h also belong to the same communication group as described with reference to FIG. 5. The information processing apparatuses 1a and 1b play a sharing game using a first game program in the game sharing mode with the information processing apparatus 1a serving as a first host apparatus and the information processing apparatus 1b serving as a first guest apparatus. It should be noted that as to the above forbidding of image sharing, for the information processing apparatuses 1a and 1b, all other users are permitted to share the above game image for image sharing (the above fourth example (all permission)).

In the present example, in another apparatus belonging to the same communication group, a game image (self-apparatus image) for the another apparatus and, in addition, a game image (shared image) received from still another apparatus belonging to the same communication group are simultaneously displayed on the display 15. For example, as shown in FIG. 6, the display 15 of the information processing apparatus 1 has a self-apparatus image display region and a shared image display region. The self-apparatus image display region covers the greatest area in the display screen of the display 15, e.g., at least half of the area of the display screen, and is located at an upper portion of the display screen. The shared image display region covers the range of the display screen of the display 15 excluding the self-apparatus image display region, e.g., less than half of the area of the display screen, and is located at a lower portion of the display screen. In the shared image display region, game images of a plurality of information processing apparatuses are displayed (ISa, ISb, ISc, ISd). It should be noted that in the present example, a game image of the self-apparatus is also displayed in the shared image display region (ISa).

As shown in FIG. 6, the information processing apparatus 1a itself serves as a host apparatus, and plays a sharing game using a first game program together with the information processing apparatus 1b that serves as a guest apparatus. A game image IPa obtained when the user of the information processing apparatus 1a plays the sharing game is displayed in the self-apparatus image display region. Specifically, a racing game that is a sharing game is performed between the information processing apparatus 1a and the information processing apparatus 1b by execution of the first game program. The game image IPa, which shows that a first player character operated by the user of the information processing apparatus 1a is traveling on a race track, is displayed as a self-screen image of the information processing apparatus 1a. A game image IPb (game image received from the information processing apparatus 1b) showing that a second player character operated by the user of the information processing apparatus 1b is traveling on a race track is displayed as a screen image of the information processing apparatus 1b. In addition, in the game image IPa, sharing game identification display indicating that a sharing game is being played together with the user of the information processing apparatus 1b is displayed.

As shown in FIG. 7, in the information processing apparatus 1b, a game image IPb showing that the user of the information processing apparatus 1b is playing a game is displayed in the self-apparatus image display region. Specifically, the game image IPb, which shows that in the racing game performed by the information processing apparatus 1a executing the first game program, the second player character operated by the user of the information processing apparatus 1b is traveling on the same race track of the first player character, is displayed as a self-screen image of the information processing apparatus 1b. In addition, in the game image IPb, sharing game identification display indicating that a sharing game is being played together with the user of the information processing apparatus 1a is displayed.

Meanwhile, images displayed on apparatuses belonging to the same communication group are displayed in the shared image display region. As shown in FIG. 6, in the shared image display region of the display 15 of the information processing apparatus 1a, respective self-screen images of the other information processing apparatuses 1b to 1h, which belong to the same communication group, are displayed as a shared image. In addition, in the present example, a self-screen image of a self-apparatus (the information processing apparatus 1a) is displayed as one of shared images. In the example of FIG. 6, shared images ISa to ISd corresponding to self-screen images of the information processing apparatuses 1a to 1d are displayed together with the names of the users of the information processing apparatuses 1a to 1d in the shared image display region of the information processing apparatus 1a. In addition, for shared images of the information processing apparatuses 1e to 1h, only the names of the users of the information processing apparatuses 1e to 1h are displayed in the shared image display region of the information processing apparatus 1a, e.g., since none of the information processing apparatuses 1e to 1h is displaying a self-screen image, or self-image sharing is off in the information processing apparatuses 1e to 1h.

Thus, at least four (in the present example, four) shared images IS can be simultaneously displayed in the shared image display region of the display 15 of the information processing apparatus 1. As a result, game images (shared images ISa and ISb) in a first sharing game (e.g., a racing game), and game images (shared images ISc and ISd) in a second sharing game (e.g., a card game), can be displayed. Therefore, members belonging to a communication group can play a game while viewing play of sharing games performed by a plurality of sets of members.

In the present example, display indicating another apparatus that is executing a sharing game together with a self-apparatus is performed. For example, as shown in FIG. 6, the information processing apparatus 1a plays a sharing game together with the information processing apparatus 1b by execution of the first game program, and provides display “playing the sharing game together with the user of information processing apparatus 1b”. In addition, the shared image ISa of the information processing apparatus 1a and the shared image ISb of the information processing apparatus 1b, which indicate play of the sharing game, are displayed. The shared images ISa and ISb may be displayed in a particular form indicating that the shared images ISa and ISb are associated with each other, e.g., both of the shared images ISa and ISb are surrounded by a double-line box.

In addition, other shared images that are not associated are displayed in a display form different from the above particular display form. For example, as shown in FIG. 6, the information processing apparatuses 1c and 1d play a sharing game by execution of the second game program different from the game program of the information processing apparatuses 1a and 1b, and the shared image ISc of the information processing apparatus 1c and the shared image ISd of the information processing apparatus 1d, which display play of the sharing game, are displayed. The shared images ISc and ISd are displayed in a display form different from the above particular display form. It should be noted that as to the above forbidding of image sharing, for the information processing apparatuses 1c and 1d, a user that is a coplayer in the multiplayer game is forbidden to share the above game image for image sharing (the above first example (coplayer forbidding)).

It should be noted that the number of shared images IS displayed in the shared image display region is not particularly limited. Not all shared images IS of members belonging to a communication group may be displayed. In addition, shared images IS displayed in the shared image display region may not include a shared image corresponding to the self-screen image of a self-apparatus (the information processing apparatus 1a).

In addition, as shown in FIG. 7, the information processing apparatus 1b displays the shared image ISb of the information processing apparatus 1b and the shared image ISa of the information processing apparatus 1a, which indicate play of a sharing game that is played together with the information processing apparatus 1b by execution of the first game program. Also in the information processing apparatus 1b, the shared images ISa and ISb are displayed in a particular display form in which both of the shared images ISa and ISb are surrounded by a double-line box, indicating that the shared images ISa and ISb are associated with each other. In addition, also in the information processing apparatus 1b, the shared images ISc and ISd that display play of a sharing game performed by execution of the second game program and that are different from the information processing apparatuses 1a and 1b are displayed. The shared images ISc and ISd are both displayed in a display form different from the above particular display form.

Thus, by displaying shared images using these display forms, the user of the information processing apparatus 1a can easily identify a game image displayed on the information processing apparatus 1b, which is performing a sharing game together with the self-apparatus. In addition, in shared images, the names of the users of the respective information processing apparatuses displaying the shared images are displayed, and therefore, members belonging to a communication group can know how a game is being played and can be encouraged to communicate information about game play with each other.

Meanwhile, as shown in FIG. 8, the information processing apparatus 1c itself serves as a host apparatus and plays a sharing game together with the information processing apparatus 1d, which serves as a guest apparatus, using the second game program that is different from the first game program. A game image IPc obtained when the user of the information processing apparatus 1c plays the sharing game is displayed in the self-apparatus image display region. Specifically, a card game is played between the information processing apparatus 1c and the information processing apparatus 1d by execution of the second game program. The game image IPc, which shows hand cards in the card game that are possessed by a third player character operated by the user of the information processing apparatus 1c, is displayed as a self-screen image of the information processing apparatus 1c. In the game image IPc, sharing game identification display indicating that a sharing game is being played together with the user of the information processing apparatus 1d is displayed.

In addition, as shown in FIG. 9, in the information processing apparatus 1d, a game image IPd obtained when a game is being played by the user of the information processing apparatus 1d is displayed in the self-apparatus image display region. Specifically, the game image IPd, which shows hand cards that are possessed by a fourth player character operated by the user of the information processing apparatus 1d in the card game performed by the information processing apparatus 1c executing the second game program, is displayed as a self-screen image of the information processing apparatus 1d. In the game image IPd, sharing game identification display indicating that a sharing game is being played together with the user of the information processing apparatus 1c is displayed.

In card games such as that described above, the game may not be established, if one's hand cards are seen by another player. In the present example, in the case in which a game is played in which it is not preferable that a game image of a self-apparatus be seen by a game coplayer, the game coplayer is set as a player that is forbidden from image sharing, by the above image sharing forbidding setting process, and a blank image is set as a shared image of the game coplayer so that the game image of the self-apparatus is not displayed as a shared image on the display of the game coplayer, for example.

As shown in FIG. 8, the shared images ISa to ISd corresponding to the self-screen images of the information processing apparatuses 1a to 1d, which belong to the same communication group, are displayed together with the names of the users of the information processing apparatuses 1a to 1d in the shared image display region of the information processing apparatus 1c. Here, the information processing apparatus 1c is playing a card game as a sharing game together with the information processing apparatus 1d, and a blank image is displayed as the shared image ISd of the information processing apparatus 1d of the coplayer user in the shared game because image sharing is forbidden for the information processing apparatus 1d. The shared images ISc and ISd are displayed in a particular display form in which both of the shared images ISc and ISd are surrounded by a double-line box, indicating that the shared images ISc and ISd are associated with each other, and that the shared image ISd is of the coplayer user. In addition, the information processing apparatuses 1a and 1b are playing a sharing game by execution of the first game program, which is different from that of the information processing apparatuses 1c and 1d, and displaying the shared images ISa and ISb showing play of the sharing game because image sharing is permitted for all. Both of the shared images ISa and ISb are displayed in a display form different from the above particular display form.

In addition, as shown in FIG. 9, the shared images ISa to ISd corresponding to the self-screen images of the information processing apparatuses 1a to 1d, which belong to the same communication group, are also displayed together with the names of the users of the information processing apparatuses 1a to 1d in the shared image display region of the information processing apparatus 1d. As described above, the information processing apparatus 1d is playing a card game as a sharing game together with the information processing apparatus 1c, and a blank image is displayed as the shared image ISc of the information processing apparatus 1c of the coplayer user because image sharing is forbidden for the information processing apparatus 1c. The shared images ISc and ISd are displayed in a particular display form in which both of the shared images ISc and ISd are surrounded by a double-line box, indicating that the shared images ISc and ISd are associated with each other, and that the shared image ISc is a game image of the coplayer user. In addition, the information processing apparatuses 1a and 1b play a sharing game different form that of the information processing apparatuses 1c and 1d, and the shared images ISa and ISb are displayed, showing play of the sharing game, because image sharing is permitted for all. The shared images ISa and ISb are both displayed in a display form different from the above particular display form.

Thus, in the case in which a game is played in which it is not preferable that the game image of a self-apparatus be seen by a game coplayer, image sharing is forbidden, and an image from which the situation of game play of the game coplayer is not known is displayed as a shared image of the game coplayer. Therefore, for a user playing such a game, even when a game coplayer belongs to the same communication group, an image that does not obstruct the game play is displayed as a shared image of the game coplayer, and therefore, a failure in game competition can be prevented. Meanwhile, as shown in FIGS. 6 and 7, even in a game in which it is not preferable that a game image be seen by a game coplayer, members of a communication group that are not involved in the game are allowed to see the game situations of all users participating in the game by viewing shared images. Therefore, communication in a communication group can be promoted.

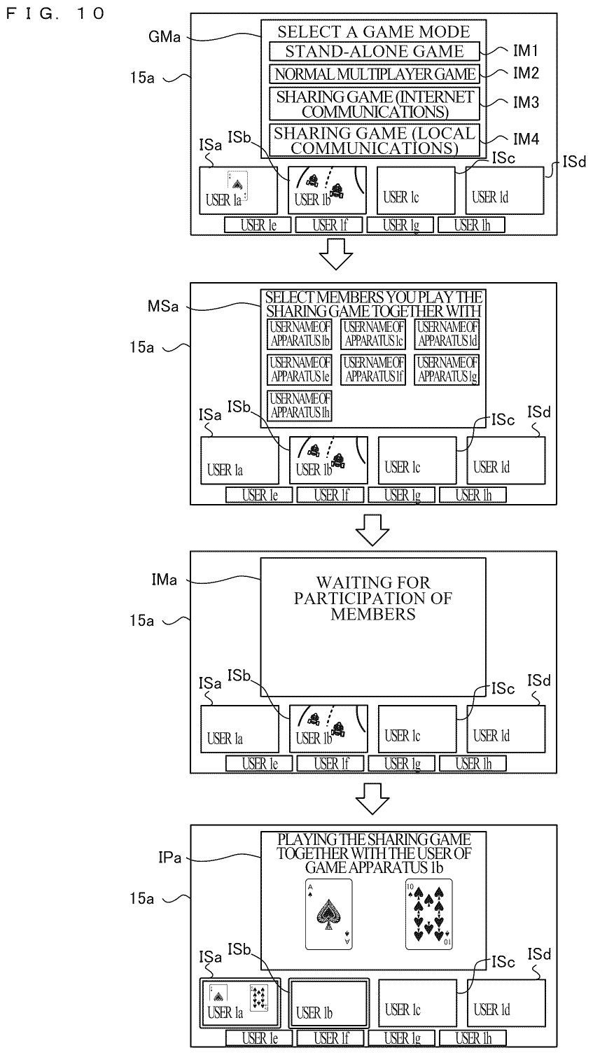

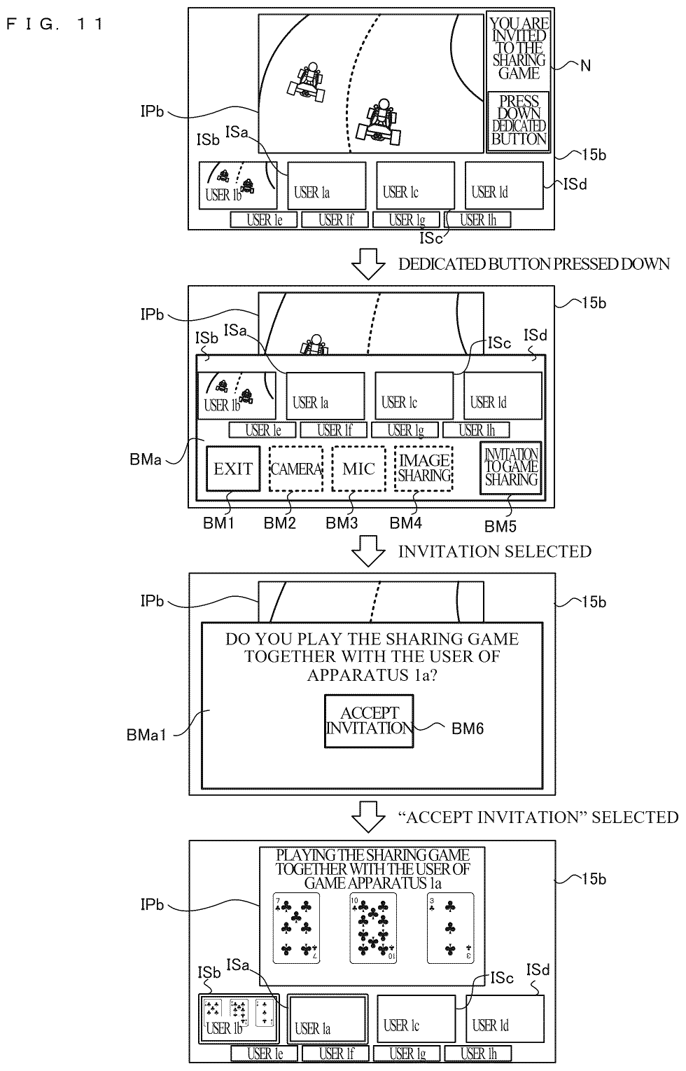

Next, an example image displayed on the display 15 of each information processing apparatus 1 when invited to a sharing game will be described with reference to FIGS. 10 and 11. It should be noted that FIG. 10 is a diagram showing an example image that is displayed by an information processing apparatus 1 that serves as a host apparatus, and that is displayed on a display 15a when an information processing apparatus 1a that serves as a host apparatus invites another information processing apparatus 1 to participate in a sharing game. FIG. 11 is a diagram showing an example image that is displayed by an information processing apparatus 1 that serves as a guest apparatus, and that is displayed on a display 15b when an information processing apparatus 1b receives an invitation to a sharing game from another information processing apparatus (1a) and participates in the sharing game, in accordance with operation of the dedicated button 3.

In the present example, a game program that is executed by the processor 11 of the information processing apparatus 1 includes codes for allowing a processor to carry out the process of operating the self-apparatus in each game mode (the stand-alone mode, communications multiplayer play mode, and game sharing mode), and when executing in the game sharing mode, executing the host function of a system program. For example, as shown in the top figure of FIG. 10, execution of a game process in the game mode selected from a menu such as a top menu displayed by a game program is started, and in the case of the game sharing mode, the host function is activated, so that a guest apparatus can be invited to a sharing game. Thus, the host function in the game sharing mode is executed by execution of a game program.

For example, in the top figure of FIG. 10, when a game program is executed in the information processing apparatus 1a, a menu image GMa, which is a self-screen image, is displayed on the display 15a as a user interface that prompts the user of the information processing apparatus 1a to select a game mode. The menu image GMa shows, as options, game modes that a game program that is being executed by the information processing apparatus 1a can provide. As an example, the menu image GMa shows a menu IM1 for starting a game in the stand-alone mode, a menu IM2 for starting a game in the communications multiplayer play mode, a menu IM3 for starting a game in the game sharing mode employing Internet communications, and a menu IM4 for starting a game in the game sharing mode employing local wireless communications. When the user of the information processing apparatus 1a performs an operation of selecting an option displayed in the menu image GMa, a game process is started in the selected game mode. In the following description, an example will be described in which the user of the information processing apparatus 1a selects the start of a game that is played in the game sharing mode employing Internet communications.

When the menu IM3 is selected by the above selection operation, in the information processing apparatus 1a the game sharing mode employing Internet communications is activated with the self-apparatus serving as a host apparatus, and the game sharing function 30h for a host in the system module 30 is activated. At this time, the server 101b is notified of the activation of the game sharing mode employing Internet communications, a session ID for a sharing game is assigned to the server 101b, and the information processing apparatus 1a is registered as a member serving as a host apparatus.

In the second figure from the top of FIG. 10, the display 15a of the information processing apparatus 1a displays a member selection image MSa indicating options for selecting a member that is to play a sharing game together with the information processing apparatus 1a itself. For example, in the present example, the name of each member of the communication group to which the self-apparatus belongs (the name of the user of each information processing apparatus 1) is obtained from the server 101a, and is displayed as an option. In the present example, the options include only members of the communication group to which the self-apparatus belongs. Therefore, coplayers in game sharing employing Internet communications are limited to the members of the communication group to which the self-apparatus belongs. When the user of the information processing apparatus 1a performs an operation of selecting at least one of the options, an information processing apparatus 1 corresponding to the selected option is invited to a sharing game through the server 101b. As a first example, for one of the members belonging to a communication group, all members except for the one member may be displayed as the options on the display of the one member. As a second example, for one of the members belonging to a communication group, only logged-in members except for the one member may be displayed as the options on the display of the one member. As a third example, the members displayed as the options may include members belonging to other communication groups and members that do not belong to any communication group (members for which the communication function is not active). In addition, members displayed as the options may be limited to those registered as a friend.

In the third figure from the top of FIG. 10, the display 15a of the information processing apparatus 1a displays a notification image Ima notifying that the information processing apparatus 1a is waiting for participation of members after inviting other members to participate in a sharing game in order to notify other members that the information processing apparatus 1a is waiting for a rely indicating participation to the invitation. The server 101b transmits invitation data to an information processing apparatus 1 that has been selected for the invitation as described above, and when receiving, from the information processing apparatus 1, participation data indicating participation as a reply to the invitation data, executes the process of registering the information processing apparatus 1 as a member serving as a guest apparatus. When a host apparatus and a guest apparatus are determined for a sharing game, the server 101b transmits, to the information processing apparatus 1a, information indicating the determination, the game session ID indicating a sharing game performed between the host apparatus and the guest apparatus, and the like.

In the bottom figure of FIG. 10, a sharing game is started in which the information processing apparatus 1b, which has returned participation data in response to an invitation to the sharing game made by the information processing apparatus 1a, serves as a guest apparatus, and the display 15a of the information processing apparatus 1a displays, as a self-screen image, a game image IPa of the information processing apparatus 1a generated in the sharing game. In the game image IPa, sharing game identification display indicating that the sharing game is being played together with the user of the information processing apparatus 1b is displayed. In addition, the above self-screen image is also displayed as a shared image ISa in the shared image display region of the display 15a. It should be noted that the sharing game illustrated in FIG. 10 is a game in which it is not preferable that a shared image be seen by a game coplayer user against the self-apparatus, and therefore, the game coplayer user is forbidden from image sharing. Therefore, a shared image ISb of the guest apparatus in the sharing game is a blank image showing only the name of the user of the information processing apparatus 1b.

Thus, in the present example, in a game menu displayed by a game program, the game sharing function can be activated as a host apparatus. In addition, in the present example, when the game sharing mode employing Internet communications is selected, the members of a communication group to which one player belongs are displayed as options for selecting a coplayer that is to be invited to sharing game play. Therefore, a trigger for activating the game sharing function as a host apparatus is provided by the game menu of a game program, and therefore, is easily understood by a user that plays a game. In addition, the members of a communication group to which one player belongs are invited to multiplayer play of a sharing game, and therefore, a sharing game can be played while communication is performed. It should be noted that for one member belonging to a communication group, users that do not belong to the communication group (e.g., users registered as a friend, logged-in users of the users registered as a friend, and users of other information processing apparatuses 1 that can perform near-field wireless communications) may also be displayed as options for selecting a coplayer that is to be invited to play a sharing game, or only members belonging to the communication group may be displayed as the options.

Meanwhile, the processor 11 of the information processing apparatus 1 carries out the function of receiving an invitation to a sharing game from another information processing apparatus 1 by the continuous activation function in the system module 50. For an invitation to a sharing game employing Internet communications, of invitations to a sharing game, the function of accepting participation in the sharing game in response to the invitation from another information processing apparatus 1 is carried out by a dedicated button menu process. For example, a dedicated button menu can be displayed in which even when the information processing apparatus 1 is executing a game program in any one of the game modes, a game that is being played can be temporarily saved by execution of the dedicated button 3, and the arrival of an invitation to a sharing game (Internet communications) from another information processing apparatus 1 can be checked.

For example, in the top figure of FIG. 11, a game image IPb generated by a game program is displayed as a self-screen image by the information processing apparatus 1b executing the game program in one of the game modes. The display 15b of the information processing apparatus 1b displays a sharing game invitation notification N indicating that an invitation to a sharing game (Internet communications) has been received from another information processing apparatus 1 through the server 101b. Here, an example of the sharing game invitation notification N shown in the top figure of FIG. 11 suggests that the user of the information processing apparatus 1b can see information indicating that the user is invited to a sharing game (Internet communications), and can see the invitation by operating the dedicated button 3 (see FIG. 1), so that information for guiding toward operation of the dedicated button 3 is displayed. Since the sharing game invitation notification N is displayed together with a game image that is being currently executed, the user that is playing a game is notified of the arrival of an invitation. In addition, display for guiding toward operation of the dedicated button 3 is additionally displayed, and therefore, an operation for responding to an invitation is easily understood.

In the second figure from the top of FIG. 11, the display 15b of the information processing apparatus 1b, when the user of the information processing apparatus 1b performs an operation of pressing down the dedicated button 3 (more specifically, immediately after the dedicated button 3 is pressed down), displays a first dedicated button menu image BMa, which overlays the game image IPb. The first dedicated button menu image BMa shown in the second figure from the top of FIG. 11 is displayed when the user operates the dedicated button 3 with the information processing apparatus 1 operating the communication function and the user being invited to a sharing game (Internet communications) from another information processing apparatus 1. For example, the first dedicated button menu image BMa shows an image and user interface related to the communication function, and in addition, a user interface related to an invitation to a sharing game (Internet communications). As an example, a shared image IS of each member belonging to the same communication group is displayed as the image related to the communication function in the first dedicated button menu image BMa. In addition, an exit button BM1, camera button BM2, microphone button BM3, image sharing button BM4, and the like are displayed as the user interface related to the communication function in the first dedicated button menu image BMa. The exit button BM1 is a menu for instructing the user to exit the communication group in which the user currently participates, and stop the communication function that is being executed. The camera button BM2 is a setting menu for instructing the user to switch on/off a camera (the imaging unit 18 shown in FIG. 2) used in the communication function. The microphone button BM3 is a setting menu for instructing the user to switch on/off a microphone (the audio input unit 17 shown in FIG. 2) used in the communication function. The image sharing button BM4 is a setting menu for instructing the user to determine whether or not to share an image of the self-apparatus in the communication function. In addition, a button BM5 indicating that the user is invited to a game sharing (Internet communications) is displayed as the user interface related to an invitation to a sharing game in the first dedicated button menu image BMa.

When the user of the information processing apparatus 1b performs an operation of selecting the button BM5 indicating an invitation to game sharing (Internet communications), as shown in the third figure from the top of FIG. 11 the display 15b of the information processing apparatus 1b displays a sharing game participation menu image BMa1, which overlays the game image IPb. The sharing game participation menu image BMa1 shows information specifying the user of the information processing apparatus 1a, that has made the above invitation, and in addition, an invitation acceptance button BM6 that is an image for prompting to determine whether or not to play a sharing game together with a user that is an invitation source, and that is a user interface that is selected when the invitation is accepted. When the user of the information processing apparatus 1b performs an operation of selecting the invitation acceptance button BM6, in the information processing apparatus 1b the game sharing mode is activated with the information processing apparatus 1b (self-apparatus) serving as a guest apparatus, and the game sharing function 50g for a guest is activated in the system module 50. Specifically, the button BM5 included in the first dedicated button menu image BMa is a trigger for activating the guest function of the game sharing function (Internet communications). Thereafter, the game sharing function 50g for a guest transmits, to the server 101b, participation data indicating participation in a sharing game to which the user is invited. Thereafter, when a host apparatus and a guest apparatus in the sharing game are determined, the server 101b transmits, to the information processing apparatus 1b, information about the determination, the game session ID indicating the sharing game to be played between the host apparatus and the guest apparatus, and the like. It should be noted that the first dedicated button menu image BMa may include a user interface such as the sharing game participation menu image BMa1 instead of the button BM5. In such a form, the first dedicated button menu image BMa can include a trigger for activating the guest function of the game sharing function (Internet communications).

It should be noted that as can be seen from the self-screen image (game image IPb) in the top, second, and third figures of FIG. 11, in the present example even when an invitation to a sharing game is received from another information processing apparatus 1, the sharing game invitation notification N, the first dedication button menu image BMa, or the like is displayed with a game image being displayed while a game that is being played is continued, without interruption of the game. When the user's operation of instructing to participate in a sharing game to which the user is invited is performed, a game that is being played is interrupted, and a game changing process is started. The operation for participating in a sharing game in response to an invitation may be an operation that is performed on a user interface that is displayed by operation of the dedicated button 3. It should be noted that a user interface (BMa1) for accepting an invitation may be provided in the first dedicated button menu image BMa.

In the bottom figure of FIG. 11, a sharing game has been started with the information processing apparatus 1a serving as a host apparatus, and a game image IPb of the information processing apparatus 1b generated in the sharing game is displayed as a self-screen image on the display 15b of the information processing apparatus 1b. The game image IPb provides sharing game identification display indicating that the sharing game is being played together with the user of the information processing apparatus 1a. The self-screen image is also displayed as a shared image ISb in the shared image display region of the display 15b. It should be noted that the sharing game illustrated in FIG. 11 is a game in which it is not preferable that an image of a self-apparatus be seen by a game coplayer user, so that the game coplayer is forbidden from image sharing, and therefore, a blank image that displays only the name of the user of the information processing apparatus 1a is displayed as the shared image ISa of the host apparatus in the sharing game.

It should be noted that the first dedicated button menu image BMa and the shared image IS displayed in the shared image display region may be overlaid by a captured image of each user or an icon image of each user. In that case, the captured image or icon image of each user may be prepared in the respective information processing apparatus 1, and may be transmitted, together with shared image data of the respective information processing apparatus 1 (self-apparatus), from the respective information processing apparatus 1 to the server 101a. In that case, the captured image of each user may be one that is captured by the imaging unit 18 of the information processing apparatus 1. Image data captured in real time during data transmission to the server 101a may be added to the shared image data of the self-apparatus, and the resultant data may be transmitted.

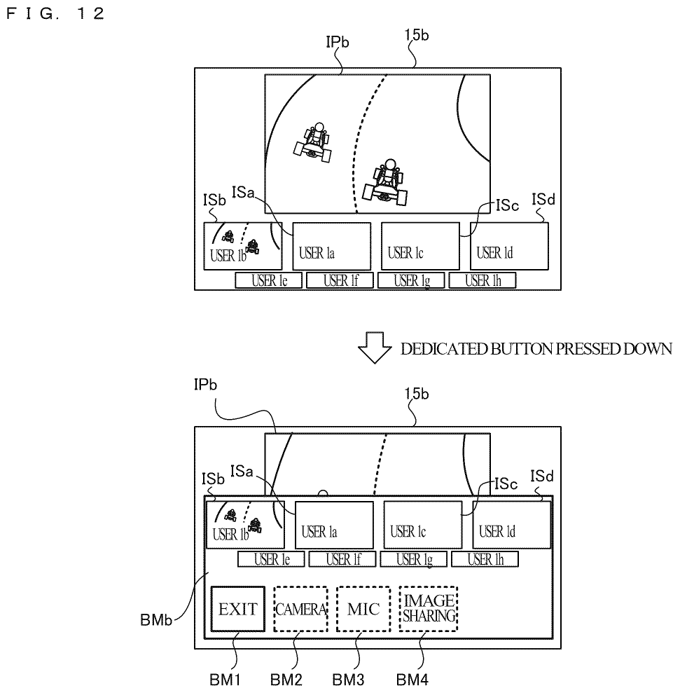

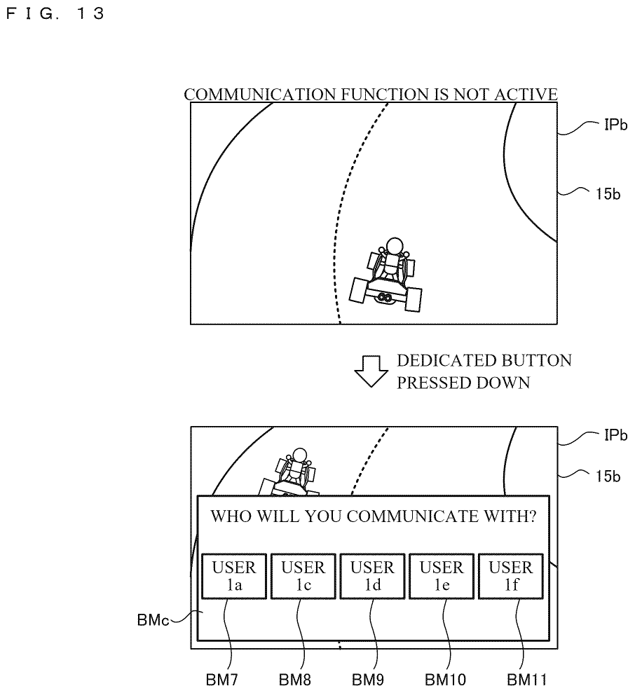

Next, another display form that is displayed when the dedicated button 3 of the information processing apparatus 1 is operated (more specifically, immediately after the dedicated button 3 is pressed down) will be described with reference to FIGS. 12 and 13. FIG. 12 is a diagram showing an example second dedicated button menu image BMb that is displayed when the dedicated button 3 of the information processing apparatus 1b is operated (more specifically, immediately after the dedicated button 3 is pressed down). FIG. 13 is a diagram showing an example third dedicated button menu image BMc that is displayed when the dedicated button 3 of the information processing apparatus 1b is operated (more specifically, immediately after the dedicated button 3 is pressed down).

In the present example, when the dedicated button 3 of the information processing apparatus 1 is operated, a dedicated button menu image BM including a user interface in the communication function is displayed. In addition, the dedicated button menu image BM includes a user interface in the game sharing function (Internet communications) (e.g., a user interface for responding to an invitation to a sharing game from a host apparatus). For example, as described above, when both of the game sharing function and the communication function are being operated in the information processing apparatus 1, the first dedicated button menu image BMa including both of the user interfaces in the game sharing function and the communication function is displayed (seethe second figure from the top of FIG. 11). Meanwhile, as shown in FIG. 12, when the communication function is being operated in the information processing apparatus 1 and any operation related to the game sharing function such as an invitation to a sharing game (Internet communications) from a host apparatus is not being performed, the second dedicated button menu image BMb including a user interface in the communication function is displayed. It should be noted that when the dedicated button 3 is operated, a user interface of the game sharing function employing local wireless communications (an interface that displays a host that is recruiting for a sharing game through local wireless communications, and that is selected for participation) may be provided.

As shown in the top figure of FIG. 12, when a game program is executed in any of the game modes in the information processing apparatus 1b, a game image IPb generated by the game program is displayed as a self-screen image on the display 15b of the information processing apparatus 1b. In addition, the communication function is being executed in the information processing apparatus 1b, and a shared image IS of each member of the same communication group is displayed in the shared image display region of the display 15b.

As shown in the bottom figure of FIG. 12, in such a state, when the user of the information processing apparatus 1b operates the dedicated button 3, the second dedicated button menu image BMb is displayed, overlaying the game image IPb. The second dedicated button menu image BMb shows an image related to the communication function and a user interface for the communication function.

As shown in the top figure of FIG. 13, when a game program is executed in any of the game modes in the information processing apparatus 1b, a game image IPb generated by the game program is displayed as a self-screen image on the display 15b of the information processing apparatus 1b. It should be noted that in the information processing apparatus 1b, the communication function is not active, and no image that is related to the communication function such as the above shared image IS is displayed on the display 15b.

As shown in the bottom figure of FIG. 13, in such a state, when the user of the information processing apparatus 1b operates the dedicated button 3, the third dedicated button menu image BMc is displayed, overlaying the game image IPb. The third dedicated button menu image BMc shows a user interface for activating the communication function. As an example, the third dedicated button menu image BMc shows member selection images BM7 to BM11 indicating options for selecting a member that, together with the self-apparatus, forms a communication group. For example, in the present example, member candidates (the user name of each information processing apparatus 1) together with which the user of the information processing apparatus 1b can form a communication group are obtained from the server 101a, and are each displayed as an option. When the user of the information processing apparatus 1b performs an operation of selecting at least one from the above options, request-to-join data for requesting for participation in a communication group is transmitted to the user of the information processing apparatus 1 corresponding to the option through the server 101a. Thereafter, when acceptance data indicating acceptance for the above participation is received from another information processing apparatus 1 that has received the above request-to-join data, the user of the information processing apparatus 1b and the user of the another information processing apparatus 1 form a communication group, and the members of the communication group are managed by the server 101a. Thus, in the present example, when the communication function is not active, the activation sequence of the communication function is started when the dedicated button 3 is operated. It should be noted that the above activation sequence of the communication function is merely illustrative, and for example, a user interface for selecting a user account of the self-apparatus may be displayed during the start of the activation sequence.

Thus, when the communication function is not active, the activation sequence of the communication function is immediately started by operating (pressing down) the dedicated button 3 provided in the information processing apparatus 1. Therefore, the communication function can be quickly activated by operation of the dedicated button 3, which is easy to understand, and in addition, the use of the communication function can be promoted. In addition, when the dedicated button 3 is operated, then if the communication function is already active, a user interface for setting the communication function instead of start of the activation sequence is provided. Therefore, a user interface related to the communication function can be provided using the same dedicated button 3 in an easy-to-understand manner. In addition, in the present example, only a user interface related to the communication function is displayed when the dedicated button 3 is operated. Therefore, the meaning of the dedicated button 3 is obvious, resulting in promotion of the communication function. It should be noted that the game sharing function employing Internet communications is a function that is performed between members of a communication group and is related to the communication function. In addition, when the dedicated button 3 is operated, a trigger for activating the game sharing function employing Internet communications is also provided. As a result, the use of other functions that utilize the communication function can also be facilitated and promoted. A trigger for activating the game sharing function when the dedicated button 3 is operated is provided only when an invitation made by the game sharing function is received, resulting in an appropriate guide to the activation. The dedicated button 3 provided in the information processing apparatus 1 can display dedicated button menus that provide user interfaces for various purposes, based on the function that is activated by the information processing apparatus 1. For example, the dedicated button 3 functions as a “button for activating a user interface for the communication function and a user interface for the game sharing function” (the first dedicated button menu image BMa), a “button for activating a user interface for the communication function” (the second dedicated button menu image BMb), or a “button for activating the communication function” (the third dedicated button menu image BMc).

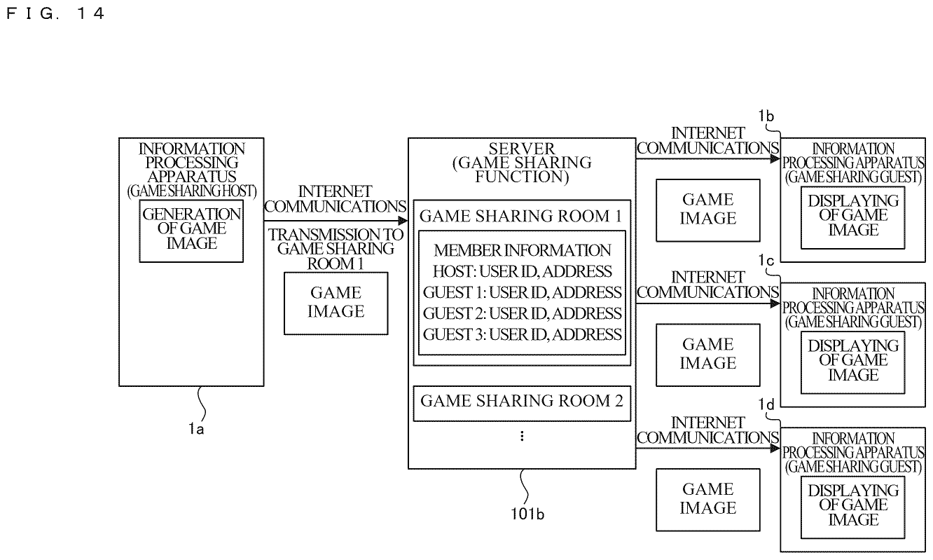

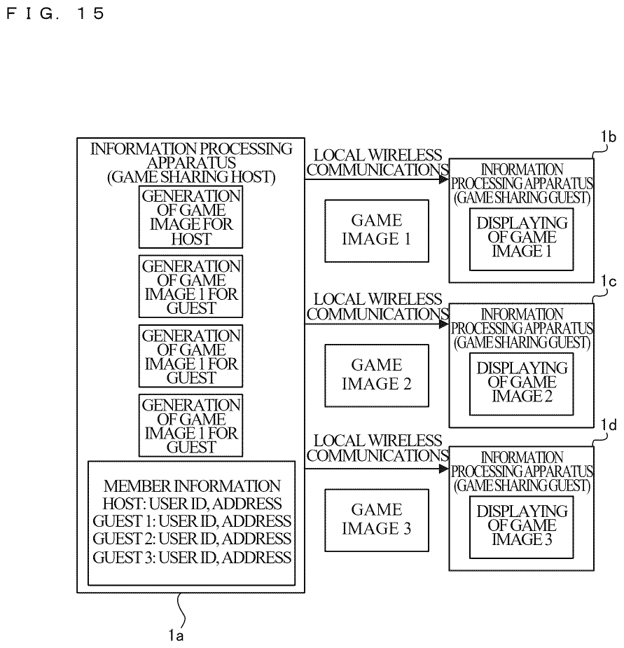

Next, an example system that performs game sharing using Internet communications and an example system that performs game sharing using local wireless communications will be described with reference to FIGS. 14 and 15. It should be noted that FIG. 14 is a diagram showing an example system that performs game sharing using Internet communications. FIG. 15 is a diagram showing an example system that performs game sharing using local wireless communications.

In the present example, the game sharing function includes one that employs Internet communications and one that employs local wireless communications. Game sharing in the former is performed between members belonging to the above communication group. Game sharing in the latter is performed between users that are operating information processing apparatuses 1 capable of performing local wireless communications with each other.

As an example, in a system that performs game sharing using Internet communications, the game sharing function is carried out by Internet communications through a server. As shown in FIG. 14, a plurality of information processing apparatuses 1 are connected through the server 101b so as to be able to perform Internet communications. In the present example, the game sharing function employing Internet communications can be performed between communication members belonging to the same communication group. In the example of FIG. 14, a plurality of information processing apparatuses 1a to 1d are operated by respective communication members belonging to the same communication group.

When the game sharing function is used between a plurality of information processing apparatuses (e.g., 1a to 1d), a game image in a sharing game is generated in a host apparatus in the game sharing mode (game sharing host; the information processing apparatus 1a). Here, in the above sharing game, the same game image common to the information processing apparatuses 1a to 1d, which are participating in the sharing game, are displayed in the information processing apparatuses 1a to 1d, and a single common game image is generated which is displayed in the game sharing host (the self-apparatus) and each game sharing guest (the information processing apparatuses 1b to 1d). The game sharing host displays the generated common game image for a sharing game in the self-apparatus, and transmits the game image to a game sharing room of the server 101b that manages the game sharing function (e.g., a game sharing room 1 in which game members belonging to a game group in the above sharing game are managed) in order to transmit the game image to each game sharing guest.

The server 101b, when receiving the above game image, determines that the game image is used in a sharing game managed in the game sharing room 1, based on member information (host) managed in each game sharing room. The server 101b sets addresses of the received game image (e.g., the user ID and IP address of each game sharing guest) based on member information (guests 1 to 3) managed in the game sharing room 1, and transmits the game image to each address separately.

Each game sharing guest (the information processing apparatuses 1b to 1d), when receiving a game image from the server 101b, displays the received game image. Thus, in the system of FIG. 14 in which game sharing is performed using Internet communications, the server 101b transmits the common game image generated by the game sharing host to each game sharing guest separately, so that the game sharing function using the game image is carried out. In addition, in the system of FIG. 14 in which game sharing is performed using Internet communications, the communication function can be used, and therefore, each game member can play a sharing game while performing communication.

It should be noted that the sharing game executed in the above system may be a game in which the information processing apparatuses 1a to 1d participating in the sharing game display different individual game images. In that case, the above game sharing host generates different individual game images for different apparatuses, identifies different game sharing guests (e.g., user IDs) for which the individual game images are used in the game sharing host, and transmits the game images for the respective game sharing guests to the server 101b.

In addition, in another example, in the system in which game sharing is performed using Internet communications, Internet communications may be directly performed between information processing apparatuses 1 using a peer-to-peer (P2P) communications scheme. In that case, the above common game image and individual game images generated by a game sharing host are transmitted by the game sharing host to each game sharing guest separately.

As an example, in the system in which game sharing is performed using local wireless communications, the game sharing function is carried out by direct local wireless communications between a game sharing host and a game sharing guest. As shown in FIG. 15, a plurality of information processing apparatuses 1 are connected together using local wireless communications. In the present example, the game sharing function employing local wireless communications is carried out without any condition limiting game members to communication members belonging to the same communication group and without using the above communication function.

In the case in which the game sharing function employing local wireless communications is used, a game image in a sharing game is generated in a host apparatus in the game sharing mode (game sharing host; the information processing apparatus 1a). Here, the above sharing game is a game in which different individual game images are displayed in the respective information processing apparatuses 1a to 1d participating in the sharing game, and the game sharing host generates a game image for a host that is to be displayed in the self-apparatus, and game images 1 to 3 for a guest that are to be displayed in the respective game sharing guests (the information processing apparatus 1b to 1d). Thereafter, the game sharing host displays the generated game image for a host in the self-apparatus, and transmits the game images 1 to 3 for a guest to the respective game sharing guests. For example, the game sharing host sets the addresses of the game images 1 to 3 for a guest (e.g., the user ID and MAC address of each game sharing guest) based on member information (guests 1 to 3) managed in the self-apparatus, and transmits the game images 1 to 3 for a guest to the respective addresses separately.

The game sharing guests (the information processing apparatus 1b to 1d), when receiving the game images 1 to 3 for a guest from the game sharing host, displays the received game images for a guest, respectively. Thus, in the system of FIG. 15 in which game sharing is performed using local wireless communications, individual game images generated by the game sharing host are transmitted to the respective game sharing guests separately, whereby the game sharing functions using the respective individual game images are carried out. In addition, in the system of FIG. 14 in which game sharing is performed using local wireless communications, there are users that operate respective information processing apparatuses 1 in the real world in a range in which the local wireless communications can be performed (e.g., a plurality of users play a game in person), and therefore, a sharing game can be played while the users directly communicate with each other in the real world.

It should be noted that the sharing game performed in the above system may be a game in which the same game image common to the information processing apparatuses 1a to 1d participating in the sharing game is displayed in the information processing apparatuses 1a to 1d. In that case, the above game sharing host may transmit the common game image to each game sharing guest.

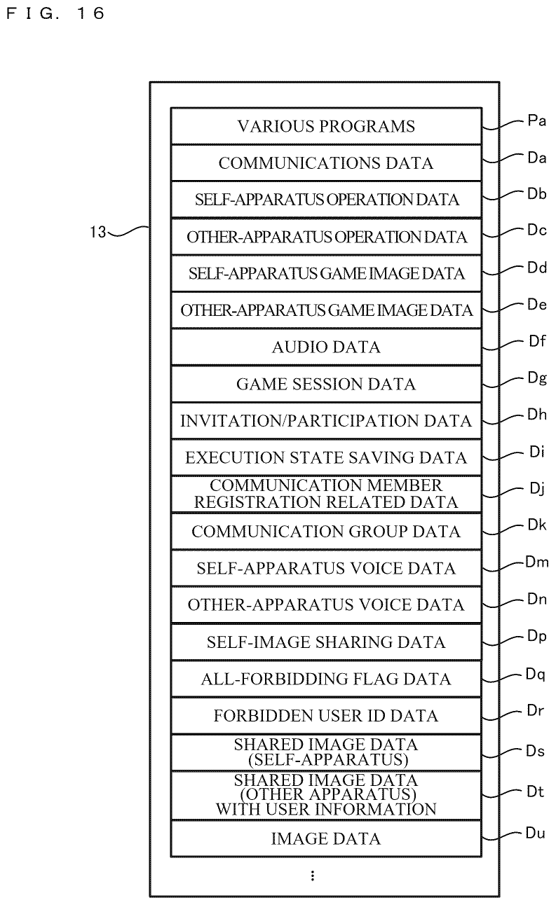

Next, an example specific process executed in the information processing apparatus 1 will be described with reference to FIG. 16. FIG. 16 is a diagram showing an example data area set in the DRAM 13. Although the DRAM 13 stores data used in other processes in addition to the data of FIG. 16, those other data will not be described in detail.

The DRAM 13 has a program storage area in which various programs Pa that are executed in the information processing apparatus 1 are stored. In the present example, the programs Pa include the system program PS, the game program PG, and the like. It should be noted that the programs Pa may be previously stored in the flash memory 12, may be obtained from a storage medium removably attached to the information processing apparatus 1 and then stored into the DRAM 13, or may be obtained from another apparatus through a network such as the Internet and then stored into the DRAM 13. The processor 11 executes the programs Pa stored in the DRAM 13.

The data storage area of the DRAM 13 also stores various kinds of data that are used in information processes executed in the information processing apparatus 1 and the like. In the present example, the DRAM 13 stores communications data Da, self-apparatus operation data Db, other-apparatus operation data Dc, self-apparatus game image data Dd, other-apparatus game image data De, audio data Df, game session data Dg, invitation/recruitment/participation data Dh, execution state saving data Di, communication member registration related data Dj, communication group data Dk, self-apparatus voice data Dm, other-apparatus voice data Dn, self-image sharing data Dp, all-forbidding flag data Dq, forbidden user ID data Dr, shared image data (self-apparatus) Ds, shared image data (other apparatus) Dt, image data Du, and the like.

The communications data Da indicates data that is to be transmitted, as appropriate, to other apparatuses (e.g., the servers 101a and 101b) and data that has been received, as appropriate, from other apparatuses.

The self-apparatus operation data Db is operation data that has been obtained, as appropriate, from the operation unit 19 of the self-apparatus. For example, the operation data obtained from the operation unit 19 includes information about an input from each input unit (e.g., buttons, an analog stick, and a touch panel) (specifically, information about an operation). The self-apparatus operation data Db is updated, as appropriate, using operation data obtained from each input unit.

The other-apparatus operation data Dc is operation data that has been obtained by other apparatuses from each input unit thereof. It should be noted that operation data that has been obtained, as appropriate, by other apparatuses are transmitted to the self-apparatus through the server 101b, and is stored into the communications data Da.

The self-apparatus game image data Dd indicates an image of a game that is being played by the user of the self-apparatus, and that is displayed as a self-screen image on the display 15 of the self-apparatus. As an example, when the self-apparatus is executing a game process, the self-apparatus game image data Dd is generated based on the game process. As another example, when the self-apparatus is set in a guest apparatus and is playing a sharing game, the self-apparatus game image data Dd is transmitted from the host apparatus through the server 101b.

The other-apparatus game image data De indicates an image of a game that is being played by the user of another information processing apparatus 1, and is used to display the image as a self-screen image on the display 15 of the another apparatus 1. As an example, when the self-apparatus is set as a host apparatus and is executing a sharing game, the other-apparatus game image data De is game image data for a guest apparatus that is generated based on the game process that is being executed by the self-apparatus, and is transmitted, as appropriate, to the guest apparatus through the server 101b.

The audio data Df includes data of game sounds that are generated together with a game image that is obtained as a self-screen image on the display 15 of the self-apparatus, and the like, and is output to the audio output unit 16 of the self-apparatus when the game image is displayed.

The game session data Dg includes data indicating a game session ID that is assigned when a sharing game is played together with another apparatus, and includes details of a communications game that is being played, an apparatus that is participating in the communications game (e.g., a host apparatus and a guest apparatus), information about the user, and the like. For example, the game session data Dg includes information about a game member belonging to a membership game group in which the above communications game is being played, the user ID of the game member, identification information of a team in which the game member participates as a player, spectator participation information about participation as a spectator, and the like.

The invitation/recruitment/participation data Dh indicates information about an invitation to a sharing game, information about recruitment of participants in a sharing game, or information about participation in a sharing game.

The execution state saving data Di saves a state of a game that has been executed before the self-apparatus transitions to the game sharing mode.

The communication member registration related data Dj indicates information about request for registration into a communication group, information about a request-to-join source, information about acceptance of request for joining a communication group, information about an acceptance source, and the like.

The communication group data Dk indicates a communication group ID indicating a communication group.

The self-apparatus voice data Dm is voice data of the user of the self-apparatus that has been collected by the audio input unit 17, and is transmitted, as appropriate, to another apparatus belonging to a communication group. The other-apparatus voice data Dn is voice data of the user of another apparatus belonging to a communication group that has been collected by the audio input unit 17 of the another apparatus. The other-apparatus voice data Dn is transmitted, as appropriate, to the self-apparatus through the server 101a and then stored into the communications data Da.

The self-image sharing data Dp indicates whether or not a game image of the self-apparatus is permitted to be displayed as a shared image on another apparatus that is a member of a communication group.

The all-forbidding flag data Dq indicates the all-forbidding flag, which is on when the image sharing forbidding setting is “all forbidding”. When the all-forbidding flag is on, the process of transmitting a game image of the self-apparatus as a shared image is not executed, and sharing with another apparatus is not performed.

The forbidden user ID data Dr indicates the user ID of a user that is forbidden from image sharing based on the image sharing forbidding setting. When a game image having such a user ID is received as a shared image, the process of displaying on the display of the self-apparatus is not executed.

The shared image data (self-apparatus) Ds indicates a shared image that is displayed in the shared image display region of the self-apparatus, corresponding to a self-screen image of the self-apparatus (e.g., ISa in FIG. 5), and is generated, as appropriate, to have a resolution lower than that of the self-screen image. The shared image data (other apparatus) Dt indicates a shared image of another apparatus that is displayed in the shared image display region of the self-apparatus (e.g., ISb, ISc, ISd in FIG. 5), and additionally includes user information (e.g., a user ID) indicating the user of the shared image, for example. As an example, the shared image data (other apparatus) Dt is a game image and the user ID of another apparatus that is executing a game in the stand-alone mode, a game image and the user ID of another apparatus that is executing a game in the communications multiplayer play mode, a game image and the user ID of another apparatus that is serving as a host apparatus and is executing a game in the game sharing mode, or a game image and the user ID of another apparatus that is serving as a guest apparatus and is executing a game in the game sharing mode, and is obtained through the server 101a.

The image data Du is for displaying, on the display 15 of the self-apparatus, a game image (e.g., an image of a player character, an image of a virtual object, an image of a field in a virtual space, and a background image).

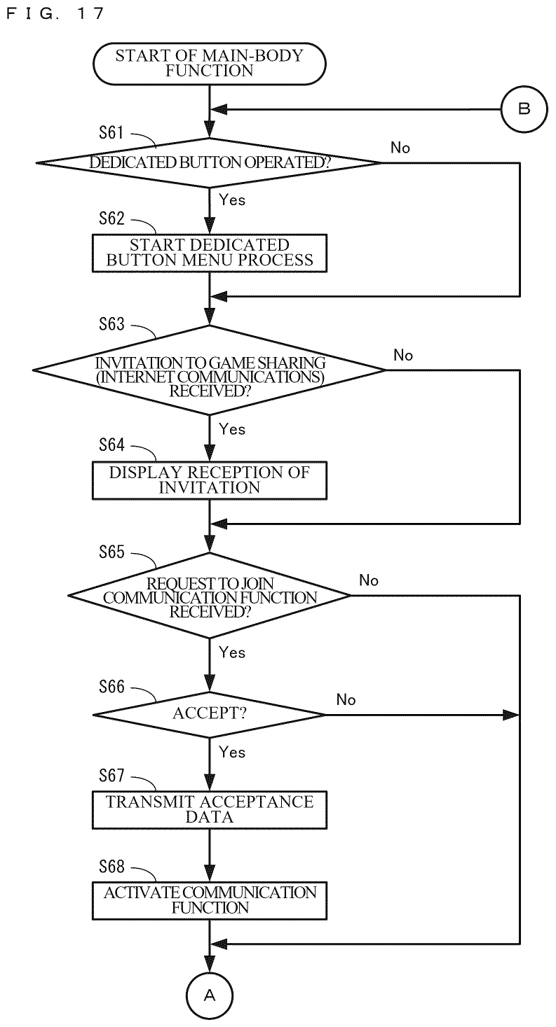

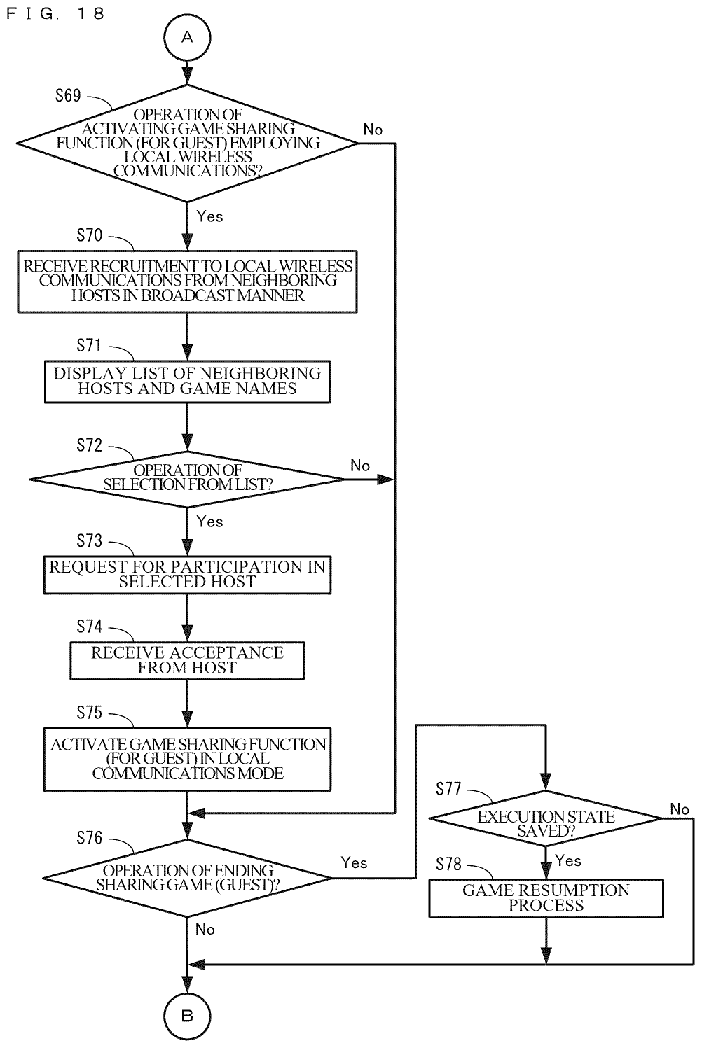

Next, an example specific main-body function process that is an example information process in the present example will be described with reference to FIGS. 17 and 18. It should be noted that FIG. 17 is a flowchart showing an example of the first half of a main-body function process that is executed in the information processing apparatus 1. FIG. 18 is a flowchart showing an example of the second half of the main-body function process that is executed in the information processing apparatus 1. In the present example, a series of steps shown in FIG. 13 is continuously active when the information processing apparatus 1 is active, and is executed by the processor 11 executing a system program included in the programs Pa. It should be noted that the timing of start of the main-body function process of FIGS. 17 and 18 is not particularly limited. As an example, the main-body function process of FIGS. 17 and 18 is started at the same time when the information processing apparatus 1 is activated.

In FIG. 17, the processor 11 determines, with reference to the self-apparatus operation data Db, whether or not the dedicated button 3 has been operated (step S61). If the dedicated button 3 has been operated, the processor 11 proceeds to step S62. Otherwise, i.e., if the dedicated button 3 has not been operated, the processor 11 proceeds to step S63.

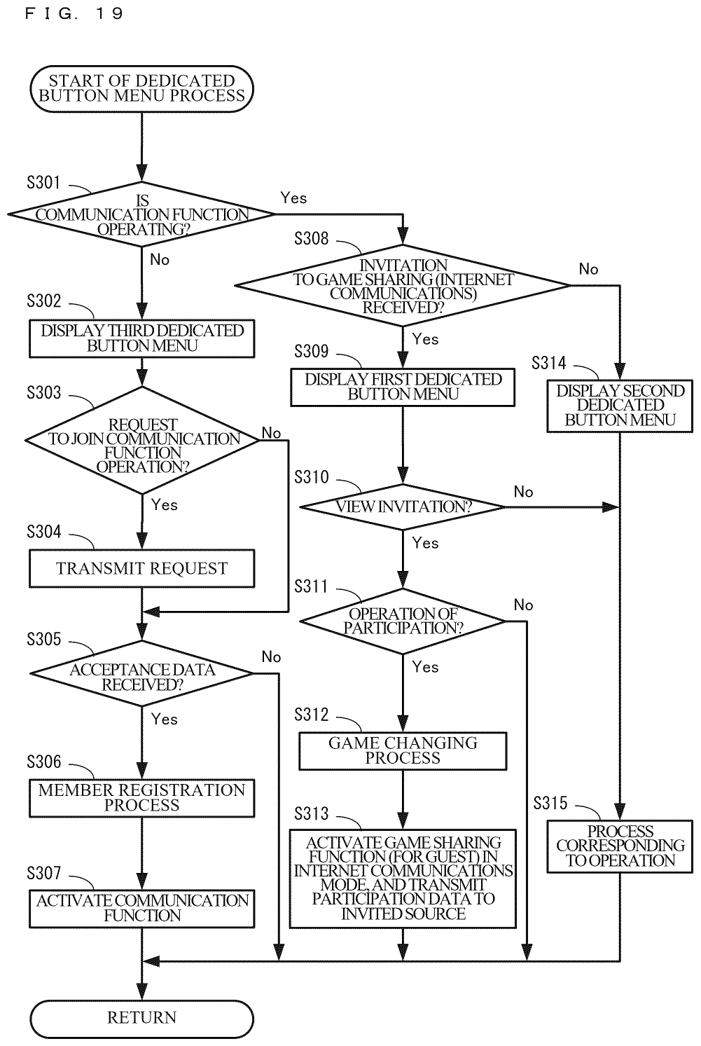

In step S62, the processor 11 activates a dedicated button menu process (see FIG. 19), and proceeds to step S63.

In step S63, the processor 11 determines, with reference to the communications data Da or the invitation/recruitment/participation data Dh, whether or not invitation data for participation in a sharing game employing Internet communications has been received from another apparatus through the server 101b. If the invitation data employing Internet communications has been received, the processor 11 proceeds to step S64. Otherwise, i.e., if the invitation data employing Internet communications has not been received, the processor 11 proceeds to step S65.

In step S64, the processor 11 performs control to display an indication that an invitation to participation in a sharing game employing Internet communications has been received from another apparatus (e.g., the sharing game invitation notification N in the top figure of FIG. 11) on the display 15 of the self-apparatus, and proceeds to step S65.

In step S65, the processor 11 determines, with reference to the communications data Da or the communication member registration related data Dj, whether or not request-to-join data for request for registration as a member of a communication group has been received from the user of another information processing apparatus 1 through the server 101a. If the request-to-join data has been received, the processor 11 proceeds to step S66. Otherwise, i.e., if the request-to-join data has not been received, the processor 11 proceeds to step S69 (see FIG. 18).

In step S66, the processor 11 determines, with reference to the self-apparatus operation data Db, whether or not the user of the self-apparatus has performed an operation of accepting registration as a member of a communication group. If the user of the self-apparatus has performed an operation of accepting registration as a member of a communication group, the processor 11 proceeds to step S67. Otherwise, i.e., if the user of the self-apparatus has not performed an operation of accepting registration as a member of a communication group, the processor 11 proceeds to step S69 (see FIG. 18).

In step S67, the processor 11 transmits acceptance data indicating acceptance of registration as a member of a communication group to the server 101a, and proceeds to the next step. For example, the processor 11 stores, into the communication member registration related data Dj, acceptance data indicating information indicating that the user of the self-apparatus has accepted registration as a member of a communication group and a request-to-join source, and transmits the acceptance data to the server 101a.

Next, the processor 11 activates the communication function of the self-apparatus (step S68), and proceeds to step S69 (see FIG. 18).

In FIG. 18, the processor 11 determines, with reference to the self-apparatus operation data Db, whether or not an operation of activating the game sharing function for a guest of the self-apparatus employing local wireless communications has been performed (step S69). The operation of activating the guest function of game sharing employing local wireless communications is, for example, a predetermined operation that is performed using a user interface provided on a home menu screen that is displayed during start of a game or when the home button 2 is operated. It should be noted that in the present example, the operation of activating the guest function of game sharing employing local wireless communications is not included in the user interface that is provided when the dedicated button 3 is operated. If the operation of activating the guest function of game sharing employing local wireless communications has been performed, the processor 11 proceeds to step S70. Otherwise, i.e., if the operation of activating the guest function of game sharing employing local wireless communications has not been performed, the processor 11 proceeds to step S76.

In step S70, the processor 11 receives recruitment data for game sharing that is broadcast by a host apparatus existing around the self-apparatus (e.g., a range in which the self-apparatus can perform local wireless communications), and proceeds to the next step.

Next, the processor 11 displays a list of the names of host apparatuses and the game names of sharing games that are included in the broadcast data received in step S70, as options, on the display 15 of the self-apparatus (step S71), and proceeds to the next step. It should be noted that in the above displayed list, when there is a guest apparatus that has already accepted participation as a guest, information about the guest apparatus may also be displayed.

Next, the processor 11 determines, with reference to the self-apparatus operation data Db, whether or not an operation of selecting a game for which the user desires to apply for the recruitment (a sharing game in which the user desires to participate) from the list displayed in step S71 has been performed (step S72). If the operation of selecting from the list has been performed, the processor 11 proceeds to step S73. Otherwise, i.e., if the operation of selecting from the list has not been performed, the processor 11 proceeds to step S76.

In step S73, the processor 11 executes the process of transmitting participation data for requesting for participation in a sharing game to the selected host apparatus, and proceeds to the next step. For example, the processor 11 stores participation data for requesting for participation in a sharing game into the invitation/recruitment/participation data Dh, and transmits the participation data to the host apparatus selected in step S72.

It should be noted that in steps S73 or S74, the processor 11 may execute a game changing process. For example, the processor 11, when executing a game (including a sharing game), may execute the process of interrupting the game, and storing the execution state of the game into the execution state saving data Di, as the game changing process. In addition, the processor 11, when the game sharing function for a guest is active separately, may execute the process of ending the game sharing function for a guest without saving the execution state of the sharing game, as the game changing process.

Next, the processor 11 receives data indicating that participation in a sharing game has been accepted from the host apparatus to which participation data has been transmitted (step S74), and proceeds to the next step.

Next, the processor 11 activates the game sharing function for a guest of the self-apparatus employing local wireless communications (step S75), and proceeds to the next step.

Next, the processor 11 determines, with reference to the self-apparatus operation data Db, whether or not an operation of ending a sharing game in which the self-apparatus has been set as a guest apparatus has been performed (step S76). If the operation of ending a sharing game in which the self-apparatus has been set as a guest apparatus has been performed, the processor 11 proceeds to step S77. Otherwise, i.e., if the operation of ending a sharing game in which the self-apparatus has been set as a guest apparatus has not been performed, the processor 11 returns to and repeats step S61 (see FIG. 17).

In step S77, the processor 11 determines, with reference to the execution state saving data Di, whether or not the execution state of a game has been saved in the game changing process of step S73 or S74 or step S312 described below (see FIG. 19). If the execution state of a game has been saved, the processor 11 proceeds to step S78. Otherwise, i.e., if the execution state of a game has not been saved, the processor 11 returns to and repeats step S61 (see FIG. 17).

In step S78, the processor 11 executes a game resumption process, and returns to and repeats step S61 (see FIG. 17). For example, the processor 11 resumes the game interrupted in step S73 or S74 or step S312 described below based on the execution state of the game stored in the execution state saving data Di, and deletes the execution state saving data Di.

Next, an example detailed dedicated button menu process that is an example information process in the present example will be described with reference to FIG. 19. It should be noted that FIG. 19 is a flowchart showing an example dedicated button menu process that is executed in the information processing apparatus 1. In the present example, a series of steps shown in FIG. 19 is started when the dedicated button 3 in the information processing apparatus 1 is operated, and is executed by the processor 11 executed a system program included in the programs Pa.

In FIG. 19, the processor 11 determines whether or not the communication function of the self-apparatus is being operating (step S301). If the communication function is not operating, the processor 11 proceeds to step S302. Otherwise, i.e., if the communication function is operating, the processor 11 proceeds to step S308.

In step S302, the processor 11 displays the third dedicated button menu image BMc (see the bottom figure of FIG. 13) on the display 15 of the self-apparatus, and proceeds to the next step.

Next, the processor 11 determines, with reference to the self-apparatus operation data Db, whether or not an operation of requesting the user of another information processing apparatus 1 shown in the third dedicated button menu image BMc to join the same communication group (step S303). If the operation of requesting the user of another information processing apparatus 1 has been performed, the processor 11 proceeds to step S304. Otherwise, i.e., if the operation of requesting the user of another information processing apparatus 1 has not been performed, the processor 11 proceeds to step S305.

In step S304, the processor 11 transmits request-to-join data for request for joining a communication group to the user selected in step S303 through the server 101a, and proceeds to step S305. For example, the processor 11 stores request-to-join data indicating information for requesting the user of another information processing apparatus 1 to join a communication group and a request-to-join source, into the communication member registration related data Dj, and transmits the request-to-join data to the server 101a.

In step S305, the processor 11 determines whether or not acceptance data indicating acceptance of registration as a member of a communication group has been received, through the server 101a, from another information processing apparatus 1 to which the above request-to-join data has been transmitted. If the acceptance data has been received, the processor 11 proceeds to step S306. Otherwise, i.e., if the acceptance data has not been received, the processor 11 ends the flowchart.

In step S306, the processor 11 executes a member registration process of transmitting data for registering the user of the self-apparatus as a member of a communication group to the server 101a, and proceeds to the next step. For example, the processor 11 stores information indicating registration of the user of the self-apparatus as a member of a communication group into the communication member registration related data Dj, and transmits the data to the server 101a. It should be noted that when the process of registering the user of the self-apparatus as a member of a communication group using the request-to-join data transmitted in step S304 is executed in the server 101a, the member registration process of step S306 may not be executed. In that case, in the server 101a, the process of registering the information processing apparatus 1 that is the transmission source of the request-to-join data and the information processing apparatus 1 that is the transmission source of the acceptance data as a member of the same communication group is executed, which is triggered by transmission of the above acceptance data from the information processing apparatus 1 that is the receiver of the above request-to-join data.

Next, the processor 11 activates the communication function of the self-apparatus (step S307), and ends the flowchart.

It should be noted that if updating data indicating that the members of a communication group has been updated is received through the server 101a, the processor 11 may notify the user of the self-apparatus of the updated details using an image and or audio.

If in step S301, the processor 11 determines that the communication function is operating, the processor 11 determines, with reference to the communications data Da or the invitation/recruitment/participation data Dh, whether or not an invitation to game sharing employing Internet communications has been received from another apparatus through the server 101b (step S308). If an invitation to game sharing employing Internet communications has been received, the processor 11 proceeds to step S309. Otherwise, i.e., if an invitation to game sharing employing Internet communications has not been received, the processor 11 proceeds to step S314.

In step S309, the processor 11 displays the first dedicated button menu image BMa (see the second figure from the top of FIG. 11) on the display 15 of the self-apparatus, and proceeds to the next step.

Next, the processor 11 determines, with reference to the self-apparatus operation data Db, whether or not the user of the self-apparatus has performed an operation of viewing an invitation to game sharing employing Internet communications (step S310). For example, if the user operation of selecting the button BM5 (see the second figure from the top of FIG. 11) indicating an invitation to game sharing displayed on the display 15 of the self-apparatus has been performed, the result of the determination by the processor 11 in step S310 is positive. If the operation of viewing an invitation has been performed, the processor 11 proceeds to step S311. Otherwise, i.e., if the operation of viewing an invitation has not been performed, the processor 11 proceeds to step S315.

In step S311, the processor 11 determines, with reference to the self-apparatus operation data Db, whether or not an operation of participating in a sharing game employing Internet communications for which an invitation has been received from another apparatus has been performed. If the operation of participating in a sharing game employing Internet communications has been performed, the processor 11 proceeds to step S312. Otherwise, i.e., if the operation of participating in a sharing game employing Internet communications has not been performed, the processor 11 ends the flowchart.

In step S312, the processor 11 executes the game changing process, and proceeds to the next step. For example, if the processor 11 is executing a game (including a sharing game), the processor 11 executes, as the game changing process, the process of interrupting the game and storing the execution state of the game into the execution state saving data Di. In addition, if the game sharing function for a guest is active, the processor 11 executes, as the game changing process, the process of ending the game sharing function for a guest without saving the execution state of the sharing game.

Next, the processor 11 activates the game sharing function for a guest of the self-apparatus employing the Internet function, and executes the process of transmitting participation data to the invitation source (step S313), and ends the flowchart. For example, the processor 11 stores participation data indicating participation in a sharing game employing Internet communications to an invitation source that has given an invitation to participation in the sharing game, into the invitation/recruitment/participation data Dh, and transmits the participation data to the server 101b.

If in step S308 the processor 11 determines that an invitation to game sharing employing Internet communications has not been received, the processor 11 displays the second dedicated button menu image BMb (see the bottom figure of FIG. 12) on the display 15 of the self-apparatus, and proceeds to step S315.

In step S315, the processor 11 executes a process corresponding to the user's operation with reference to the self-apparatus operation data Db, and ends the flowchart. For example, the processor 11 executes a process corresponding to a user interface selected by the user's operation of selecting any of user interfaces related to the communication function (e.g., the buttons BM1 to BM4 in the second figure from the top of FIG. 11 the bottom figure of FIG. 12) shown in the first dedicated button menu image BMa or the second dedicated button menu image BMb displayed in the display 15 of the self-apparatus.

Thus, in the present example, by operating the dedicated button 3 to display the first dedicated button menu image BMa, the communication function can be activated, and various kinds of information about the communication function can be viewed and set, and in addition, the process of participating in a sharing game (Internet communications) in response to an invitation can be executed. In addition, in the present example, when the information processing apparatus 1 is active, any of the dedicated button menu images can be displayed, as appropriate, by operating the dedicated button 3. Therefore, even when any game program is being executed, an invitation to a sharing game employing Internet communications can be received, the settings of the communication function can be changed, and the communication function can be activated. It should be noted that even when a sharing game is being executed together with another information processing apparatus 1, an invitation to another sharing game can be received by the above dedicated button menu process. When an operation of participating in the another sharing game in response to the invitation is performed, the another sharing game can replace and be played in a self-communication group, and therefore, communication and game play can be promoted.

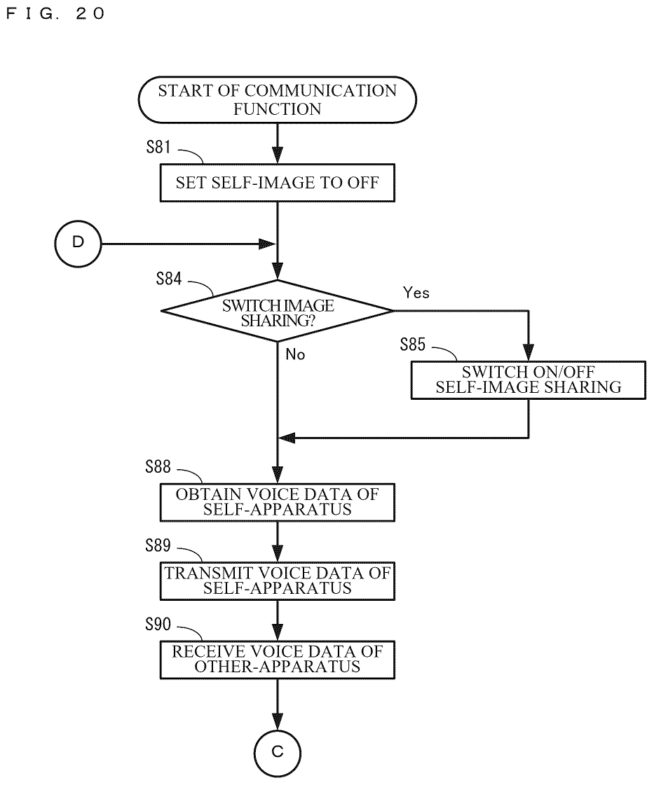

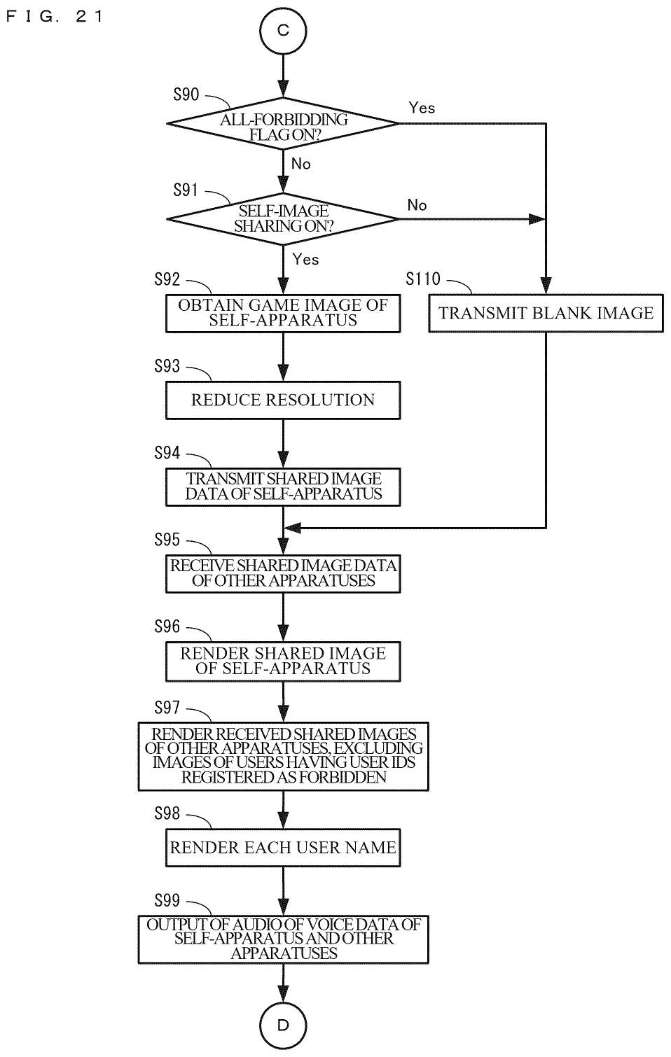

Next, an example detailed communication function process that is an example information process in the present example will be described with reference to FIGS. 20 and 21. FIG. 20 is a flowchart showing an example of the first half of the communication function process executed in the information processing apparatus 1. FIG. 21 is a flowchart showing an example of the second half of the communication function process executed in the information processing apparatus 1. In the present example, a series of steps shown in FIGS. 20 and 21 is executed by the processor 11 executing a system program included in the programs Pa. Although the communication function process of FIGS. 20 and 21 is started in response to execution of step S68, step S307, and step S140 described below, the timing of start thereof is not particularly limited.

In FIG. 20, the processor 11 switches off an image sharing setting for permitting a self-screen image to be displayed as a shared image on another apparatus (step S81), and proceeds to the next step. For example, the processor 11 sets the self-image sharing data Dp to off. If the self-image sharing data Dp is off, the game image of the self-apparatus is not displayed in any other apparatuses. The self-image sharing data Dp is arbitrarily used by the user to switch image sharing on/off.

Next, the processor 11 determines, with reference to the self-apparatus operation data Db, whether or not an operation of switching self-screen image sharing on/off has been performed (step S84). If the operation of switching self-screen image sharing on/off has been performed, the processor 11 proceeds to step S85. Otherwise, i.e., if the operation of switching self-screen image sharing on/off has not been performed, the processor 11 proceeds to step S88.

In step S85, the processor 11 executes the process of switching on/off of a self-image sharing setting, with reference to the self-image sharing data Dp, and proceeds to step S88. For example, if the self-image sharing data Dp indicates that the self-image sharing setting is off, the processor 11 changes the self-imaging sharing setting to on, and updates the self-image sharing data Dp. In addition, if the self-image sharing data Dp indicates that the self-image sharing setting is on, the processor 11 changes the self-image sharing setting to off, and updates the self-image sharing data Dp.

In step S88, the processor 11 obtains voice data of the self-apparatus, and proceeds to the next step. For example, the processor 11 obtains voice data of the user of the self-apparatus collected by the audio input unit 17 of the self-apparatus, and updates the self-apparatus voice data Dm.

Next, the processor 11 transmits voice data of the self-apparatus indicated by the self-apparatus voice data Dm to the server 101a (step S89), and proceeds to the next step.

Next, the processor 11 receives voice data of another apparatus, and proceeds to the next step S90 (see FIG. 21). For example, the processor 11 receives voice data of another apparatus transmitted from the server 101a, and updates the other-apparatus voice data Dn.

Referring to FIG. 21, in step S90, the processor 11 determines, with reference to the all-forbidding flag data Dq, whether or not the all-forbidding flag is on. If the all-forbidding flag is off, the processor 11 proceeds to step S91. Otherwise, i.e., if the all-forbidding flag is on, the processor 11 proceeds to step S110. The all-forbidding flag is for forbidding sharing of a game image according to a game program irrespective of the user's intention.

In step S91, the processor 11 determines, with reference to the self-image sharing data Dp, whether or not the self-image sharing setting is on. If the self-image sharing setting is on, the processor 11 proceeds to step S92. Otherwise, i.e., if the self-image sharing setting is off, the processor 11 proceeds to step S110.

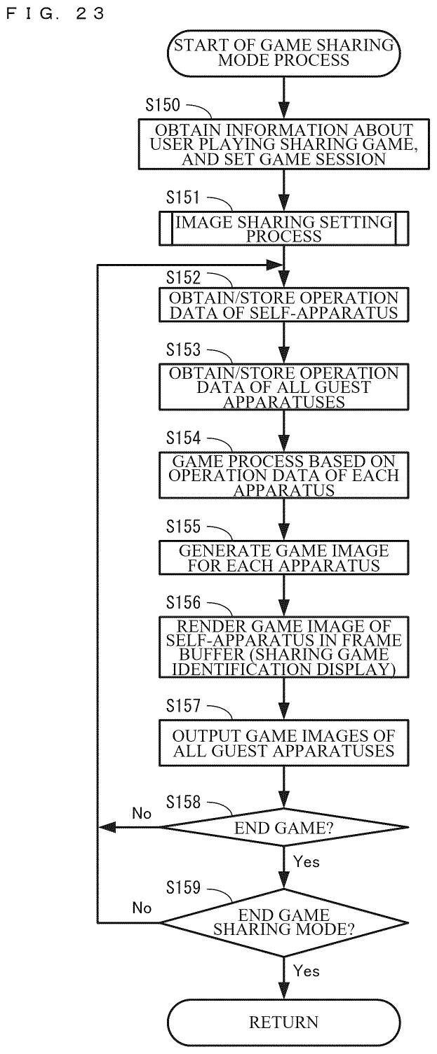

In step S92, the processor 11 obtains a game image to be displayed as a self-screen image of the self-apparatus with reference to the self-apparatus game image data Dd, and proceeds to the next step. More specifically, the processor 11 obtains, from the frame buffer or the like, a game image to be rendered in step S156 of FIG. 23 of a game program described below.

Next, the processor 11 executes the process of reducing the resolution of the game image obtained in step S92 (step S93), and proceeds to the next step. For example, the processor 11 reduces the resolution of a game image indicated by the self-apparatus game image data Dd to a predetermined level to generate a shared image of the self-apparatus, and updates the shared image data (self-apparatus) Ds using the shared image.

Next, the processor 11 transmits the shared image data of the self-apparatus generated in step S93 together with user information (e.g., a user ID) of the self-apparatus to another information processing apparatus 1 through the server 101a (step S94), and proceeds to step S95. For example, the processor 11 transmits the shared image data of the self-apparatus indicated by the shared image data (self-apparatus) Ds together with the user information to the information processing apparatus 1 of another member through the server 101a.

If in step S90, the processor determines that the all-forbidding flag is on, or if in step S91, the processor 11 determines that the self-image sharing setting is off, the processor 11 transmits data indicating a blank image as the shared image data of the self-apparatus together with user information (e.g., a user ID) of the self-apparatus to the information processing apparatus 1 of another member through the server 101a (step S110), and proceeds to step S95. It should be noted that the data indicating a blank image may be the image data of the blank image itself, or data for instructing to display the blank image. In addition, in step S110, nothing may be transmitted as shared image data of the self-apparatus to the information processing apparatus 1 any other member through the server 101a.

In step S95, the processor 11 receives, from another information processing apparatus 1, the shared image data of the another apparatus and corresponding user information (e.g., a user ID) through the server 101a, and proceeds to the next step. For example, the processor 11 updates the shared image data (other apparatus) Dt using the shared image data and user information of another apparatus received through the server 101a. It should be noted that the user information may be stored in each apparatus during registration into a communication group.

Next, the processor 11 performs control to render a shared image of the self-apparatus to display the shared image on the display 15 (step S96), and proceeds to the next step. It should be noted that in step S96, a program for executing the communication function executes the process of instructing the GPU to perform rendering. The rendering process itself is executed by the GPU. For example, the processor 11 outputs, to the frame buffer, the shared image data (self-apparatus) Ds as image data to be displayed as a shared image of the self-apparatus in the shared image display region (e.g., the image ISa in FIG. 6) of the display 15 of the self-apparatus.

Next, the processor 11 performs control to render a shared image of another apparatus to display the shared image on the display 15 (step S97), and proceeds to the next step. For example, the processor 11 outputs, to the frame buffer, the shared image data (other apparatus) Dt that has been received from another information processing apparatus 1 in step S95 and updated, excluding shared image data corresponding to a user ID registered in the forbidden user ID data Dr, as image data to be displayed as a shared image of another apparatus in the shared image display region.

Next, the processor 11 performs control to render the names of users based on user information corresponding to shared images of the self-apparatus and another apparatus, to display the user names on the display 15 (step S98), and proceeds to the next step. For example, the processor 11 obtains the name of the user of the self-apparatus and a user name based on user information corresponding to a shared image to be displayed in the shared image display region, and outputs an information image indicating each user name to the frame buffer so that the information image overlays a portion of the corresponding shared image.

Next, the processor 11 performs control to output audio corresponding to voice data of the self-apparatus and another apparatus (step S99), and returns to and repeats step S84 (see FIG. 20). For example, the processor 11 outputs the self-apparatus voice data Dm and the other-apparatus voice data Dn from the audio output unit 16 of the self-apparatus, and deletes voice data stored in the self-apparatus voice data Dm and the other-apparatus voice data Dn.

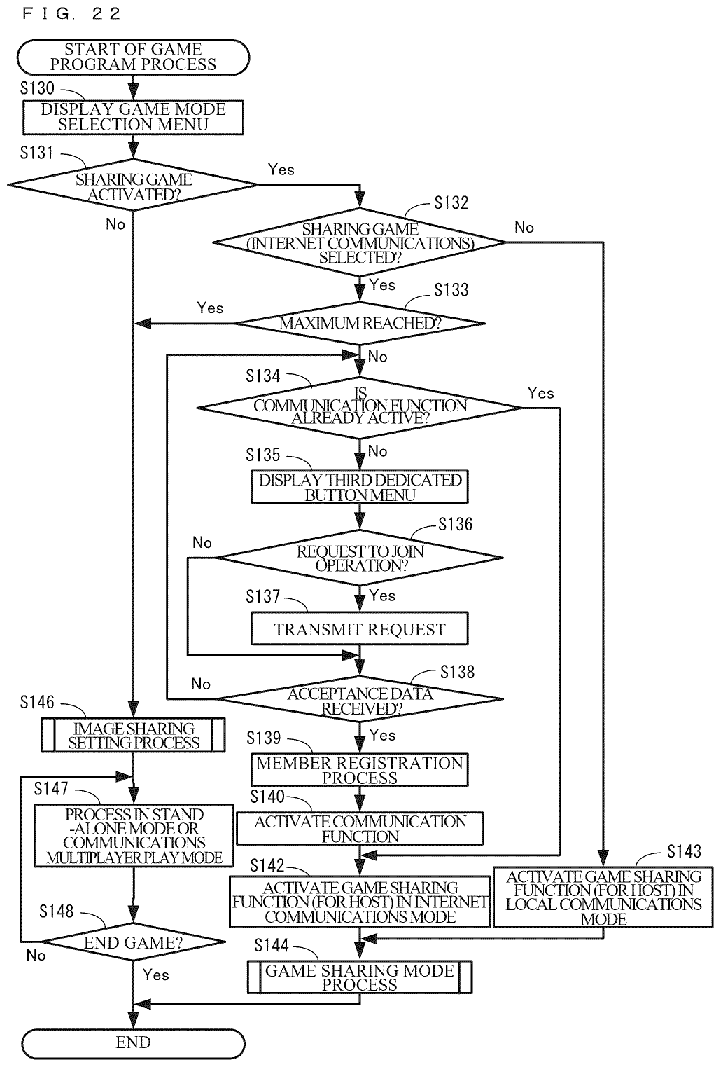

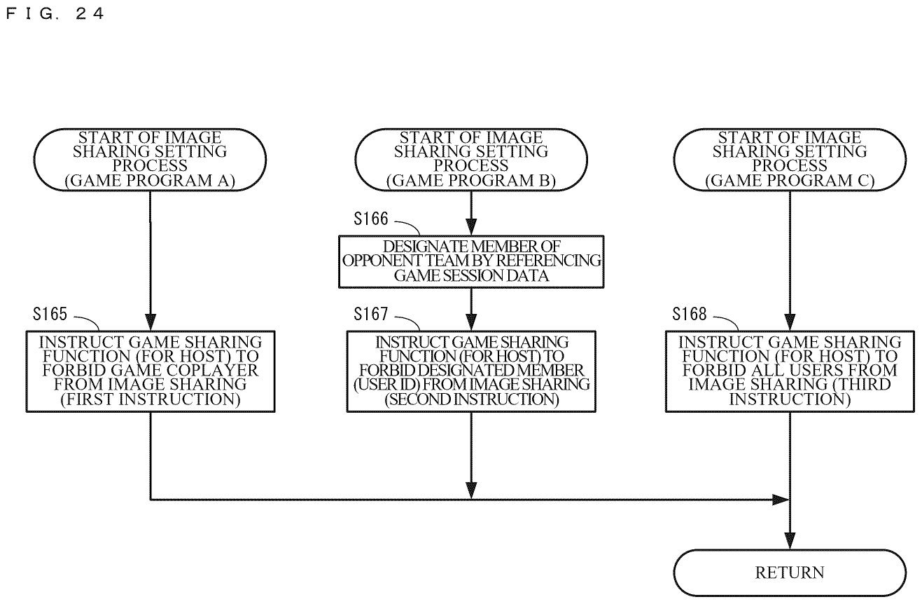

Next, an example detailed game program process will be described as an example information process in the present example with reference to FIGS. 22 to 24. FIG. 22 is a flowchart showing an example game program process that is executed in the information processing apparatus 1. FIG. 23 is a subroutine indicating an example detailed game sharing mode process that is executed in step S144 of FIG. 22. FIG. 24 is a subroutine indicating an example detailed image sharing setting process that is executed in step S146 of FIG. 22 and step S151 of FIG. 23. In the present example, a series of steps shown in FIGS. 22 to 24 is executed by the processor 11 executing a predetermined application program (game program) included in the programs Pa. It should be noted that the timing of start of the game program process of FIGS. 22 to 24 is not particularly limited.

In FIG. 22, the processor 11 displays a game mode selection menu on the display 15 of the self-apparatus (step S130), and proceeds to the next step. For example, the processor 11 displays the menu image GMa illustrated in the top figure of FIG. 10 to prompt the user of the self-apparatus to select a game mode.

Next, the processor 11 determines, with reference to the self-apparatus operation data Db, whether or not an operation of selecting a game mode in which a sharing game is to be played (e.g., an operation of selecting the menu IM3 for starting a game in the game sharing mode employing Internet communications or the menu IM4 for starting a game in the game sharing mode employing local wireless communications, which are illustrated in the top figure of FIG. 10) has been performed (step S131). If the operation of selecting a game mode has been performed, the processor 11 proceeds to step S132. Otherwise, i.e., if the operation of selecting a game mode has not been performed, the processor 11 proceeds to step S146.

In step S132, the processor 11 determines, with reference to the self-apparatus operation data Db, whether or not an operation of selecting a game mode in which a sharing game is to be played using Internet communications (e.g., an operation of selecting the menu IM3 for starting a game in the game sharing mode employing Internet communications, which is illustrated in the top figure of FIG. 10) has been executed. If the operation of selecting a game mode in which a sharing game is to be played using Internet communications has been performed, the processor 11 proceeds to step S133. Otherwise, i.e., if the operation of selecting a game mode in which a sharing game is to be played using local wireless communications has been performed, the processor 11 proceeds to step S143.

In step S133, the processor 11 determines whether or not the number of sharing games employing Internet communications that are being played in the communication group to which the self-apparatus belongs has reached the maximum. For example, if the number of sharing games employing Internet communications that are being played in the communication group to which the self-apparatus belongs has reached a predetermined threshold (e.g., a number of at least two), the result of the determination by the processor 11 in step S133 is positive. As an example, the processor 11 may obtain information about the members of the communication group from the server 101a, and information about the number of host apparatuses that are executing a sharing game employing Internet communications from the server 101b, and calculate the number of sharing games based on the these pieces of information. In addition, the processor 11 may ask the server 101b to permit starting of a sharing game, and the server 101b may determine whether or not to give the permission, depending on the number of sharing games employing Internet communications that are being played in the same communication group. As another example, the processor 11 may manage, in the self-apparatus, the number of sharing games employing Internet communications that are being played in the communication group to which the self-apparatus belongs. If the number of sharing games employing Internet communications has not reached the maximum, the processor 11 proceeds to step S134. Otherwise, i.e., if the number of sharing games employing Internet communications has reached the maximum, the processor 11 proceeds to step S146. It should be noted that if no limitation is imposed on the number of sharing games that can be simultaneously started in the same communication group, step S133 may not be executed. In addition, if the result of the determination in step S133 is positive, the processor 11 may return to step S130, in which the user may be prompted again to select a game mode. In that case, the game mode in which a sharing game is played using Internet communications may not be allowed to be selected, and the user may be prompted again to select a game mode.

In step S134, the processor 11 determines whether or not the communication function of the self-apparatus is active. If the communication function is not active, the processor 11 proceeds to step S135. Otherwise, i.e., if the communication function is active, the processor 11 proceeds to step S142.

In step S135, the processor 11 displays the third dedicated button menu image BMc (see the bottom figure of FIG. 13) on the display 15 of the self-apparatus, and proceeds to the next step.

Next, the processor 11 determines, with reference to the self-apparatus operation data Db, whether or not an operation of requesting the user of another information processing apparatus 1 displayed through the third dedicated button menu image BMc to obtain the communication function has been performed (step S136). If the operation of requesting the user of another information processing apparatus 1 has been performed, the processor 11 proceeds to step S137. Otherwise, i.e., if the operation of requesting the user of another information processing apparatus 1 has not been performed, the processor 11 proceeds to step S138.

In step S137, the processor 11 transmits request-to-join data for request for joining a communication group to the user selected in step S136 through the server 101a, and proceeds to step S138. For example, the processor 11 stores request-to-join data indicating information for requesting the user of another information processing apparatus 1 to join a communication group and a request-to-join source into the communication member registration related data Dj, and transmits the request-to-join data to the server 101a.

In step S138, the processor 11 determines whether or not acceptance data indicating acceptance of registration as a member of a communication group has been received, through the server 101a, from another information processing apparatus 1 that has transmitted the request-to-join data. If the acceptance data has been received, the processor 11 proceeds to step S139. Otherwise, i.e., if the acceptance data has not been received, the processor 11 returns to and repeats step S134. It should be noted that if step S138 has been repeatedly executed for at least a predetermined period of time, the processor 11 may return to step S130, in which the user is prompted again to select a game mode.

In step S139, the processor 11 executes the member registration process of transmitting, to the server 101a, data for registering the user of the self-apparatus as a member of a communication group, and proceeds to the next step. For example, the processor 11 stores information for registering the user of the self-apparatus as a member of a communication group into the communication member registration related data Dj, and transmits the data to the server 101a. It should be noted that if the process of registering the user of the self-apparatus as a member of a communication group has been executed using the request-to-join data transmitted in step S139 in the server 101a, the member registration process of step S139 may not be executed. In that case, in the server 101a, the process of registering the information processing apparatus 1 that is the transmission source of the request-to-join data and the information processing apparatus 1 that is the transmission source of the acceptance data as a member of the same communication group has been executed, which is triggered by transmission of the above acceptance data from the information processing apparatus 1 that is the receiver of the above request-to-join data.

Next, the processor 11 activates the communication function of the self-apparatus (step S140), and proceeds to step S142.

In step S142, the processor 11 activates the game sharing function for a host employing Internet communications (system program), and proceeds to step S144.

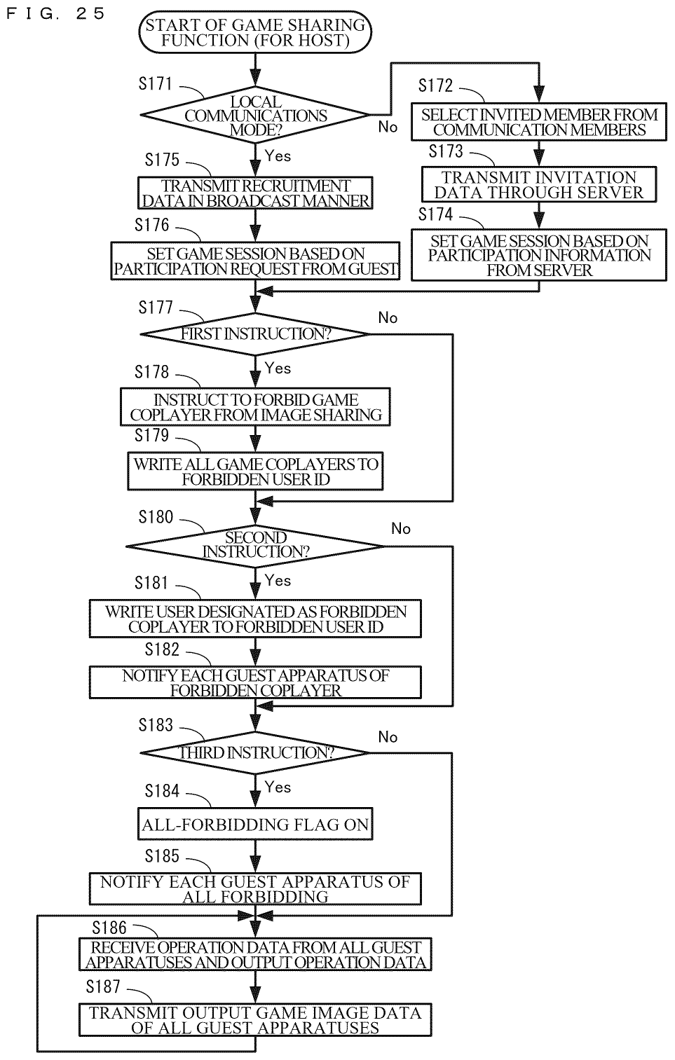

If in step S132, the processor 11 determines that the operation of selecting a game mode in which a sharing game is to be played using local wireless communications has been performed, the processor 11 activates the game sharing function for a host of the self-apparatus that employs local wireless communications (step S143), and proceeds to step S144. The game sharing function process for a host (system program) is described below with reference to FIG. 25.

In step S144, the processor 11 executes the game sharing mode process, and ends the flowchart. Thus, in a menu provided by a game program, the game sharing function is activated, and in addition, a communications scheme is selected for the game sharing function. Therefore, a user that plays a game can activate the game as a sharing game in an easy-to-understand manner when the user desires to do so. In addition, the user can select an appropriate communications scheme, depending on the situation. An example game sharing mode process that is executed in step S144 will be described below with reference to FIG. 23.

In FIG. 23, the processor 11 obtains user information (e.g., a user ID) about a user that plays a sharing game, sets a game session in the sharing game (step S150), and proceeds to the next step. For example, when a sharing game employing Internet communications is played, the processor 11 obtains, from the server 101b, information about a game member in a sharing game that is to be started (the user ID of a game member, team identification information of a user participating as a player, spectator participation information of a user participating as a spectator, etc.), and updates the game session data Dg. It should be noted that when a sharing game is played using local wireless communications, the game session data Dg of a sharing game that is to be started is updated by step S176, which is executed by the game sharing function (for a host) of the self-apparatus.

Next, the processor 11 executes the image sharing setting process (step S151), and proceeds to step S152. An example of the image sharing setting process that is executed in step S151 will be described below with reference to FIG. 24. For example, details of the image sharing setting process vary from game program to game program. Game programs A, B, and C having different details of the image sharing setting process will be described.

In FIG. 24, the processor 11, when is executing the game program A, issues a first instruction to the game sharing function (for a host) of the self-apparatus through an API (step S165), and ends the subroutine. Here, the game program A includes the first instruction to forbid all game members that play a sharing game together from image sharing. The first instruction is to “forbid all members that are playing a sharing game together from screen sharing”, and it is not necessary to designate individual users that are forbidden from image sharing. A system program, when receiving the instruction, forbids each member that is currently playing a sharing game together from screen sharing. The processor 11 instructs, based on the above first instruction included in the game program A, the game sharing function (for a host) of the self-apparatus to forbid all game members that play a sharing game from image sharing. It should be noted that in the above setting, only a member(s) that is participating as a player of the above sharing game may be to be forbidden from image sharing, and when a user that participates as a spectator exists in the above sharing game, the user may be excluded from those that are to be forbidden from image sharing.

In addition, the processor 11, when is executing the game program B, identifies a member of an opponent team in a sharing game that is to be started, with reference to the game session data Dg (step S166), and proceeds to the next step. For example, the processor 11 identifies the user ID of a user in an opponent team based on the user IDs and team identification information of game members managed in the game session data Dg. In another example, when the game program B that is being executed by the processor 11 forbids a user participating as a player, excluding a game spectator, from image sharing, the processor 11 may exclude the user ID of the user participating a spectator in a sharing game from those that are to be forbidden from image sharing, based on the user IDs and spectator participation information of game members managed in the game session data Dg.

Next, the processor 11, when is executing the game program B, issues a second instruction to the game sharing function (for a host) of the self-apparatus through an API (step S167), and ends the subroutine. Here, the game program B includes the second instruction to forbid a designated user from image sharing (individually forbidding). The above second instruction, which is different from the above first instruction, includes a user ID that is to be forbidden from image sharing. The processor 11 instructs the game sharing function (for a host) of the self-apparatus to forbid the user designated in step S166 from image sharing, based on the above second instruction included in the game program B.

In addition, the processor 11, when is executing the game program C, issues a third instruction to the game sharing function (for a host) of the self-apparatus through an API (step S168), and ends the subroutine. Here, the game program C includes a third instruction to forbid all users from image sharing (all forbidding). The above third instruction is to “forbid all users from image sharing”, and does not include any user ID that is to be forbidden from image sharing. The processor 11 instructs the game sharing function (for a host) of the self-apparatus to forbid all users from image sharing, based on the above third instruction included in the game program C.

Referring back to FIG. 23, after the image sharing setting process of step S151, the processor 11 obtains operation data from the operation unit 19 of the self-apparatus, updates the self-apparatus operation data Db (step S152), and proceeds to the next step.

Next, the processor 11 obtains operation data of all guest apparatuses, updates the other-apparatus operation data Dc (step S153), and proceeds to the next step. For example, the processor 11 updates the other-apparatus operation data Dc using operation data of guest apparatuses and the game session ID received from the server 101b or the guest apparatuses in the game sharing function for a host.

Next, the processor 11 executes a game process based on operation data of the self-apparatus (host apparatus) and another apparatus (guest apparatus) (step S154), and proceeds to the next step. The specific details of the game process in step S154 are not particularly limited. For example, the action of a player character corresponding to each apparatus may be controlled based on the operation data of the apparatus, the action of a non-player character may be controlled, an instruction may be selected in a game based on the operation data of each apparatus.

Next, the processor 11 executes the process of generating a game image for each apparatus based on a result of the game process executed in step S154 (step S155), and proceeds to the next step. For example, based on a result of the game process, the processor 11 generates a game image for the self-apparatus (host apparatus) and a game image for another apparatus (guest apparatus), and updates the self-apparatus game image data Dd and the other-apparatus game image data De. It should be noted that the generated game images may be the same image common to all of the host apparatus and the guest apparatus.

Next, the processor 11 renders a game image of the self-apparatus in the frame buffer to display the game image on the display 15 of the self-apparatus (step S156), and proceeds to the next step. For example, the processor 11 adds sharing game identification display to a game image for a host apparatus indicated by the self-apparatus game image data Dd, and renders the resultant game image in the frame buffer to display the game image in the self-apparatus image display region of the display 15 (see the game image IPa of FIG. 6 and the game image IPc of FIG. 8).

Next, the processor 11 executes the process of outputting a game image of another apparatus to the game sharing function for a host (step S157), and proceeds to the next step. For example, the processor 11 performs control to output game image data for a guest apparatus stored in the other-apparatus game image data De, together with the game session ID, to the game sharing function for a host, and thereby transmit the game image data to each guest apparatus.

Next, the processor 11 determines whether or not to end the game (step S158). In step S158, the game is ended, for example, if a condition for ending the game is satisfied, the user has performed an operation of ending the game, or the like. If the processor 11 does not determine to end the game, the processor 11 returns to and repeats step S152. Otherwise, i.e., if the processor 11 determines to end the game, the processor 11 proceeds to step S159.

In step S159, the processor 11 determines whether or not to end the game sharing mode. In step S159, the game sharing mode is ended, for example, if a condition for ending the game sharing mode is satisfied, the user has performed an operation of ending the game sharing mode, or the like. If the processor 11 does not determine to end the game sharing mode, the processor 11 returns to and repeats step S152. Otherwise, i.e., if the processor 11 determines to end the game sharing mode, the processor 11 ends the subroutine.

Referring back to FIG. 22, if in step S131, the processor 11 determines that the operation of selecting a game mode in which a sharing game is to be played has not been performed, the processor 11 executes the image sharing setting process in the stand-alone mode or the communications multiplayer play mode (step S146), and proceeds to the next step. It should be noted that the image sharing setting process of step S146 is similar to that of step S151 described above with reference to FIG. 24 and will not be described in detail.

Next, the processor 11 executes a process in the stand-alone mode or the communications multiplayer play mode (step S147), and proceeds to the next step. It should be noted that in step S147, based on the game mode selected from the game mode selection menu displayed in step S130, the stand-alone mode or the communications multiplayer play mode is determined as a game play mode, and a game image based on a result of a game process corresponding to the mode is displayed as a self-screen image on the display 15 of the self-apparatus. The specific details of the game process are not particularly limited and will not be described in detail.

Next, the processor 11 determines whether or not to end the game that is being played in step S147 (step S148). The condition for ending the game in step S148 is, for example, that a condition for ending the game is satisfied, the user has performed an operation of ending the game, or the like. If the processor 11 does not determine to end the above game, the processor 11 returns to and repeats step S147. If the processor 11 determines to end the game, the processor 11 ends the flowchart.

Next, a game sharing function process for a host that is an example information process in the present example will be described with reference to FIG. 25. It should be noted that FIG. 25 is a flowchart showing an example game sharing function process for a host that is executed in the information processing apparatus 1. In the present example, a series of steps shown in FIG. 25 is executed by the processor 11 executing a system program included in the programs Pa. It should be noted that the game sharing function process for a host of FIG. 25 is started in response to execution of step S142 or S143. The timing of start of the game sharing function process for a host is not particularly limited.

In FIG. 25, the processor 11 determines whether or not the game sharing function is active in the local communications mode (step S171). If the game sharing function is active in the Internet communications mode, the processor 11 proceeds to step S172. Otherwise, i.e., if the game sharing function is active in the local communications mode, the processor 11 proceeds to step S175.

In step S172, the processor 11 displays an invited member selection image showing that members of the communication group to which the self-apparatus belongs are invited to a sharing game (Internet communications) (see the second figure from the top of FIG. 10). The processor 11 receives a user operation for selecting a member to be invited (invited member). If the self-apparatus operation data Db indicates that the user operation has been performed, the processor 11 proceeds to the next step. It should be noted that a plurality of invited members may be selected. In addition, the processor 11 obtains information about a member of a communication group from the server 101a, and based on the information, may display the above invited member selection image.

Next, the processor 11 transmits invitation data for inviting to game sharing (Internet communications) to the information processing apparatus 1 of each invited member through the server 101b, and proceeds to the next step. For example, the processor 11 stores invitation data that is to be transmitted to the information processing apparatus 1 of the invited member selected in step S172 into the invitation/recruitment/participation data Dh, and transmits the invitation data to the information processing apparatus 1 of the invited member through the server 101b.

Next, the processor 11 sets game session data in a sharing game that is to be started, based on participation information transmitted from the server 101b, and proceeds to step S177. For example, the processor 11 updates the game session data Dg based on the user information (e.g., a user name), game session ID, team identification information, spectator participation information, and the like of a guest apparatus registered as a game member, which is indicated by participation information that has been transmitted from the server 101b.

If in step S171, the processor 11 determines that the game sharing function is active in the local communications mode, the processor 11 transmits recruitment data for recruitment to game sharing (local wireless communications) to information processing apparatuses 1 existing around the self-apparatus in a broadcast manner (e.g., a range in which local wireless communications can be performed by the self-apparatus), and proceeds to the next step. For example, the processor 11 stores recruitment data that is to be transmitted to the above information processing apparatuses 1 into the invitation/recruitment/participation data Dh, and transmits the recruitment data in a broadcast manner.

Next, the processor 11 sets game session data in a sharing game that is to be started, based on a participation request transmitted from a guest apparatus, and proceeds to step S177. For example, the processor 11 sets a game member, game session ID, team identification information, spectator participation information, and the like in a sharing game that is to be started, based on user information (e.g., a user name) of a guest apparatus indicated by the above participation request, and updates the game session data Dg. In addition, the processor 11 transmits information indicating the set game session data to each guest apparatus that has transmitted the above participation request.

Thus, in the case of the local communications mode, not only the communication group to which the self-apparatus belongs but also apparatuses around the self-apparatus are recruited to game sharing. In the case of a sharing game employing Internet communications, a remote user may become a coplayer, and the communication function is required for sharing play that is performed while communication is performed. In the case of the local communications mode, direct communication is highly likely to be allowed, and therefore, it is not necessary to limit the game member to communication members, unlike sharing games employing Internet communications.

In step S177, the processor 11 determines whether or not the game module (module executed by a game program) of the self-apparatus has issued the above first instruction to the game sharing function (for a host) through an API (see step S165 in FIG. 24). If the first instruction has been issued, the processor 11 proceeds to step S178. Otherwise, i.e., if the first instruction has not been issued, the processor 11 proceeds to step S180.

In step S178, the processor 11 instructs the server 101b or each guest apparatus to forbid all users that are a game sharing coplayer from image sharing, and proceeds to the next step. For example, when the processor 11 starts a sharing game employing Internet communications, the processor 11 requests the server 101b to set the coplayer forbidding flag to on. In addition, when the processor 11 starts a sharing game employing local wireless communications, the processor 11 instructs each guest apparatus to forbid a game coplayer from image sharing.

Next, the processor 11 identifies the user IDs of all users that are a game sharing coplayer, writes each user ID into the forbidden user ID (step S179), and proceeds to step S180. For example, the processor 11 references the game session data Dg to obtain the user IDs of all game members that are to participate in a sharing game that is to be started, and writes the user IDs into the forbidden user ID data Dr.

In step S180, the processor 11 determines whether or not the game module of the self-apparatus has issued the above second instruction to the game sharing function (for a host) (see step S167 in FIG. 24). If the second instruction has been issued, the processor 11 proceeds to step S181. Otherwise, i.e., if the second instruction has not been issued, the processor 11 proceeds to step S183.

In step S181, the processor 11 writes the user ID of a user that is forbidden from image sharing and is designated by the above second instruction into the forbidden user ID data Dr, and proceeds to the next step. It should be noted that in the above second instruction, the ID of a user that is forbidden from image sharing in a host apparatus and the ID of a user that is forbidden from image sharing in a guest apparatus (if there are a plurality of guest apparatuses, the ID of a user that is forbidden from image sharing for each guest apparatus) may be designated. In that case, in step S181, the ID of a user that is forbidden from image sharing in a host apparatus may be written into the forbidden user ID data Dr.

Next, the processor 11 notifies each guest apparatus of the user ID of a user that is forbidden from image sharing (user ID forbidden for each guest apparatus) and is designated by the above second instruction (step S182), and proceeds to step S183. For example, when a sharing game employing Internet communications is started, the processor 11 notifies each guest apparatus of the user ID of a user that is forbidden from image sharing through the server 101b (or P2P). In addition, when a sharing game employing local wireless communications is started, the processor 11 directly notifies each guest apparatus of the user ID of a user that is forbidden from image sharing.

In step S183, the processor 11 determines whether or not the game module of the self-apparatus has issued the above third instruction to the game sharing function (for a host) (see step S168 in FIG. 24). If the third instruction has been issued, the processor 11 proceeds to step S184. Otherwise, i.e., if the third instruction has not been issued, the processor 11 proceeds to step S186.

In step S184, the processor 11 sets the all-forbidding flag to on, updates the all-forbidding flag data Dq, and proceeds to the next step.

Next, the processor 11 notifies each guest apparatus of all forbidding (step S185), and proceeds to step S186. For example, when a sharing game employing Internet communications is started, the processor 11 notifies each guest apparatus of all forbidding through the server 101b (or P2P). In addition, when a sharing game employing local wireless communications is started, the processor 11 directly notifies each guest apparatus of all forbidding.

In step S186, the processor 11 receives operation data of all guest apparatuses, outputs the operation data as data that is to be used in the above game program process, and proceeds to the next step. For example, if the Internet communications mode has been selected, the processor 11 receives operation data of all guest apparatuses transmitted from the server 101b (or P2P) together with a game session ID and outputs these pieces of data as data that is to be used in the above game program process, using Internet communications. In addition, if the local communications mode has been selected, the processor 11 receives operation data of all guest apparatuses transmitted from the guest apparatuses and outputs the operation data as data that is used in the above game program process, using local wireless communications.

Next, the processor 11 transmits the game image data for a guest apparatus output by the above game program process (step S187), and returns to and repeats step S186. For example, if the Internet communications mode has been selected, the processor 11 transmits the game image data for a guest apparatus output by the above game program process together with a game session ID, to the server 101b (or through P2P), using Internet communications. In addition, if the local communications mode has been selected, the processor 11 transmits the game image data for a guest apparatus output by the above game program process, to each game apparatus, using local wireless communications.

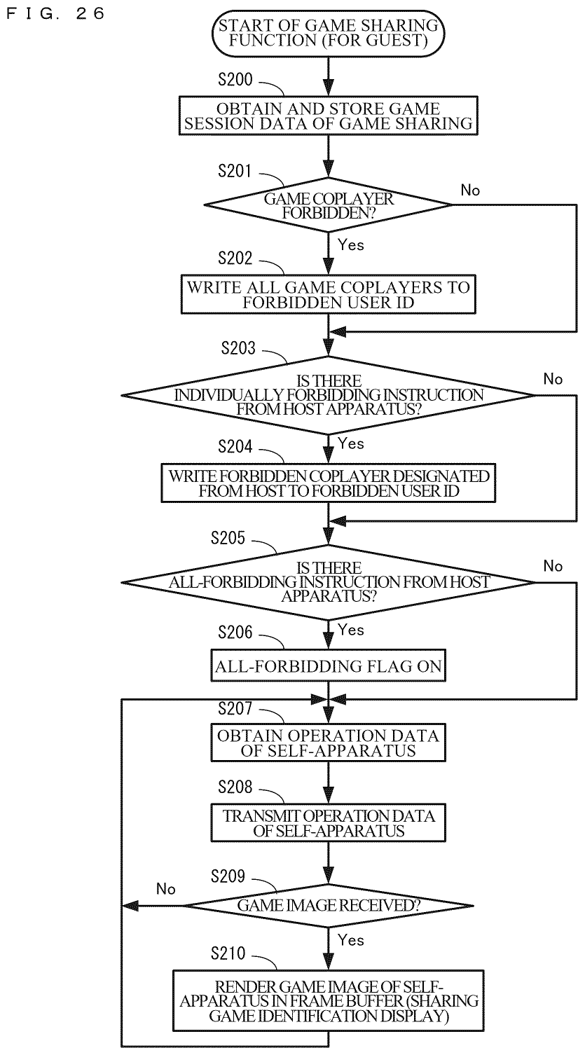

Next, referring to FIG. 26, an example detailed game sharing function process for a guest that is an example information process in the present example will be described. It should be noted that FIG. 26 is a flowchart showing an example game sharing function process for a guest that is executed in the information processing apparatus 1. The game sharing function process for a guest is activated by step S75, which has been described with reference to FIG. 18, or by step S313, which has been described with reference to FIG. 19. In the former case, the game sharing function process for a guest is activated in the local communications mode; and in the latter case, in the Internet communications mode. In the present example, a series of steps shown in FIG. 26 is executed by the processor 11 executing a system program included in the programs Pa. Although the game sharing function process for a guest of FIG. 26 is started in response to execution of step S68, the timing of start of the game sharing function process for a guest of FIG. 26 is not particularly limited.

In FIG. 26, the processor 11 obtains and stores game session data that is used in a sharing game (step S200), and proceeds to the next step. For example, in the case of the Internet communications mode, the processor 11 sets game session data in a sharing game that is to be started, based on participation information transmitted from the server 101b (or P2P) using Internet communications, and updates the game session data Dg. In addition, in the case of the local communications mode, the processor 11 updates the game session data Dg based on the game session data transmitted from a host apparatus using local wireless communications.

Next, the processor 11 determines whether or not an instruction to forbid a game coplayer from image sharing has been issued (step S201). For example, if the coplayer forbidding flag managed by the server 101b is on, the result of the determination by the processor 11 in step S201 is positive. In addition, if a host apparatus has issued an instruction to forbid a game coplayer from image sharing, the result of the determination by the processor 11 in step S201 is positive. If the instruction to forbid a game coplayer from image sharing has been issued, the processor 11 proceeds to step S202. Otherwise, i.e., if the instruction to forbid a game coplayer from image sharing has not been issued, the processor 11 proceeds to step S203. It should be noted that in the case in which a sharing game employing local wireless communications is played, and therefore, the coplayer forbidding flag is managed by an information processing apparatus 1 (e.g., a host apparatus or each guest apparatus), the processor 11 may execute the determination of step S201 based on the setting of the coplayer forbidding flag managed by the information processing apparatus 1.

In step S202, the processor 11 writes the user IDs of all users that are a game sharing coplayer into the forbidden user ID, and proceeds to step S203. For example, the processor 11 references the game session data Dg to obtain the user IDs of all game members that are to participate in a sharing game that is to be started, and writes the user IDs into the forbidden user ID data Dr.

In step S203, the processor 11 determines whether or not a host apparatus has issued an individually forbidding instruction. For example, if the user ID of a user that is forbidden from image sharing has been notified of by a host apparatus, the result of the determination by the processor 11 in step S203 is positive. If the individually forbidding instruction has been issued, the processor 11 proceeds to step S204. Otherwise, i.e., if the individually forbidding instruction has not been issued, the processor 11 proceeds to step S205. For example, in the case of the Internet communications mode, a host apparatus notifies that the user ID of a user that is forbidden from image sharing is subject to the above individually forbidding, through the server 101b (or P2P), using Internet communications. In addition, in the case of the local communications mode, a host apparatus directly notifies each guest apparatus that the user ID of a user that is forbidden from image sharing is subject to the above individually forbidding, using local wireless communications.

In step S204, the processor 11 writes the user ID of a user designated by a host apparatus for individually forbidding into the forbidden user ID data Dr, and proceeds to step S205.

In step S205, the processor 11 determines whether or not an all-forbidding instruction has been issued by a host apparatus. If the all-forbidding instruction has been issued, the processor 11 proceeds to step S206. Otherwise, i.e., if the all-forbidding instruction has not been issued, the processor 11 proceeds to step S207. For example, in the case of the Internet communications mode, the above all forbidding instruction is issued by a host apparatus through the server 101b (or P2P) using Internet communications. In the case of the local communications mode, the above all forbidding instruction is directly issued from a host apparatus to each guest apparatus using local wireless communications.

In step S206, the processor 11 sets the all-forbidding flag to on, updates the all-forbidding flag data Dq, and proceeds to step S207.

In step S207, the processor 11 obtains operation data from the operation unit 19 of the self-apparatus, updates the self-apparatus operation data Db, and proceeds to the next step.

Next, the processor 11 transmits the operation data of the self-apparatus obtained in step S207 (step S208), and proceeds to the next step. For example, in the case of the Internet communications mode, operation data of the self-apparatus is transmitted together with a game session ID to the server 101b (or to a host apparatus through P2P) using Internet communications. In the case of the local communications mode, the processor 11 transmits operation data of the self-apparatus to a host apparatus using local wireless communications.

Next, the processor 11 determines whether or not game image data for the self-apparatus (guest apparatus) has been received (step S209). If game image data for the self-apparatus has been received, the processor 11 proceeds to step S210. Otherwise, i.e., if game image data for the self-apparatus has not been received, the processor 11 returns to and repeats step S207. For example, in the case of the Internet communications mode, game image data for the self-apparatus is received through the server 101b (or P2P) using Internet communications. In the case of the local communications mode, game image data for the self-apparatus is directly received from a host apparatus using local wireless communications.

In step S210, the processor 11 updates the self-apparatus game image data Dd using the received game image data and game session ID. Thereafter, the processor 11 performs control to render a game image indicated by the self-apparatus game image data Dd in the frame buffer, to display the game image on the display 15 of the self-apparatus, and returns to and repeats step S207. For example, the processor 11 adds sharing game identification display to the game image for a guest apparatus indicated by the self-apparatus game image data Dd, and renders the resultant game image in the frame buffer to display the game image in the self-apparatus image display region of the display 15 (see the game image IPb of FIG. 7 and the game image IPd of FIG. 9).

Thus, the game sharing function process for a guest is activated in the local communications mode when recruitment from a host apparatus in the local communications mode is accepted, and in the Internet communications mode when an invitation is received from a host apparatus in the Internet communications mode and is accepted. Therefore, the communications scheme can be efficiently set on the guest side.

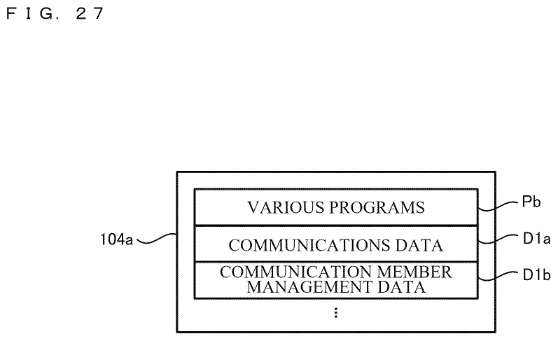

Next, data and programs stored in the storage 104a of the server 101a that are used to control the communication function will be described with reference to FIG. 27. Although the server 101a also stores data used in other processes in addition to the data of FIG. 27, such additional data will not be described in detail.

As shown in FIG. 27, the storage 104a stores, in a data storage area thereof, communications data D1a, communication member management data D1b, and the like. In addition, various programs Pb for carrying out the above processes are stored in the program storage area of the storage 104a.

The communications data D1a stores, as appropriate, reception data that has been received from each information processing apparatus 1, and stores, as appropriate, transmission data that is to be transmitted to each information processing apparatus 1. It should be noted that the timing of receiving data from the information processing apparatus 1 and storing the data into the communications data D1a, and the timing of storing data to be transmitted to the information processing apparatus 1 into the communications data D1a and transmitting the data are not particularly limited, and these processes may be executed in each cycle of the process executed in the server 101a.

The communication member management data D1b indicates member information for each communication group that has been formed. For example, the member information includes a communication group ID indicating a communication group, and in addition, an apparatus ID for each member, a user name, and the like.

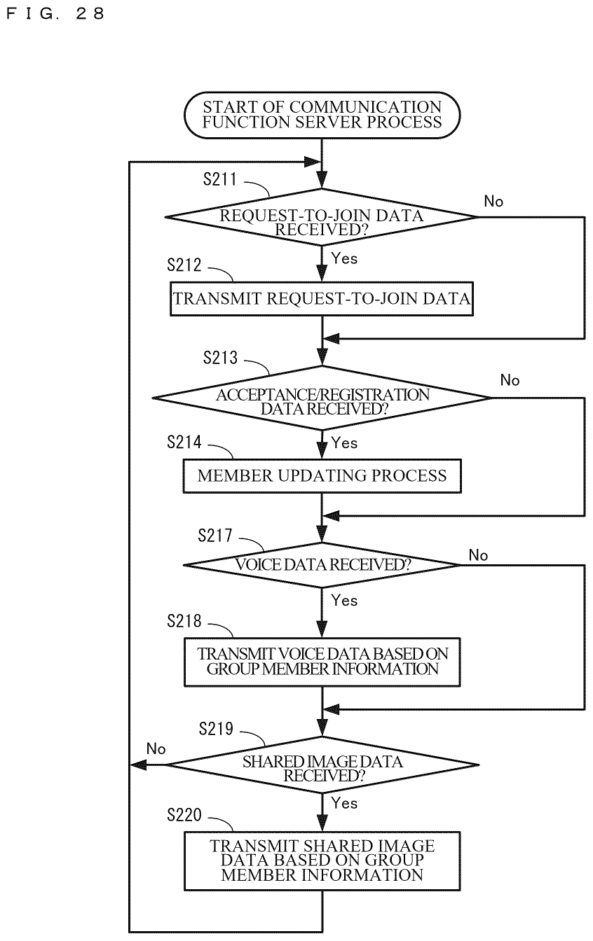

Next, a process that is executed in the server 101a to control the communication function will be described in detail with reference to FIG. 28. Here, in the flowchart of FIG. 28, steps that are executed in the server 101a to manage a communication group will be mainly described, and other steps that are not directly related to these steps will not be described in detail.

In FIG. 28, a processor 103a of the server 101a determines whether or not request-to-join data to the communication function has been received from an information processing apparatus 1 (step S211). If request-to-join data has been received, the processor 103a proceeds to step S212. Otherwise, i.e., if request-to-join data has not been received, the processor 103a proceeds to step S213.

In step S212, the processor 103a transmits the request-to-join data to an information processing apparatus 1 to be requested, and proceeds to step S213. For example, the processor 103a transmits request-to-join data indicating a user that is a request-to-join source and indicating that the user as the request-to-join source requests registration as a member of a communication group, the request-to-join data being addressed to an information processing apparatus 1 to be requested with the request-to-join data received in step S211. It should be noted that if the user as the request-to-join source has already belonged to a communication group, the processor 103a may transmit request-to-join data to which information about the members of the communication group is added. For example, if the communication member management data D1b indicates that the user as the request-to-join source is registered as a member of a communication group, the processor 103a may transmit, to an information processing apparatus 1 to be enticed, request-to-join data to which information about the members of the communication group and the communication group ID of the communication group are added.

In step S213, the processor 103a determines whether or not acceptance data or registration data has been received from an information processing apparatus 1. If acceptance data or registration data has been received, the processor 103a proceeds to step S214. Otherwise, i.e., if neither acceptance data nor registration data has been received, the processor 103a proceeds to step S217.

In step S214, the processor 103a executes a member updating process, and proceeds to step S217. As a first example, if the communication member management data D1b indicates that a user as a request-to-join source indicated by the received acceptance data does not belong to a communication group, the processor 103a generates a new communication group. Thereafter, the processor 103a registers the user as the request-to-join source and the accepted user in the acceptance data as a member of the newly generated communication group, sets a communication group ID for the communication group, and updates the communication member management data D1b. As a second example, if the communication member management data D1b indicates that a user as a request-to-join source indicated by the received acceptance data belongs to a communication group, the processor 103a registers the accepted user in the acceptance data as a member of the communication group, and updates the communication member management data D1b. As a third example, the processor 103a registers a user as a transmission source that has transmitted registration data, as a member of the communication group for which the user desires to be registered as a member, and updates the communication member management data D1b.

In step S217, the processor 103a determines whether or not voice data has been received from an information processing apparatus 1. If voice data has been received, the processor 103a proceeds to step S218. Otherwise, i.e., if voice data has not been received, the processor 103a proceeds to step S219.

In step S218, the processor 103a transmits the voice data received in step S217, based on the communication member management data D1b, and proceeds to step S219. For example, the processor 103a retrieves the communication group to which the transmission source of the received voice data belongs from the communication member management data D1b, adds information about the transmission source of the voice data and the communication group ID to the voice data, and transmits the resultant voice data to the information processing apparatus 1 of each member of the communication group.

In step S219, the processor 103a determines whether or not shared image data has been received from an information processing apparatus 1. If shared image data has been received, the processor 103a proceeds to step S220. Otherwise, i.e., if shared image data has not been received, the processor 103a returns to and repeats step S211.

In step S220, the processor 103a transmits the shared image data received in step S219, based on the communication member management data D1b, and returns to and repeats step S211. For example, the processor 103a retrieves the communication group to which the transmission source of the received shared image data from the communication member management data D1b, adds information (e.g., a user ID) about the transmission source of the shared image data and the communication group ID to the shared image data, and transmits the resultant shared image data to the information processing apparatus 1 of each member of the communication group.

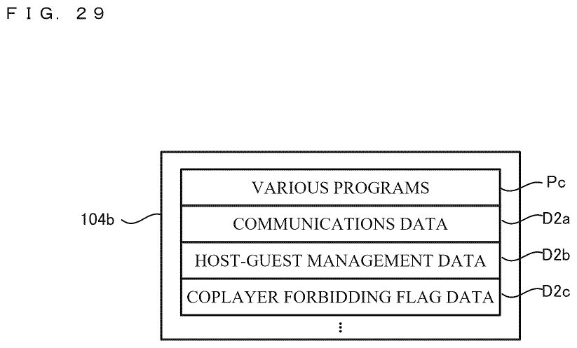

Next, data and programs stored in a storage 104b of the server 101b that are used to control the game sharing function will be described with reference to FIG. 29. Although the server 101b also stores data used in other processes in addition to the data of FIG. 29, such additional data will not be described in detail.

As shown in FIG. 29, the storage 104b stores, in a data storage area thereof, communications data D2a, host-guest management data D2b, coplayer forbidding flag data D2c, and the like. In addition, the storage 104b stores, in a program storage area thereof, various programs Pc for carrying out the above processes.

The communications data D2a stores, as appropriate, reception data that has been received from each information processing apparatus 1, and stores, as appropriate, transmission data that is to be transmitted to each information processing apparatus 1. It should be noted that the timing of receiving data from the information processing apparatus 1 and storing the data into the communications data D2a, and the timing of storing data to be transmitted to the information processing apparatus 1 into the communications data D2a and transmitting the data are not particularly limited, and these processes may be executed in each cycle of the process executed in the server 101b.

The host-guest management data D2b indicates apparatus information for each combination of a host apparatus and a guest apparatus that are executing a sharing game. For example, the apparatus information includes the game session ID for each combination, and in addition, the apparatus ID, the user name, the user ID, the type of a played game, and the like of each of a host apparatus and a guest apparatus that are executing a sharing game.

The coplayer forbidding flag data D2c indicates the coplayer forbidding flag that is set to on for a game session in which a game coplayer is forbidden from image sharing. Based on an instruction from an information processing apparatus 1, the coplayer forbidding flag corresponding to the game session ID to which the information processing apparatus 1 belongs is set to on.

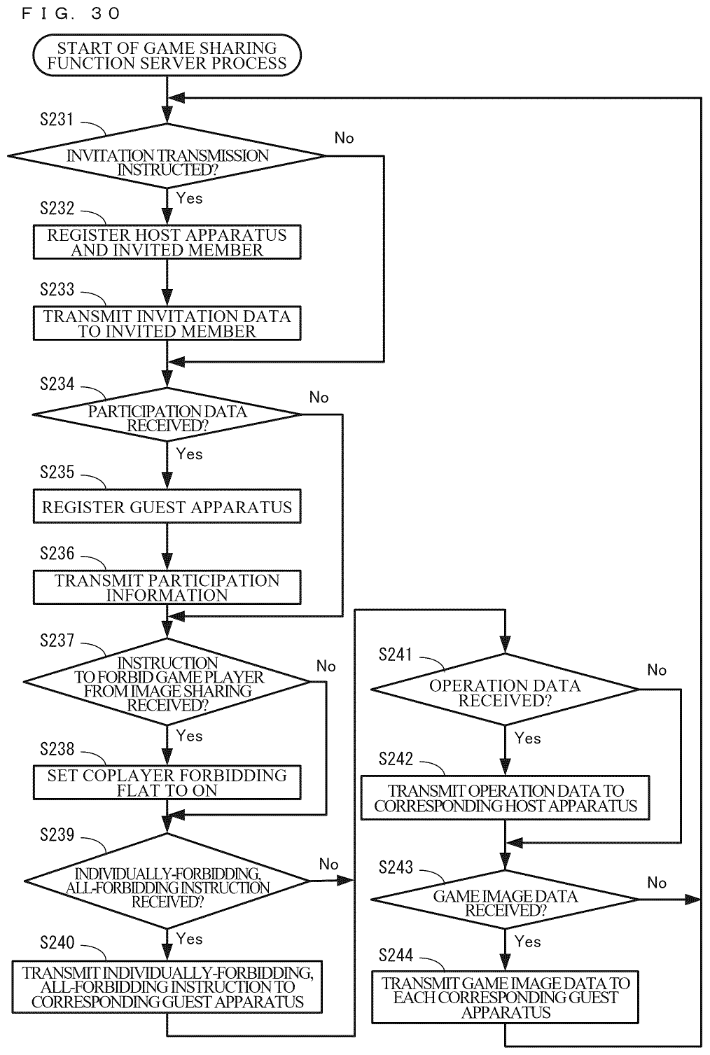

Next, a detailed process that is executed in the server 101b to control the game sharing function will be described with reference to FIG. 30. Here, in the flowchart of FIG. 30, a process that is executed in the server 101b to manage a host apparatus and a guest apparatus that play a sharing game will be mainly described, and other processes that are not directly involved with these processes will not be described in detail.

In FIG. 30, a processor 103b of the server 101b determines whether or not an information processing apparatus 1 has instructed to transmit (Internet communications) invitation data to a sharing game (step S231). If the instruction to transmit the invitation data has been issued, the processor 103b proceeds to step S232. Otherwise, i.e., if the instruction to transmit the invitation data has not been issued, the processor 103b proceeds to step S234.

In step S232, the processor 103b registers a host apparatus and an invited member, and proceeds to the next step. For example, the processor 103b registers the apparatus ID, user ID, and user name of an invitation source that has instructed to transmit invitation data as a host apparatus, registers the apparatus ID, user ID, and user name of an invited member as a guest apparatus candidate, and updates the host-guest management data D2b.

Next, the processor 103b transmits the invitation data to the information processing apparatus 1 that is the invited member (step S233), and proceeds to step S234. For example, the processor 103b transmits invitation data indicating the user of an invitation source and indicating that the user of the invitation source invites to play a sharing game, the invitation data being addressed to the information processing apparatus 1 of the invited member in the invitation data transmission instruction received in step S231. It should be noted that if an invitation source has already served as a host apparatus and, together with another guest apparatus, has formed a combination for playing a sharing game, the processor 103b may transmit the invitation data to which information about the members of the combination is added. For example, with reference to the host-guest management data D2b, the processor 103b may add, to the invitation data, information about a combination of the invitation source as a host apparatus and a guest apparatus and the game session ID of a sharing game for which invitation has been made, and transmit the resultant invitation data to the information processing apparatus 1 of the invited member. In addition, if no participation data has been obtained from the invited member since a predetermined period of time before, the processor 103b may end transmission of the invitation data to the invited member, cancel registration of the guest apparatus candidate, and update the host-guest management data D2b.

In step S234, the processor 103b determines whether or not participation data has been received from an information processing apparatus 1. If participation data has been received, the processor 103b proceeds to step S235. Otherwise, i.e., if participation data has not been received, the processor 103b proceeds to step S237.

In step S235, the processor 103b registers a guest apparatus, and proceeds to the next step. For example, the processor 103b changes the registration of the transmission source of the received participation data from a guest apparatus candidate to a guest apparatus, and updates the host-guest management data D2b. In addition, for a combination for a sharing game in which a guest apparatus has been registered, if the game session ID has not been set, the processor 103b sets the game session ID of the sharing game for the combination, and updates the host-guest management data D2b.

Next, the processor 103b transmits participation information to an information processing apparatus 1 of a coplayer for the guest apparatus registered in step S235 (step S236), and proceeds to step S237. For example, the processor 103b transmits participation information indicating a newly registered guest apparatus (e.g., an apparatus ID), the user (e.g., a user ID and a user name), and the game session ID to a host apparatus and other guest apparatuses.

In step S237, the processor 103b determines whether or not an image sharing forbidding instruction (e.g., an instruction to set the coplayer forbidding flag to on) for a game coplayer has been received from an information processing apparatus 1. If the image sharing forbidding instruction for a game coplayer has been received, the processor 103b proceeds to step S238. Otherwise, i.e., if the image sharing forbidding instruction for a game coplayer has not been received, the processor 103b proceeds to step S239.

In step S238, the processor 103b sets the coplayer forbidding flag to on, and proceeds to step S239. For example, the processor 103b sets, to on, the coplayer forbidding flag corresponding to the game session ID that is started by the information processing apparatus 1 that has transmitted the image sharing forbidding instruction for a game coplayer, and updates the coplayer forbidding flag data D2c.

In step S239, the processor 103b determines whether or not an individually-forbidding or all-forbidding instruction has been received from an information processing apparatus 1. As an example, if data for notifying each guest apparatus of the user ID of a user that is to be forbidden from image sharing (individually-forbidding instruction) has been received from an information processing apparatus 1 (host apparatus), or if data for notifying each guest apparatus of all forbidding (all-forbidding instruction) has been received from an information processing apparatus 1 (host apparatus), the result of the determination by the processor 103b in step S239 is positive. If the individually-forbidding or all-forbidding instruction has been received, the processor 103b proceeds to step S240. Otherwise, i.e., if neither individually-forbidding nor all-forbidding instruction has been received, the processor 103b proceeds to step S241.

In step S240, the processor 103b transmits the individually-forbidding or all-forbidding instruction received in step S239 to a corresponding guest apparatus, and proceeds to step S241.

In step S241, the processor 103b determines whether or not operation data has been received from an information processing apparatus 1. If operation data has been received, the processor 103b proceeds to step S242. Otherwise, i.e., if operation data has not been received, the processor 103b proceeds to step S243.

In step S242, the processor 103b transmits the received operation data to a corresponding host apparatus, and proceeds to step S243. For example, the processor 103b retrieves a host apparatus that is combined with the transmission source (guest apparatus) of the operation data from the host-guest management data D2b, adds information about the guest apparatus that has transmitted the operation data and the game session ID to the operation data, and transmits the resultant operation data to the host apparatus.

In step S243, the processor 103b determines whether or not game image data has been received from an information processing apparatus 1. If game image data has been received, the processor 103b proceeds to step S244. Otherwise, i.e., if game image data has not been received, the processor 103b returns to and repeats step S231.

In step S244, the processor 103b transmits the received game image data to each corresponding guest apparatus, and returns to and repeats step S231. For example, the processor 103b retrieves a transmission destination to which the game image data is to be transmitted from a guest apparatus combined with the transmission source (host apparatus) of the game image data, with reference to the received game image data and the host-guest management data D2b, adds information about the host apparatus and the game session ID to the game image data, and transmits the resultant game image data to the guest apparatus as the transmission destination.

It should be noted that the steps in the flowcharts of FIGS. 17 to 26, 28, and 30, which are merely illustrative, may be executed in a different order, or another step may be executed in addition to and/or instead of each step, if a similar effect is obtained. In the present example, it is assumed that the processor 11, the processor 103a, or the processor 103b (CPU) executes each step of the flowcharts. Alternatively, a portion of the steps of the flowcharts may be executed by the processor 11, the processor 103a, or the processor 103b, and the other portion may be executed by a processor or dedicated circuit other than the processor 11, the processor 103a, or the processor 103b. Still alternatively, all of the steps of the flowcharts may be executed by a processor or dedicated circuit other than the processor 11, the processor 103a, or the processor 103b. In addition, a portion of the steps executed by the information processing apparatus 1, the server 101a, and the server 101b may be executed by another information processing apparatus that can communicate with the information processing apparatus 1, the server 101a, and the server 101b (e.g., another apparatus that can communicate with these apparatuses through a network). Specifically, the steps of FIGS. 17 to 26, 28, and 30 may be executed by a plurality of apparatuses including the information processing apparatus 1, the server 101a, and the server 101b cooperating with each other.

Thus, in the present example, while at least one game member of communication members is forbidden from image sharing, other communication members are allowed to perform image sharing. Therefore, a game image can be appropriately shared in the communication function.

Although in the above examples, a client-server system in which a plurality of information processing apparatuses 1 perform Internet communications through the server 101a or 101b is employed, other communications systems may be employed. In another example, a peer-to-peer communications system employing Internet communications may be employed in which a plurality of information processing apparatuses 1 directly exchange data with each other without through a server. For example, at least one of data communications associated with the communication function executed through the server 101a and data communications associated with the game sharing function executed through the server 101b may be executed using a peer-to-peer communications system employing Internet communications. In the case in which the former data communications is executed using a peer-to-peer communications system, the function of the group management unit 105 of the server 101a may be provided in each information processing apparatus 1. In the case in which the latter data communications is executed using a peer-to-peer communications system, the guest apparatus registration/management function of the game management unit 106 of the server 101b may be provided in the game sharing function for a host in each information processing apparatus 1, and the host apparatus registration/management function of the game management unit 106 of the server 101b may be provided in the game sharing function for a guest in each information processing apparatus 1.

In addition, in the case in which the peer-to-peer communications system is employed, data communications using said communications system may be either Internet communications or local wireless communications. For example, in another example, data communications associated with the communication function may be executed using Internet communications through the server 101a, and data communications associated with the game sharing function may be executed using local wireless communications employing the peer-to-peer communications system.

In addition, in the foregoing description, an example in which an information process (game process) is executed by the information processing apparatus 1 or the servers 101a and 101b. Alternatively, at least a portion of the above process steps may be performed in another apparatus. For example, in the case in which the information processing apparatus 1, the server 101a, and the server 101b can also communicate with another apparatus (e.g., another server, another information processing apparatus, another image display apparatus, another information processing apparatus, or another mobile terminal), the above process steps may be executed in cooperation with the another apparatus. By thus causing another apparatus to perform a portion of the above process steps, a process similar to the above process can be performed. The above information process may be executed by a single processor or a plurality of cooperating processors included in an information processing system including at least one information processing apparatus. In the above examples, the information processes can be executed by the processor 11 of the information processing apparatus 1, the processor 103a of the server 101a, and the processor 103b of the server 101b executing respective predetermined programs. Alternatively, all or a portion of the above processes may be performed by a dedicated circuit(s) included in the information processing apparatus 1, the server 101a, and/or the server 101b.

Here, according to the above variation, the present example can be carried out in a so-called cloud computing system form or distributed wide-area and local-area network system forms. For example, in the distributed local-area network system form, the above process can be executed by cooperation between a stationary information processing apparatus and a mobile information processing apparatus (handheld information processing apparatus). It should be noted that in these system forms, each of the steps may be performed by substantially any of the apparatuses, and the present example may be implemented by assigning the steps to the apparatuses in substantially any manner.

The order of steps, setting values, conditions for determination, etc., used in the above information processes are merely illustrative, and of course, other order of steps, setting values, conditions for determination, etc., may be used to carry out the present example.

The above programs may be supplied to the information processing apparatus 1, the server 101a, and the server 101b not only through an external storage medium, such as an external memory, but also through a wired or wireless communications line. The above programs may be previously stored in a non-volatile storage device in the apparatus. Examples of an information storage medium storing the above programs include non-volatile memories, and in addition, CD-ROMs, DVDs, optical disc-like storage media similar thereto, and flexible disks, hard disks, magneto-optical disks, and magnetic tapes. The information storage medium storing the above programs may be a volatile memory storing the above programs. Such a storage medium may be referred to as a storage medium that can be read by a computer, etc. (an information processing apparatus-readable storage medium, etc.). For example, the above various functions can be provided by causing a computer, etc., to read and execute programs from these storage media. In addition, the above programs may be executed by an interpreter or emulator.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

As described above, the present example is applicable as an information processing system, system program, game program, information processing method, and the like in which a game image or the like can be appropriately shared in a communication group.

What is claimed is:

1. An information processing system comprising one or more memories storing instructions and one or more processors executing the instructions, the information processing system being configured to perform operations comprising:
forming a communication group in which communication is performed, and executing a communication process between a plurality of communication members using network communications;
forming a game group in which a multiplayer game is performed, and executing the multiplayer game between a plurality of game members using the network communications or another network communications to generate game image data for each game member; and
displaying the game image based on the generated game image data on displays of other communication members of the communication group, to share the game image with other communication members,
forbidding at least one game image from being displayed on a display for at least one of game members of the game group.

2. The information processing system according to claim 1, wherein
the operations further comprise:
designating at least one of the game members according to a condition specified in the multiplayer game of the game group,
the forbidding comprises forbidding the game image from being displayed on at least one of displays for the at least one of the designated game members.

3. The information processing system according to claim 1, wherein
the operations further comprise:
storing identification information of the game members of the game group; and
designating at least one of the game members satisfying a condition based on the identification information, and
the forbidding comprises forbidding the game image from being displayed on at least one of displays for the at least one of the designated game members.

4. The information processing system according to claim 1, wherein
the multiplayer game is a team competition game
the operations further comprise:
storing team configuration data including identification data of game member of each team of the team competition game; and
designating game members of an opponent team in the team competition game, based on the team configuration data, and
the forbidding comprises forbidding the game image from being displayed on at least one of displays for the at least one of the designated game members.

5. The information processing system according to claim 1, wherein
the multiplayer game is a game in which a user participates as a player and a user participates as a spectator,
the operations further comprise:
storing member configuration data including identification data of game members for identifying the user participating as a player and the user participating as a spectator, and
designating at least one of the users participating as a player without designating the user participating as a spectator, based on the member configuration data, and
the forbidding comprises forbidding the game image from being displayed on at least one of displays for the at least one of the designated game members.

6. The information processing system according to claim 1, wherein
the operations further comprise:
executing a game program,
a first game program for executing the multiplayer game is stored as the game program to be executed, in a memory, and
the first game program includes a first instruction to designate the game member satisfying a condition, based on identification information of the game members of the game group, and
the forbidding comprises forbidding the game image from being displayed on at least one of displays for the at least one of the designated game members.

7. The information processing system according to claim 6, wherein
a second game program for executing the multiplayer game is stored as the game program to be executed, in a memory,
the second game program includes a second instruction to designate all game members of the game group, and
the forbidding comprises forbidding the game image from being displayed on at least one of displays for the at least one of the designated game members.

8. The information processing system according to claim 6, wherein
a third game program for executing the multiplayer game is stored as the game program to be executed, in a memory, and
the third game program includes a third instruction to designate all communication members of the communication group.

9. The information processing system according to claim 6, wherein
a second and a third game program for executing the multiplayer game are stored as the game program to be executed, in the memory,
the second game program includes a second instruction to designate all game members of the game group, and
the third game program includes a third instruction to designate all communication members of the communication group.

10. The information processing system according to claim 1, wherein
the operations further comprise:
designating all communication members of the communication group according to a user's instruction, and
the forbidding comprises forbidding the game image from being displayed on at least one of displays for the at least one of the designated game members.

11. The information processing system according to claim 1, wherein
the information processing system comprises a plurality of game apparatuses, and
in the multiplayer game, one of the plurality of game apparatuses serving as a host apparatus is configured to obtain operation data of one of the plurality of game apparatuses serving as a guest apparatus, and execute a game program using operation data of the host apparatus and the operation data of the guest apparatus to generate game image data for the host apparatus and game image data for the guest apparatus.

12. One or more non-transitory computer-readable storage media storing instructions that cause one or more computers to perform operations comprising:
displaying a game image on a display of another communication member of a communication group,
receiving a first instruction to designate all game members of a game group, the first instruction being issued by execution of a game program of a multiplayer game; and
forbidding a game image corresponding to the designated game member from being displayed on a display by the displaying.

13. The one or more non-transitory computer-readable storage media according to claim 12, wherein
the operations further comprise:
receiving a second instruction to designate all communication members, the second instruction being issued by execution of a game program of a multiplayer game; and
forbidding a game image corresponding to the designated members from being displayed on a display by the displaying.

14. One or more non-transitory computer-readable storage media storing instructions that cause one or more computers to perform operations comprising:
displaying a game image on a display of another communication member of a communication group,
receiving a third instruction to designate user identification data, the third instruction being issued by execution of a game program of a multiplayer game; and
forbidding a game image corresponding to the designated user identification data from being displayed on a display by the displaying.

15. The one or more non-transitory computer-readable storage media according to claim 14, wherein
the operations further comprise:
receiving a fourth instruction to designate all communication members of a communication group, the fourth instruction being issued by execution of a game program of a multiplayer game; and
forbidding a game image corresponding to the designated members from being displayed on a display by the displaying.

16. The one or more non-transitory computer-readable storage media according to claim 12, wherein
the operations further comprise:
receiving a third instruction to designate user identification data, the third instruction being issued by execution of a game program of a multiplayer game; and
forbidding a game image corresponding to the designated user identification data from being displayed on a display by the displaying.

17. One or more non-transitory computer-readable storage media storing instructions that cause one or more computers to perform operations comprising:
executing a multiplayer game; and
instructing a system program to designate all game members of a game group of the multiplayer game as subject to forbidding of sharing of a game image.

18. One or more non-transitory computer-readable storage media storing instructions that cause one or more computers to perform operations comprising:
executing a multiplayer game; and
instructing a system program to designate a game member of a game group of the multiplayer game as subject to forbidding of sharing of a game image.

19. The one or more non-transitory computer-readable storage media according to claim 18, wherein
in the designation, a game member of an opponent team in a team competition game as the multiplayer game, is configured to be designated as subject to forbidding of sharing of a game image.

20. A computer-implemented method comprising:
executing a process of forming a communication group in which communication is performed, and executing a communication process between a plurality of communication members using network communications;
executing a process of forming a game group in which a multiplayer game is performed, and executing the multiplayer game between a plurality of game members using the network communications or another network communications to generate game image data for each game member;
displaying the game image based on the generated game image data on displays of other communication members of the communication group, to share the game image with other communication members; and
forbidding at least one game image based on the generated game image data from being displayed on a display for at least one of game members of the game group.
